(19) United States
(12) Patent Application Publication
(10) Pub. No.: US 2026/0216768 A1
(43) Pub. Date: Jul. 30, 2026

(54) SYSTEM FOR THE PRODUCTION OF FOOD PRODUCTS FROM ENGINEERED MICROBES

(71) Applicants: Board of Trustees of Southern Illinois University, Carbondale, IL (US); The Board of Trustees of the University of Illinois, Urbana, IL (US); NUtech Ventures, Lincoln, NE (US); The Research Foundation for the State University of New York, Albany, NY (US)

(72) Inventors: Lahiru N. Jayakody, Carbondale, IL (US); Kenneth B. Anderson, Carbondale, IL (US); Scott B. Hamilton-Brehm, Carbondale, IL (US); Matthew McCarroll, Carbondale, IL (US); Poopalasingam Sivakumar, Carbondale, IL (US); Gayan L. Aruma Baduge, Carbondale, IL (US); Iwona M. Jasiuk, Urbana, IL (US); Kaustav Majumder, Lincoln, NE (US); Rina Tannenbaum, Albany, NY (US)

(21) Appl. No.: 19/144,782

(22) PCT Filed: Jan. 3, 2024
(86) PCT No.: PCT/US2024/010136

§ 371 Date: Jun. 30, 2025

Related U.S. Application Data
(60) Provisional application No. 63/437,051, filed on Jan. 4, 2023.

(51) Int. Cl. B09B 3/60; B09B 3/35; B09B 3/70

(52) U.S. Cl. CPC B09B 3/60; B09B 3/35; B09B 3/70

(57) ABSTRACT

A system, genetically modified yeast and methods for sustainable production of yeast protein extract and food products containing the yeast protein extract, the system comprising an oxidative hydrothermal dissolution (OHD) apparatus for decomposing plastic and biomass into OHD output feedstock and a bioreactor configured for growing the genetically modified yeast engineered to utilize the OHD output feedstock as a carbon source.

### CROSS REFERENCES TO RELATED APPLICATIONS

This application claims the benefit of priority to U.S. Provisional Patent Application 63/437,051 filed Jan. 4, 2023, the entire disclosure of which is herein incorporated by reference in its entirety.

### INCORPORATION-BY-REFERENCE OF SEQUENCE LISTING FILE

The application contains a Sequence Listing which has been submitted electronically in .XML format and is hereby incorporated by reference in its entirety. Said .XML copy, created on Jan. 2, 2024, is named “6584.154363 .xml” and is 75,484 bytes in size. The sequence listing contained in this .XML file is part of the specification and is hereby incorporated by reference herein in its entirety.

### TECHNICAL FIELD

The present disclosure generally relates to a food production system comprising genetically modified yeast and corresponding methods for conversion of a waste feedstock, preferably plastic and biomass waste feedstock, into a food product suitable for human consumption.

### BACKGROUND

Food insecurity is a global problem that affects millions of people. A solution to this problem may be dependent on developing new systems and methods for sustainable food production. It has been also recently reported that deep space travel may be constrained by a limited food storage space, urging the need for sustainable food production systems and methods which can be operated during space travel.

Additional challenge which directly impacts the food chain is accumulation of plastic waste that pollutes oceans, landfills, and the land. Recycling plastic waste by processing it into nutritious food may be a transformative approach to treating the world hunger while also decreasing plastic pollution and contributing to a more sustainable world.

Currently, there is a need in the field for systems and methods which can be used to produce a sustainable food product, solving a problem of the world hunger while also reducing accumulation of plastic waste the pollutes our environment. There is also a need for sustainable food production systems which may be manufactured as a portable unit with dimensions suitable for space travel.

### SUMMARY

This disclosure provides a technical solution to the above-mentioned technical problems.

In one aspect, this disclosure provides a system for sustainable production of food. The system may be referred in this disclosure as ‘micro-bites’ system, or the μBites system, or as a food production system according to this disclosure. The μBites system leverages an oxidative hydrothermal dissolution (OHD) process that uses water, heat, and pressure to decompose a solid synesthetic and/or natural carbon polymer into liquid organic compounds. In the μBites system, the OHD process produces a soluble carbon liquid stream which may be used for growing recombinant yeast genetically modified to thrive and grow by using the OHD feedstock as a carbon supply.

In one aspect, the disclosure provides a system for sustainable food production from waste feedstock, the system comprising:
a) a feedstock preparation component comprising a grinding and/or an extrusion apparatus;
b) an oxidative hydrothermal dissolution (OHD) apparatus configured for decomposing plastic materials and/or biomass into an output OHD feedstock;
c) a bioreactor configured for growing a microorganism, including bacterial and/or yeast cells;
d) one or more of bacterial and/or yeast cells encoding enzymes for utilizing the OHD output feedstock as a carbon source while growing and producing yeast protein and/or food additives;
e) a separation component configured for harvesting the yeast protein and/or the food additives and separating the yeast protein from fermented broth and yeast cell debris;
f) a formulation component for formulating and preparing a food product comprising the yeast protein and/or the food additives;
g) an analytical sensor component configured for analyzing chemical compositions and for detecting bacterial contamination; and
h) a control interface component for operating component a) through g).

Preferred embodiments of the system include those, wherein the system is further characterized by one or more of the following features:
the feedstock preparation component is connectable to the oxidative hydrothermal dissolution apparatus;
the bioreactor is a plastic bag and/or comprises one or more inlets for and one or more outlets;
the separation component comprises one or more of the following: a centrifuge, a sonicator and/or filtration membrane;
the formulation component comprises a mixing apparatus; and/or
the system further comprises one or more of the following: a 3D food printer, cooking oven or a microwave.

Particularly preferred embodiments of the system may include those, wherein the waste feedstock comprises waste plastic and/or biomass such as apple, green tea, coffee, corn stover. In further embodiments, the OHD apparatus may comprise one or more of the following: a reactor for reacting waste feedstock with oxygen in the presence of water, an oxygen pump, a chiller, water reclamation unit, reverse osmosis unit and/or an OHD substrate storage tank.

In the system, the bacterial and/or yeast cell may be preferably supplied as a dry material in a capsule. Particularly preferred genetically modified yeast cells include those, wherein the yeast cell is Saccharomyces cerevisiae, Saccharomyces boulardii, Rhodosporidium toruloides, Rhodotorula toruloides or Yarrowia lipolytica genetically modified to grow on the OHD output feedstock as a carbon source and expressing one or more of following recombinant enzymes: YLLO56C enzyme converting ethylene glycol into glycolaldehyde and having the amino acid sequence with SEQ ID NO: 24 or a functional variant thereof; aldehyde dehydrogenase having the amino acid sequence with SEQ ID NO: 25 or a functional variant thereof; and/or PET-hydrolase having the amino acid sequence with SEQ ID NO: 17 or a functional variant thereof. Preferably, the yeast cells produce at least yeast protein as an unpurified food product feedstock. In embodiments, Rhodosporidium toruloides, Rhodotorula toruloides can be used for carotene production.

In particularly preferred embodiments, the system may further comprise one or more of the following: a 3D food printing apparatus and or a microwave oven.

In another aspect, this disclosure relates to a sustainable food product produced by using the system according to this disclosure. The food product may preferably comprise genetically modified yeast protein extract. Preferably, the food product may be a cookie.

In yet another aspect, the disclosure relates to a method for sustainable food production, using the system according to this disclosure, the method comprising:
i. grinding and/or extruding waste feedstock in the feedstock preparation component;
ii. mixing with water the waste feedstock, wherein the waste feedstock comprises plastic and biomass;
iii. reacting the waste feedstock with oxygen in the presence of water at a temperature in the range 100° C. to about 374° C. under pressure in the range 1500 to 3500 psi and producing an OHD output feedstock comprising liquid organic compounds;
iv. supplying the OHD output feedstock obtained in step iii to a bioreactor and growing microbial cells, preferably bacterial and/or yeast cells, and more preferably genetically modified bacterial and/or yeast cells, in the bioreactor with the OHD output feedstock used as a source of carbon and thereby producing unpurified food product feedstock;
v. subjecting the unpurified food product feedstock of step iv to one or more of sonication, centrifugation and/or filtration, and obtaining purified food product feedstock separated from waste water and yeast cell debris;
vi. mixing and/or 3D-printing a usable feedstock product comprising the purified food product feedstock obtained in step v. and other food additives; and
vii. cooking or baking the usable feedstock product from step vi. into an edible food product.

Embodiments of the method include those, wherein step ii is performed simultaneously with step i. Particularly preferred embodiments include those, wherein the OHD output feedstock comprises ethylene glycol.

Preferably, the methods may be performed with the yeast cells which are genetically modified to utilize ethylene glycol as a carbon source. The yeast cell may be Saccharomyces cerevisiae, Saccharomyces boulardii, Rhodosporidium toruloides, Rhodotorula toruloides or Yarrowia lipolytica genetically modified to grow on the OH D output feedstock as a carbon source. Preferably, the yeast cells may be modified to express one or more of following recombinant enzymes: YLLO56C enzyme converting ethylene glycol into glycolaldehyde and having the amino acid sequence with SEQ ID NO: 24 or a functional variant thereof; aldehyde dehydrogenase having the amino acid sequence with SEQ ID NO: 25 or a functional variant thereof; and/or PET-hydrolase having the amino acid sequence with SEQ ID NO: 17 or a functional variant thereof.

In particularly preferred embodiments of the method, the unpurified food product feedstock produced in step iv may comprise one or more of the following: yeast protein, xylitol, milk protein, intracellular yeast protein, a vitamin, lactic acid, flavor, aroma, lipid, β-carotene, omega-3 and/or -6 fatty acids. In particularly preferred embodiments of the method, the purified food product feedstock may comprise one or more of the following: yeast protein, xylitol, milk protein, amino acids, a vitamin, lactic acid, flavor, aroma, lipid, β-carotene, omega-3 and/or -6 fatty acids.

The method may further include using a 3D food printing apparatus to form the usable feedstock product into a printed food product before the step of cooking or baking. Preferably, the method may include using a Raman spectrometer to analyze for microbial contamination in any of the following: the OHD output feedstock comprising liquid organic compounds; the unpurified food product feedstock; the purified food product feedstock separated from waste water and yeast cell debris, the usable feedstock product comprising the purified food product feedstock obtained in step v. and/or the edible food product.

In a further aspect, this disclosure relates to a genetically modified yeast cell expressing one or more of enzymes utilizing an OHD output feedstock as a carbon source for growth. Preferably, the genetically modified yeast cell is genetically modified to express one or more of enzymes for hydrolyzing poly(ethylene terephthalate) (PET) and/or ethylene glycol. In particularly preferred embodiments, the genetically modified yeast cell may express one or more of the following recombinant enzymes: YLLO56C enzyme converting ethylene glycol into glycolaldehyde and having the amino acid sequence with SEQ ID NO: 24 or a functional variant thereof; aldehyde dehydrogenase having the amino acid sequence with SEQ ID NO: 25 or a functional variant thereof; and/or PET-hydrolase having the amino acid sequence with SEQ ID NO: 17 or a functional variant thereof.

### BRIEF DESCRIPTION OF THE DRAWINGS

FIG. 1 is a schematic illustrating the overall food production system (μBites system) according to this disclosure.

FIG. 2 is a schematic illustrating Component 2 (the kitchen-scale OHD system) of the food production system according to this disclosure.

FIG. 3 is a schematic illustrating Component 3 of the food production system according to this disclosure.

FIG. 4 is a series of photographs showing that the OHD feedstock is free of microbial contaminants. The OHD feedstocks were filtered using 0.22 μm filters to make them sterile. The OHD products were plated on LB and tested for microbial contamination (i.e., aerobic count). Incubated at 37° C. for 120 h.

FIG. 5A is a schematic illustrating Component 3 embodied as a plastic bioreactor bag with 5 L capacity.

FIG. 5B-FIG. 5D are examples of synthetic yeast genetically engineered (modified) to produce yeast extract (FIG. 5B), xylitol (FIG. 5C), or milk protein (FIG. 5D).

Energy Usage: 100 W to operate the micro air pump and reactor operate at ambient condition. Water Usage: Net water usage will be 300 mL Input: Yeast growth supplements, dry-yeast capsule, OHD-substrates, and O₂ Output: Yeast cell, extracellular protein, intracellular proteins, fat, carbohydrates, and CO₂ Waste: Used plastic bioreactor bag, Cells debris, CO₂, and water CO₂ will be converts to formate, and reset of the waste will be recycled via OHD.

FIG. 6 is a series of photographs showing fermentation of OHD feedstock using engineered yeast, μBites-Yeast 01. A) The engineered strain's, μBites-Yeast 01, growth was tested on the OHD feedstock using 100 mL culture synthetic complete (SC) media supplemented with 10 g/L of glucose and OHD substrates derived from waste Green Tea and PET. The initial inoculation volume was set as OD600=0.1 and cells were incubated at 28° C. B) The test of the growth in a biobag supplemented with O₂. C) Remarkable growth of μBites yeast was observed. D) Grown yeast cells can be collected through by gravity flow.

FIG. 7 is a series of bar graphs evaluating toxicity of OHD-fermented yeast protein on human endothelial cells. A) Corn stover+PET OHD before fermentation. B) Corn stover+PET OHD after fermentation.

FIG. 7 CONT'D C) Protein extracted from μBites-Yeast 01 fermented with glucose. D) Protein extracted from μBites-Yeast 01 fermented with Corn stover+PET OHD. A negative value indicates cytotoxicity.

FIG. 8 is a schematic illustrating Components 4, 5, and 6 of the food production system according to this disclosure.

FIG. 9 is a photograph of exemplary food products produced in the system according to this disclosure.

FIG. 10 is a graph showing identification of distinguishing Raman Spectroscopic peaks of microbes in OHD substrates (waste green tea and plastic). Chemicals in OHD were identified via Raman Spectroscopy Analysis and added E. coli (supplement) to detect via Raman Spectroscopy Analysis. The black arrow highlights one of the specific peaks that was used to identify E. coli if they are present in the OHD substrates.

FIG. 11 is a schematic illustrating Components 7 and 8 of the food production system according to this disclosure.

FIG. 12 depicts one embodiment of a layout for the system according to this disclosure which may be sufficient for providing food to four astronauts in 3 years of deep space mission.

FIG. 13 is a process diagram showing steps of the food production process according to this disclosure, including the critical control points.

FIG. 14 is a series of figures depicting growth and substrate utilization of yeast on OHD-Corn Stover & PET. A) Cell growth on OHD as a sole carbon source. B) Dry yeast yield per OHD substrate.

FIG. 14 CONT'D C) HPLC chromatographs reveal OHD substrates' utilization by engineered yeast strain EJ4, that can catabolize cellobiose and xylose. Five milliliters of complete synthetic media containing 50% (v/v) Corn Stover and PET were inoculated with yeast. Samples were incubated at ambient temperature at 225 rpm for 48 h.

FIG. 15 is a series of graphs showing the comparison of yeast protein with egg and soy protein. A) The distribution of amino acids (AA) and peptides (2-10 amino acid long). B) The distribution of essential amino acids in digested fractions.

FIG. 16 is a series of figures showing the mass, space, and water requirement for plastic as an alternative substrate for the μBite food system. The calculation was done based on the C requirement for producing the required quantity of yeast protein for a three-year mission with four astronauts.

FIG. 17 report results of scenario-based questions. 80% of participants would probably or definitely consider consuming this product in a spacecraft.

FIG. 18 reports enabling ethylene glycol metabolism in S. cerevisiae BY4743 by genetically modifying yeast cells to express YLLO56C and ALD5 enzymes. A) Metabolic pathway and the plasmid map B) Growth C) EG utilization D) Glycolic acid production. The strains were tested in SC medium-Trp supplemented with EG as the sole carbon source. Results are average of n=3, and the statistical comparison (T-test) of the control and engineered strain denotes as * 0.05<p, ** 0.01<p.

FIG. 19 is a map of pYD1:YLLO56C plasmid expressing YLLO56C enzyme.

FIG. 20 is a map of pVT100:ALD5 plasmid expressing ALD5 enzyme.

### DETAILED DESCRIPTION

The following abbreviations and definitions may be used in this disclosure:
“MW” means molecular weight;
“PET” means polyethylene terephthalate;
“PBAT” means poly(butylene adipate-co-terephthalate);
“BHET” means bis(2-hydroxyethyl) terephthalate;
“MHET” means mono-(2-hydroxyethyl)terephthalic acid;
“TPA” means terephthalic acid which can be also referred to as benzene-1,4-dicarboxylic acid;
“EG” means ethylene glycol;
“OHD” means oxidative hydrothermal dissolution process;
“An OHD-substrate” means a substrate that was pretreated by the OHD process. In this disclosure, the OHD-substrate may be referred interchangeably as the OHD-feedstock or the OHD-output feedstock;
“LCC” means leaf-branch compost cutinase, the PET-hydrolase;
“LDH-A” means lactate dehydrogenase A;
“GH-1-1” means beta glucosidase;
“XYL-1” means xylose reductase;
“XYL-2” means xylitol dehydrogenase;
“XYL-3” means D-xylulokinase;
“YLLO56C” means an enzyme converting ethylene glycol into glycolaldehyde;
“ALD5” means aldehyde dehydrogenase;

In this disclosure “a functional variant” means a polypeptide that may perform the same enzymatic reaction as its corresponding enzyme. Some functional variants may contain one or more of amino acid substitutions which do not significantly impact the enzymatic function. For example, one negatively charged amino acid may be substituted for another negatively charged amino acid. Some other examples include, but are not limited to, one or more amino acid deletion and/or insertion, preferably when such mutations are made outside the enzyme catalytic domain.

### Micro-Bites Food Production System

In one aspect, this disclosure relates to a food production system comprising genetically modified yeast for conversion of a waste feedstock, preferably containing plastic and/or biomass waste, into a food product suitable for human consumption.

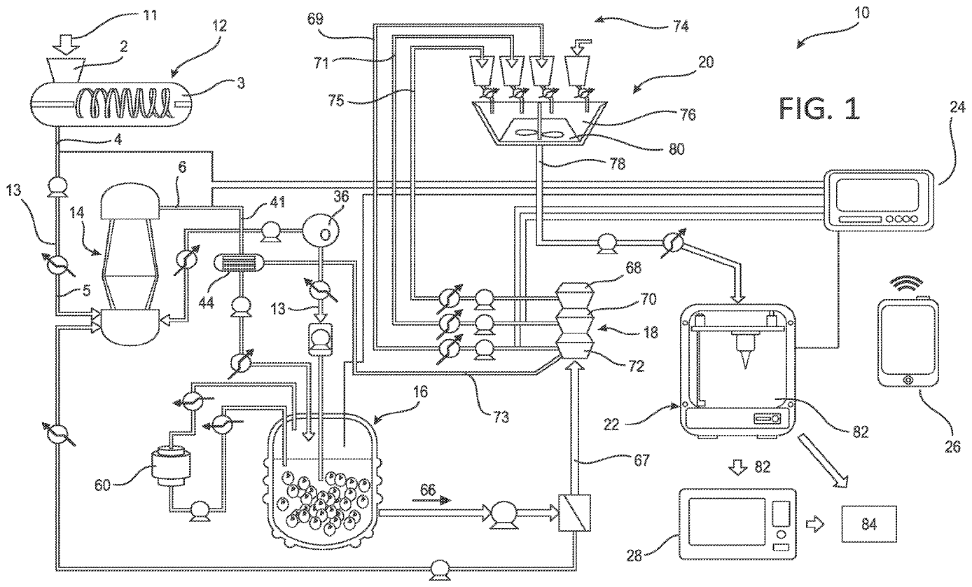

The micro-bites food production system one embodiment of which is shown in FIG. 1, generally (10) may comprise a plurality of components. The food production system (10) according to this disclosure may comprise the following components: a feedstock preparation component (12), which may be referred to as Component 1; an oxidative hydrothermal dissolution (OHD) component (14), which may be referred to as Component 2; a bioreactor component (16), which may be referred to as Component 3; a separation component (18), which may be referred to as Component 4; a formulation component (20), which may be referred to as Component 5; an optional 3D printing component (22), which may be referred to as Component 6; an analytical sensor component (24), which may be referred to as Component 7; and a control interface component (26), which may be referred to as Component 8.

The food production system (10), which may also be referred to as μBites or micro-Bites or the μBites system or the μBites food production system (10), utilizes plastic and/or biomass waste as a carbon source for food generation. The oxidative hydrothermal dissolution (OHD) process dissolves any carbon-based waste material (>90% efficiency) into a carbon-rich liquid. Synthetically engineered yeast metabolizes the OHD processed carbon stream into nutrient-dense food slurries. Low volume/high flavor spices and food additives may enrich the nutrient-dense food slurries for taste. The process may be fully automated and monitored to affirm quality and safe food production and operate the unit safely. In application to space travel, the nutritional components can be customized for individual nutrition needs for each crewmember of a space craft, compensating for physiological variation over long periods under zero or microgravity conditions.

The system (10) utilizes water, heat, and oxygen to dissolve any waste carbon material into a liquid carbon stream. Waste plastics (even those produced from the μBites system) may be reused as a carbon source for producing nutritious foods, minimizing inputs, and maximizing outputs. The liquid carbon is the preferred feedstock for yeast to consume and generate chemical materials required for making nutritious foods. A 3D food printing allows production of meals in a variety of compositions and geometric shapes. With the support of a 3D food printer and a heating component such as for example as a microwave over, this technology may produce different liquid or solid food products. This customizable format combined with tasty, and nutrient-rich foods maximizes personalized selections for dietary needs.

The μBites system (10) is easy to operate due because of its design and utilization of common ‘off-the-shelf’ hardware components. The system (10) may uses robust, easily replaceable grinders, millers, micro-Raman spectrometer, sensors, 3D food printers, and control panels. The μBites yeast-bioreactors (16) have the same reliability of production, given that the engineered yeast may be generated via antibiotic and marker-free genome engineering technology, making the yeast genetically stable over time. Carefully selected ingredient supplements used for the μBites process are expected to have a minimum of three years shelf life with a minimum functional loss to those items of 55%. It is worth noting that the μBites system (10) relies on yeast-based food ingredients to meet the nutritional demand of humans or animals. The nutritional value is supplemented by the use of supplements to enhance the aroma, texture, and favors. Thus, the loss of functionality of the supplements does not affect the nutritional profile of the food. Notably, the μBites food production system (10) and corresponding methods also have a high potential to improve terrestrial food production while positively affecting the environment. In particular, the proposed technical solution addresses three critical global challenges: overcoming the scarcity of food, removing accumulation of plastic waste, and adapting to the global climate change. The μBites system (10) combines the novel OHD technology with genetically modified and optimized yeast to produce nutritive raw materials (e.g., proteins, lipids, vitamins, and sugars) from synthetic or natural carbon polymers (e.g., lignocellulose and plastic). The innovative μBites system (10) and corresponding methods produce nutritious, safe, sustainable next generation food.

The μBites system (10) may comprises, comprises essentially of or consists of eight components (12, 14, 16, 18, 20, 22, 24 and 26) (FIG. 1). The system (10) leverages the OHD technology to dissolve >90% of waste carbon (biomass or plastic) into microbial accessible water-soluble carbon using only water, heat, and oxygen. Water may be recovered through the Reverse Osmosis (RO) unit (44) and reused in the OHD process. In embodiments, the OHD and RO system (10) was developed that can generate 12 L of 4% total organic carbon from corn stover/green tea and polyethylene terephthalate (PET). Different yeast strains may be engineered to obtain intracellular (yeast protein, amino acids, vitamins, flavors, aroma, and omega-3 and -6 fatty acids) and extracellular compounds (e.g., milk proteins and xylitol) from OHD processed materials (e.g., waste biomass or plastics). Oleaginous yeast strains were grown on OHD processed materials to obtain FDA-approved food components such as lipids and β-carotene. The production of the entire daily astronaut's protein and fat requirements may be supplied via the yeast-based compounds. Sonication was utilized to obtain the intracellular protein, and centrifugation and membrane-based technology was used to separate yeast protein and other nutrients from fermented broth and yeast cell debris. The waste yeast biomass and plastic reactors can be recycled by the OHD process.

### Component 1: Feedstock Preparation Component (12)

Referring to FIG. 1, component 1 (12) may comprise an input line (2) for supplying an unmodified waste feedstock (11) to the food production system (10), an ingredient preparation apparatus (3) for converting the unmodified waste feedstock (11) to a modified waste feedstock (13), and an output line (4) for supplying the modified waste feedstock (13) from Component 1 (12) to Component 2 (14).

The input line (2) may be operably connected to the ingredient preparation apparatus (3).

The ingredient preparation apparatus (3) may comprise a grinding apparatus for reducing the particle size of the unmodified waste feedstock. The ingredient preparation apparatus may comprise an extrusion apparatus for modifying the texture of the unmodified waste feedstock. The ingredient preparation apparatus (3) may comprise both a grinding apparatus and an extrusion apparatus. An example of preparing feedstock (13) may include the following: biomass and plastic mix with 20:1 ratio (w/w) for the OHD process. The biomass and plastic mixture may be prepared by wet milling (automated mortar and pestle) to pass an 18-mesh sieve and then diluted to ~1-2% (w/v) with deionized water.

The output line (4) may be operably connected to the ingredient preparation apparatus (3). The output line (4) may also be operably connected to Component 2 (14).

The unmodified waste feedstock (11) may comprise plastics, including synthetic plastics and bio-derived plastics, apple, green tea, coffee, corn stover, coal, biomass, other industrial waste products suitable for the OHD process, or a mixture of thereof. Examples of suitable biomass substrates include, but are not limited to, algae; grass; wood; tree; shrub; tree leaves; tree needles; bushes; agricultural biomass wastes including leaves, crop stalks, roots, fruit and/or vegetable skins, corn stover, rice hulls, grain husks; beverage industry waste including black tea waste, green tea waste, ground coffee; forestry wood waste including branches, trees, bushes; construction and demolition biomass waste including saw dust, scrap wood; post-consumer biomass waste including paper, cardboard, used tea leaves, used ground coffee, peeled vegetable or fruit skins and other food preparation wastes. Preferred examples of biomass wastes include, but are not limited to, green tea waste, black tea waste, used tea leaves, ground coffee and/or corn stover.

Plastics may include any plastic polymeric material, natural or synthetic. Preferably, suitable plastics may include a polyethylene material. More preferably, suitable plastics include any plastic material having recycling code PET also known as PETE and also known as recycling symbol #1 and comprising polyethylene terephthalate (PET). Examples of plastic waste suitable as waste feedstock include, but are not limited to, plastic bottles for water, food and beverages, plastic bags, food wrappers, containers, straws, among many others.

The input line (2) may also supply water to the ingredient preparation apparatus (3) of the food production system (10). Alternatively, Component 1 (12) may further comprise a water input line for supplying water to the ingredient preparation apparatus of the food production system.

### Component 2: Oxidative Hydrothermal Dissolution (OHD) Component (14)

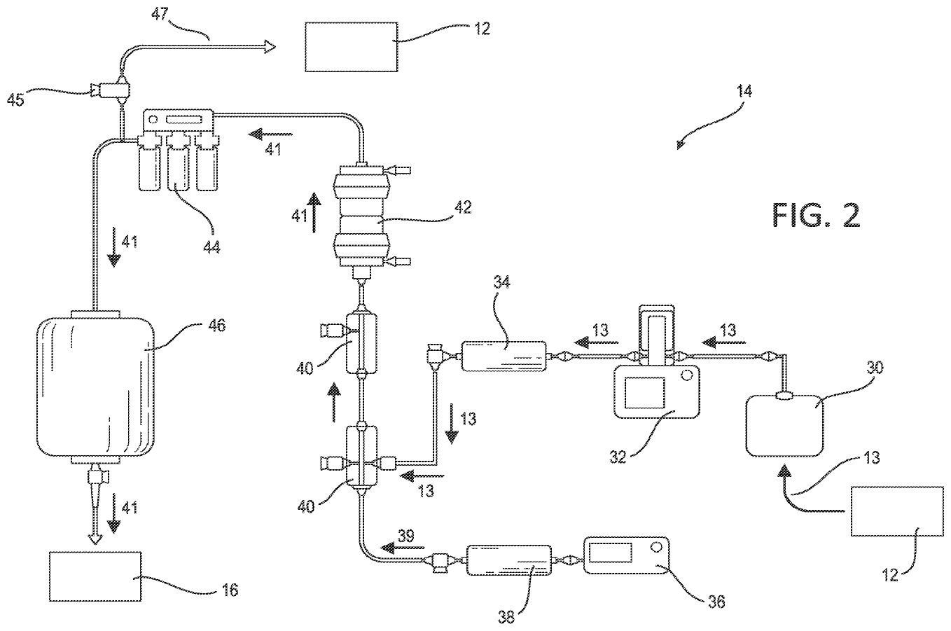

With reference to FIGS. 1 and 2, Component 2 (14) may comprise an input line (5) for supplying a modified waste feedstock (13), an OHD apparatus (14) for converting the modified waste feedstock (13) to an OHD output feedstock (41) and an output line (6) for supplying the OHD output feedstock (41) from Component 2 (14) to Component 3 (16). The OHD process is described in detail in U.S. Pat. No. 8,563,791, the entire disclosure of which is herein incorporated by reference.

The input line (5) may be operably connected to the OHD apparatus (14). The input line (5) may be operably connected to the output line (4) of Component 1 (12). The input line (5) may be the output line (4) of Component 1 (14).

The OHD apparatus (14) may comprise a reaction vessel (40), which may comprise of two reactor units, each (40) for de-polymerizing the modified waste feedstock (13) to an OHD output feedstock (41) in which solid complex synesthetic and/or natural carbon polymer is decomposed into liquid organic compounds. Preferably, the OHD output feedstock (41) comprises ethylene glycol.

The OHD apparatus (14) subjects the modified waste feedstock (13) to OHD process conditions. In embodiments, the OHD apparatus (14) include a slurry pump (32) configured for pumping a biomass and/or plastic slurry mixed with water (30) through a slurry preheater (34) and then transferring the slurry into the reactor (40), wherein the slurry is reacted with oxygen supplied by an oxygen pump (36) which may also include an oxygen flow heater (38) for preheating oxygen prior to it being delivered into the reactor (40).

The OHD reactor (40) may be operated at about 220-350° C., 2000 psi, O₂ loading 0.5-0.8, and retention time of about 15 s. The OHD substrate may be concentrated up to 8 g/L of TOC using a laboratory scale water reclamation (RO), reverse osmosis unit (44). Preferably, the pH of the OHD slurry (30) may be adjusted to 6 using NaOH and filtered with 0.22 μm filter to sterilize the substrate.

The OHD reactor (40) performs oxidative hydrothermal dissolution (OHD) process in the presence of oxygen in subcritical water in a reactor (40) at an elevated temperature under pressure, which may be conducted at a temperature in the range from about 100° C. to about 374° C., and preferably in the range from about 200° C. to about 350° C. The pressure in the OHD reactor (40) may be specified to at least maintain the water in liquid state. In some embodiments, the pressure may be in the range 1500 to 3500 psi. “Subcritical water” means high-temperature and high-pressure water. Examples of OHD methods are known in the art, for example from U.S. Pat. No. 10,023,512, the entire disclosure of which is herein incorporated by reference.

The OHD apparatus (14) may further comprise a chiller (42) which can be used for cooling down the OHD output feedstock (41) exiting the reactor (40). The heat transferred from the OHD output feedstock (41) in the chiller (42) may be transferred back into the system (10) as shown in FIG. 1. Optionally, the OHD output feedstock (41) may be further processed in a water-reclamation (reverse osmosis) unit (44) for removing extra water which now may be re-cycled back into the system (10) through a line (47), the line (47) preferably having a back-pressure regulator (45). The OHD output feedstock (41) is then may be stored in an OHD substrate storage tank (46) until needed for use in a bioreactor (16).

The OHD output feedstock (41) may be delivered from the OHD substrate storage tank (46) and into a bioreactor (16) by an output line (6).

The output line (6) may be operably connected to the OHD apparatus (14). The output line (6) may also be operably connected to Component 3 (16).

The input line (5) may also supply water to the OHD apparatus (14). Alternatively, Component 2 (14) may further comprise a water input line for supplying water to the OHD apparatus (14). The water input line (5) may be the water output line of Component 4 (18), described below.

The input line (5) may also supply oxygen to the OHD apparatus (14). Alternatively, Component 2 (14) may further comprise an oxygen input line for supplying oxygen (39) to the OHD reactor (40).

In embodiments, the OHD apparatus (4) may be fabricated as kitchen-scale (Laboratory) OHD reactor (40) and reverse osmosis (RO) unit (44). The reactor (40) enables generation of 40 g/L of total carbon containing OHD substrate from waste biomass and plastic. Initial mass balance indicates about 80-90% of carbon conversion in OHD output feedstock. Different oxygen loading is being tested to enhance the carbon conversion further. Also, water can be recirculated to the OHD reactor (40) to reuse. The additional pumping system (38) to control the oxygen flow may be added and complete the apparatus (14). The apparatus (14) may use less than 1.9 kW to generate the OHD output feedstock. The produced OHD output feedstock has been analyzed through HPLC, LC-MS, GC-MS, and Raman to characterize the chemicals and successfully used for the yeast experiments.

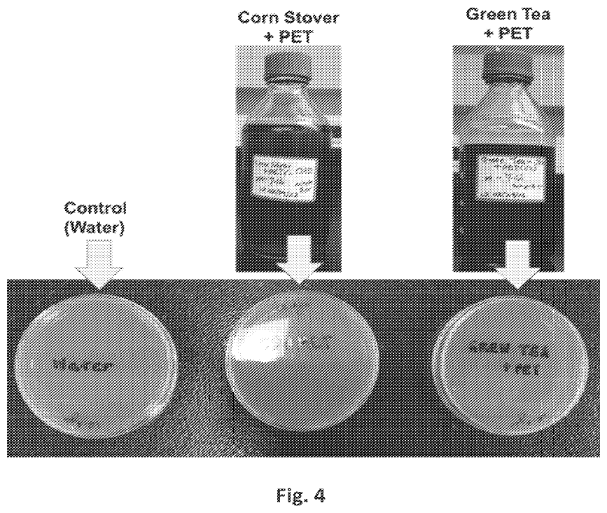

Generally, the OHD output feedstock (41) is free of microbes because of reaction conditions (heat and pressure), and the component 2 (14) can be kept fee of contamination. To have a second tier of protection (food safety), the OHD output feedstock can be filtered after being obtained in the component 2 (14) by using a 0.22 μm filter to make a sterile fermentation substrate and tested for microbial contamination as shown in FIG. 4. After four days of incubation, no colonies were observed. Thus, it was confirmed that the prepared OHD output feedstock (41) for fermentation in the component 3 (16) of the system (10) is free of any microbial contaminant(S).

In embodiments of producing OHD output feedstock, apple and PET OHD substrate that contains >90% of Carbon in the original material may be used. A micro-scale continuous OHD reaction system was used to generate OHD products. A commercially available apple and high crystalline (>40%, <300 m) PET powder (GoodFellow, Inc, USA) at a 20:1 ratio (w/w) was used for the OHD process.

The apple may be prepared for testing by wet milling (automated mortar and pestle) to pass an 18-mesh sieve and then diluted to ~1-2% (w/v) with deionized water. The OHD reactor (40) may be operated at about 220-350° C., 2000 psi, O₂~loading 0.5-0.8, and retention time ~15 s; the OHD substrates may be concentrated up to 8 g/L of TOC using a laboratory scale RO unit. The pH of the OHD slurry may be adjusted to 6 using NaOH and filtered with 0.22 μm filter to sterile the substrates.

### Component 3: Bioreactor Component (16)

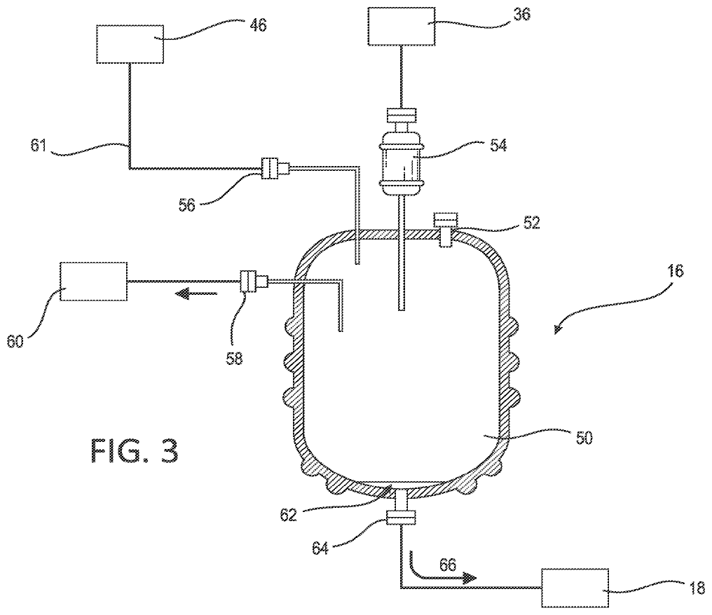

With reference to FIGS. 1 and 3, Component 3 (16) may comprise an input line (61) for supplying an OHD output feedstock (41), a bioreactor apparatus (50) which may be referred to as a biobag in certain applications for converting the OHD output feedstock (41) to an unpurified food product feedstock (66), and an output line (64) for supplying the unpurified food product feedstock from Component 3 (16) to Component 4 (18).

The input line (61) may be operably connected through a substrate inlet (56) to the bioreactor apparatus (50). The input line (61) may be operably connected to the output line (6) of Component 2 (14). The input line (61) may be the output line (6) of Component 2 (14).

The bioreactor apparatus (50) may comprise a reaction vessel (50) for converting the OHD output feedstock (41) to an unpurified food product feedstock (66). The reaction vessel (50) may be seeded with a microorganism, preferably genetically modified yeast and growth supplements (62) for converting the OHD output feedstock (41) to an unpurified food product feedstock (66). The microorganism may be supplied as a dry material in a capsule which can be seeded in the vessel when the bioreactor is to be used.

The microorganism may be a bacterial or yeast cell capable of growing by using the OHD output feedstock (41) as a source of carbon. Preferably, the microbial cell is a yeast cell. Even more preferably, the microorganism is Saccharomyces cerevisiae, Saccharomyces boulardii, Rhodosporidium toruloides, Rhodotorula toruloides, Yarrowia lipolytica or any other suitable yeast, preferably genetically modified, capable of utilizing the OHD output feedstock (41) as carbon source for growth in order to produce an unpurified food product feedstock (66). The genetically modified yeast cells may be referred in this disclosure as micro-bites yeast cells or as μ-bites yeast cells.

The bioreactor (50) is preferably a vessel and more preferably a plastic bag. The bioreactor (50) comprises a substrate inlet (56) for receiving the OHD output feedstock (41). In addition, the bioreactor (50) may comprise a gas inlet (54) for supplying oxygen to the bioreactor (50). The gas inlet (54) may be connected to the oxygen source (36) which may be also used for producing oxygen for the OHD reactor (40). The bioreactor (50) further comprises an inoculation inlet (52) through which the microorganisms are inoculated into the bioreactor (50) when the bioreactor is in use. The bioreactor (50) may further comprise one or more gas outlets (58) for removing gas (carbon dioxide) from the bioreactor (50). Carbon dioxide produced in the bioreactor (50) may be recycled in an apparatus (60). In embodiments, the bioreactor (50) may comprise an outlet such as an output line (64) for collecting yeast cells after growth has been completed. In embodiments, one or more the inlets may be combined into one or the vessel (50) may be engineered with more than one inlets/outlets for the same function.

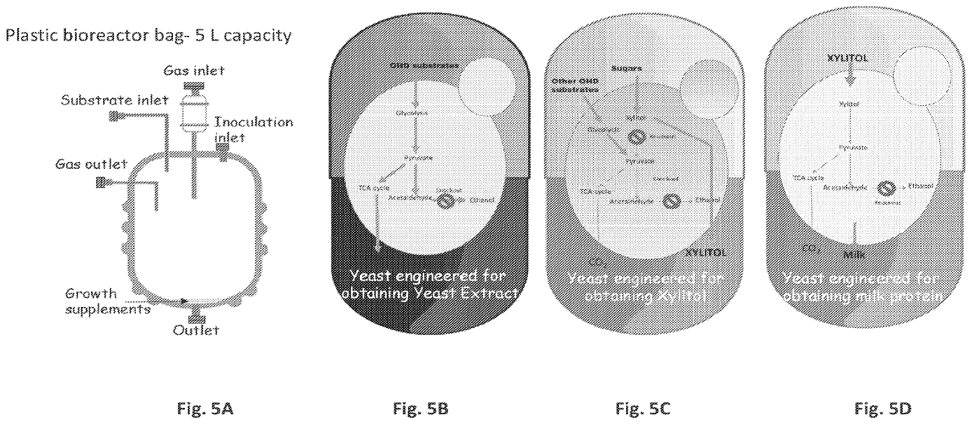

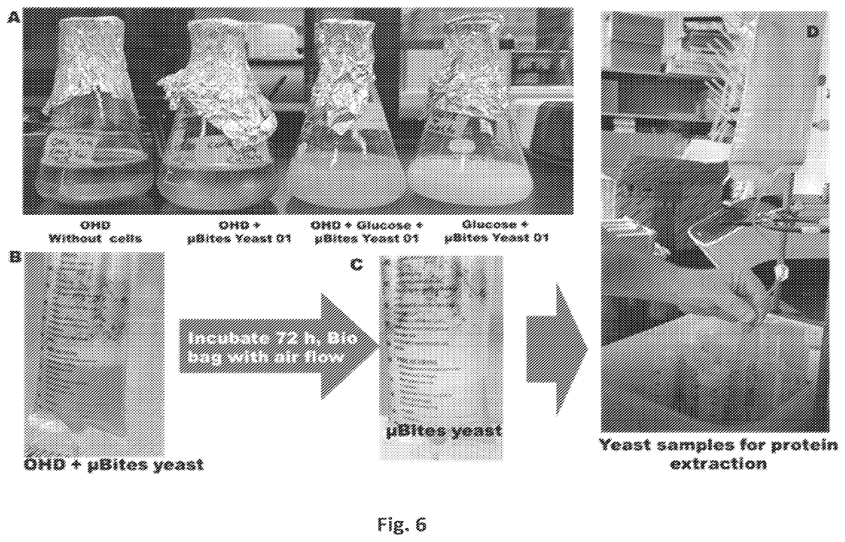

When in use, the microbial cells, such as yeast and/or bacterial cells can be grown in the bioreactor (50) for a period of time from about 10 hours to about 24 or 48 hours, or longer. Various unpurified food product feedstock (66) may be produced in the bioreactor (50), including for producing yeast protein extract and/or for producing a specific food supplement such as xylitol, milk protein or any other nutrient, protein or food supplement, some embodiments of which are depicted in FIG. 5.

In some preferred embodiments, the micro-bites yeast cell may be genetically modified to express at least one or more PET-hydrolases. A preferred PET-hydrolase includes leaf-branch compost cutinase (LCC) or a functional variant thereof, having a hydrolase enzymatic activity for hydrolyzing PET. Preferably, the PET-hydrolase is a recombinant enzyme in which a yeast cell secretion signaling peptide is fused in frame with an opening reading frame (ORF) of LCC and having the amino acid sequence with SEQ ID NO: 17 or a functional variant thereof having at least 70%, 80%, 90%, or at least 95% overall amino acid sequence identity to the peptide with SEQ ID NO: 17. Preferably, the peptide with SEQ ID NO: 17 may be encoded by a nucleic acid sequence having SEQ ID NO: 1 or by a functional variant thereof having at least 70%, 80%, 90%, or at least 95% overall nucleotide sequence identity with SEQ ID NO: 1.

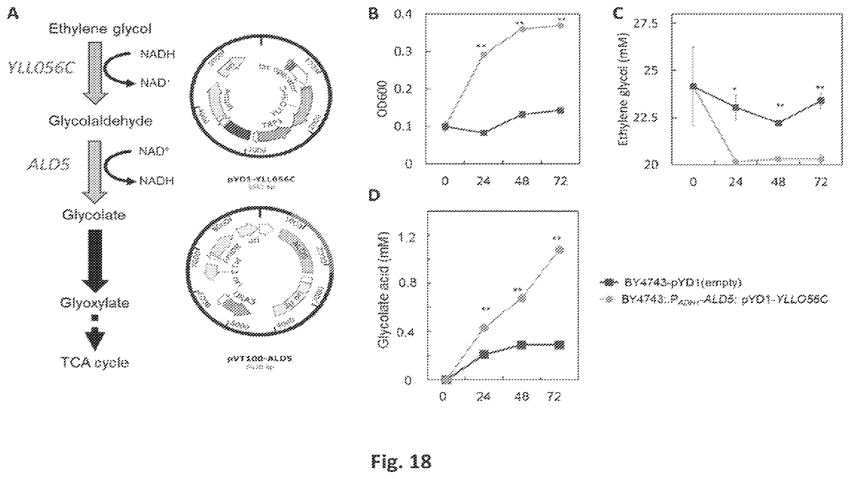

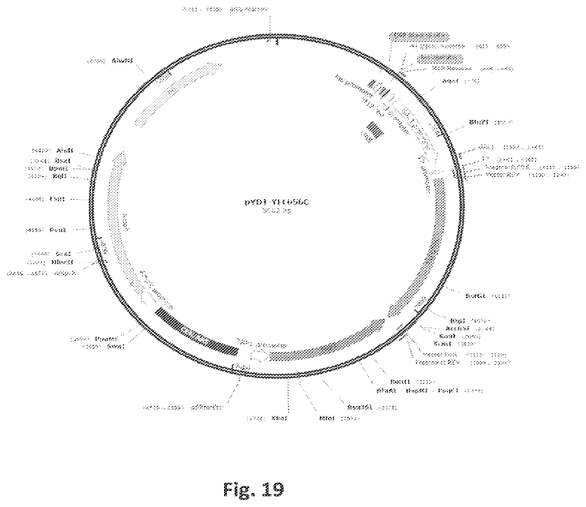

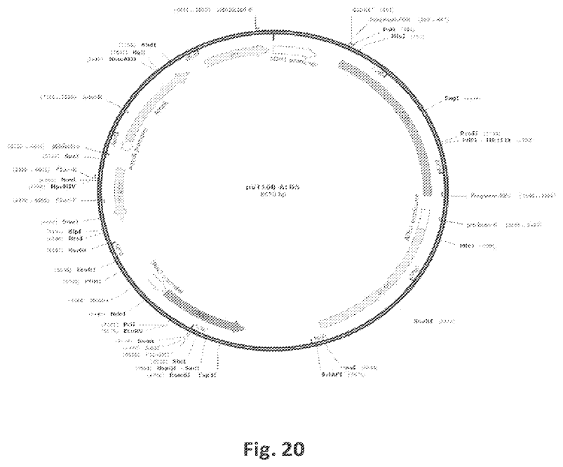

In some embodiments, the micro-bites yeast cell may be genetically modified to overexpress from a promoter, preferably native to the yeast cell, at least one or more of enzymes for using ethylene glycol (EG) as a carbon source. The enzymes may include at least one enzyme for converting EG into glycoladehyde and/or at least one enzyme for converting glycolaldehyde into glycolate, embodiments of which are shown in FIGS. 18, 19 and 20. Preferably, the EG-processing enzymes may include YLLO56C having the amino acid sequence with SEQ ID NO: 24 or a functional variant thereof having at least 70%, 80%, 90%, or at least 95% overall amino acid sequence identity to the peptide with SEQ ID NO: 24, expressed from a heterogenous promoter, as shown in FIGS. 18, 19 and 20. Preferably, the peptide with SEQ ID NO: 24 may be encoded by a nucleic acid sequence having SEQ ID NO: 8 or by a functional variant thereof having at least 70%, 80%, 90%, or at least 95% overall nucleotide sequence identity with SEQ ID NO: 8.

Preferably, the EG-processing enzymes may further include at least one aldehyde dehydrogenase, preferably the aldehyde dehydrogenase (ALD5) having the amino acid sequence with SEQ ID NO: 25 or a functional variant thereof having at least 70%, 80%, 90%, or at least 95% overall amino acid sequence identity to the peptide with SEQ ID NO: 25, expressed from a heterogenous promoter, as shown in FIGS. 18, 19 and 20. Preferably, the peptide with SEQ ID NO: 25 may be encoded by a nucleic acid sequence having SEQ ID NO: 9 or by a functional variant thereof having at least 70%, 80%, 90%, or at least 95% overall nucleotide sequence identity with SEQ ID NO: 9.

In preferred embodiments, the micro-bites yeast cell may comprise one or more of the following recombinant nucleic acids:
SEQ ID NO: 1 or a functional variant therefore having at least 70%, 80%, 90%, or at least 95% overall nucleotide sequence identity with SEQ ID NO: 1;
SEQ ID NO: 2 or a functional variant therefore having at least 70%, 80%, 90%, or at least 95% overall nucleotide sequence identity with SEQ ID NO: 2;
SEQ ID NO: 3 or a functional variant therefore having at least 70%, 80%, 90%, or at least 95% overall nucleotide sequence identity with SEQ ID NO: 3;
SEQ ID NO: 4 or a functional variant therefore having at least 70%, 80%, 90%, or at least 95% overall nucleotide sequence identity with SEQ ID NO: 4;
SEQ ID NO: 5 or a functional variant therefore having at least 70%, 80%, 90%, or at least 95% overall nucleotide sequence identity with SEQ ID NO: 5;
SEQ ID NO: 6 or a functional variant therefore having at least 70%, 80%, 90%, or at least 95% overall nucleotide sequence identity with SEQ ID NO: 6;
SEQ ID NO: 7 or a functional variant therefore having at least 70%, 80%, 90%, or at least 95% overall nucleotide sequence identity with SEQ ID NO: 7;
SEQ ID NO: 8 or a functional variant therefore having at least 70%, 80%, 90%, or at least 95% overall nucleotide sequence identity with SEQ ID NO: 8;
SEQ ID NO: 9 or a functional variant therefore having at least 70%, 80%, 90%, or at least 95% overall nucleotide sequence identity with SEQ ID NO: 9; or
any combination thereof.

In preferred embodiments, the micro-bites yeast cell may express one or more of the following recombinant enzymes:
PET-hydrolase, preferably the PET-hydrolase having the amino acid sequence with SEQ ID NO: 17 or a functional variant therefore having at least 70%, 80%, 90%, or at least 95% overall amino acid sequence identity with SEQ ID NO: 17 and more preferably, the PET-hydrolase being encoded by SEQ ID NO: 1 or by a functional variant thereof having at least 70%, 80%, 90%, or at least 95% overall nucleotide sequence identity with SEQ ID NO: 1;
L-lactate dehydrogenase A, preferably the L-LDH-A-dehydrogenase having the amino acid sequence with SEQ ID NO: 18 or a functional variant therefore having at least 70%, 80%, 90%, or at least 95% overall amino acid sequence identity with SEQ ID NO: 18, and more preferably the L-LDH-A dehydrogenase being encoded by a nucleotide sequence comprising SEQ ID NO: 2 or by a functional variant thereof having at least 70%, 80%, 90%, or at least 95% overall nucleotide sequence identity with SEQ ID NO: 2;
lactose permease, preferably the lactose permease having the amino acid sequence with SEQ ID NO: 19 or a functional variant thereof having at least 70%, 80%, 90%, or at least 95% overall amino acid sequence identity with SEQ ID NO: 19, and more preferably, the lactose permease being encoded by a nucleotide sequence comprising SEQ ID NO: 3 or by a functional variant thereof having at least 70%, 80%, 90%, or at least 95% overall nucleotide sequence identity with SEQ ID NO: 3;
beta glucosidase, preferably the beta glucosidase having the amino acid sequence with SEQ ID NO: 20 or a functional variant thereof having at least 70%, 80%, 90%, or at least 95% overall amino acid sequence identity with SEQ ID NO: 20, and more preferably, the beta glucosidase being encoded by a nucleotide sequence comprising SEQ ID NO: 4 or by a functional variant thereof having at least 70%, 80%, 90%, or at least 95% overall nucleotide sequence identity with SEQ ID NO: 4;
xylose reductase, preferably the xylose reductase having the amino acid sequence with SEQ ID NO: 21 or a functional variant thereof having at least 70%, 80%, 90%, or at least 95% overall amino acid sequence identity with SEQ ID NO: 21, and more preferably, the xylose reductase being encoded by a nucleotide sequence comprising SEQ ID NO: 5 or by a functional variant thereof having at least 70%, 80%, 90%, or at least 95% overall nucleotide sequence identity with SEQ ID NO: 5;
xylitol dehydrogenase, preferably the xylitol dehydrogenase having the amino acid sequence with SEQ ID NO: 22 or a functional variant thereof having at least 70%, 80%, 90%, or at least 95% overall amino acid sequence identity with SEQ ID NO: 22, and more preferably, the xylitol dehydrogenase being encoded by a nucleotide sequence comprising SEQ ID NO: 6 or by a functional variant thereof having at least 70%, 80%, 90%, or at least 95% overall nucleotide sequence identity with SEQ ID NO: 6;
xylulokinase, preferably the xylulokinase having the amino acid sequence with SEQ ID NO: 23 or a functional variant thereof having at least 70%, 80%, 90%, or at least 95% overall amino acid sequence identity with SEQ ID NO: 23, and more preferably, the xylulokinase being encoded by a nucleotide sequence comprising SEQ ID NO: 7 or by a functional variant thereof having at least 70%, 80%, 90%, or at least 95% overall nucleotide sequence identity with SEQ ID NO: 7;
the enzyme converting ethylene glycol into glycol aldehyde, preferably the enzyme having the amino acid sequence with SEQ ID NO: 24 or a functional variant thereof having at least 70%, 80%, 90%, or at least 95% overall amino acid sequence identity with SEQ ID NO: 24, and more preferably, the enzyme being encoded by a nucleotide sequence comprising SEQ ID NO: 8 or by a functional variant thereof having at least 70%, 80%, 90%, or at least 95% overall nucleotide sequence identity with SEQ ID NO: 8;
alcohol dehydrogenase, preferably the alcohol dehydrogenase having the amino acid sequence with SEQ ID NO: 25 or a functional variant thereof having at least 70%, 80%, 90%, or at least 95% overall amino acid sequence identity with SEQ ID NO: 25, and more preferably, the enzyme being encoded by a nucleotide sequence comprising SEQ ID NO: 9 or by a functional variant thereof having at least 70%, 80%, 90%, or at least 95% overall nucleotide sequence identity with SEQ ID NO: 9; or
any combination thereof.

In addition to these genetic modifications for consumption of the OHD output feedstock (41), the micro-bites yeast cell according to this disclosure may comprise one or more additional mutations helping with increasing the total protein productions when the yeast cells are grown in a medium comprising the OHD output feedstock (41).

In addition to converting the OHD output feedstock (41) into an unpurified food product feedstock (66) comprising yeast protein, addition genetic modifications can be introduced such that the micro-bites yeast cell may be engineered in embodiments to produce intracellular yeast protein, vitamins, flavors, aroma, and omega-3 and -6 fatty acids and/or extracellular compounds (e.g., milk proteins and xylitol) from OHD output feedstock (e.g., waste biomass or plastics). Oleaginous yeast strains may be grown on OHD output feedstock to obtain FDA-approved food components such as lipids and β-carotene.

The microorganism may be modified to overexpress the cdt-1 gene. The microorganism may be modified to overexpress the ghl-1 gene. The microorganism may be modified to overexpress the XYL1 gene. The microorganism may be modified to overexpress the XYL2 gene. The microorganism may be modified to overexpress the XYL3 gene. The microorganism may be modified to overexpress the ldhA gene. The microorganism may be modified to overexpress the XYL3 gene. The microorganism may be modified to overexpress the PET degrading LCC gene. The microorganism may be modified to overexpress at least two genes selected from the group consisting of: cdt-1, ghl-1, XYL1, XYL2, XYL3, IdhA, LCC, YLLO56C, ADH5 or any combination thereof.

The output line (64) may be operably connecting the bioreactor apparatus (50) to Component 4 (18).

In some embodiments, an engineered yeast S. cerevisiae (μBites-Yeast01) strain capable of using most OHD output feedstock as the sole carbon source is employed, including oligosaccharides, acid, and aromatics compounds. The strain enables conversion of OHD-substrates to cell biomass (i.e., protein) and lactic acid, and native ethanol production of the strain was eliminated. Initial experiments have been carried out to understand the phenotype of the strain and the growth conditions by performing shake flask experiments. The developed strain can grow on OHD as a sole carbon source. The fermentation was scaled up to 1 L Bio-bag and successfully demonstrated the remarkable yeast growth. Next, it is envisioned to use a 10 L plastic bioreactor bag with supplementation of O₂, and high-biomass productions are expected by optimizing the fermentation conditions. Yeast protein was extracted and used for the 3D printing of μBites food product. A schematic of the bioreactor (Component 3) where OHD substrates are converted to cell biomass and lactic acid is shown in FIGS. 3 and 5A-5D. A series of pictures illustrating the results of the OHD output feedstock conversion is also shown in FIG. 6.

The bioreactor process may be described as setting up and using a biobag, but it is noted that other types of reactors may be used such as a commercial vat or holding tank. Prelature of Y. lipolytica NRRL Y-1094, S. boulardii ATCC MYA-796 (Δleu2, Δura3, Δhis3, Δtrp1), and engineered and microbite yeast (μ-Yeast 01) was made with Yeast Peptone Dextrose (YPD) media. The mid-log phase culture for inoculating the biobag may be obtained by transferring 5 mL overnight culture into 50 mL YPD medium containing the shake flask, and then incubating samples at 300° C. at 225 rpm for 4 hours. The cell pellets may be obtained by centrifugation at 4,000 rpm for 5 min. The cell pellet may be washed with SC media without a carbon source and used to inoculate the 5 L biobag (~initial OD600=0.01). In an embodiment, the biobag may be filled with the Synthetic complete media and OHD substrates (Apple 95% (w/w) and PET 5% (w/w), OHD contained ~8 g/L of TOC, and the media was supplemented with 20 g/L of glucose. SC media contains 1.7 g/L of Yeast Nitrogen Base (YNB) w/o AA and AS (Research Products International Corp, USA), 2.0 g/L of Drop-out mix comp W/O YNB (United States Biological Corporation, USA), and 5.0 g/L of Ammonium sulfate (AS) (Fisher Scientific, USA).

The 5 L of OHD filtered with 0.2 μm filter and inoculated with yeast was pumped into the bio bag using the pump (FIG. 3). The biobag was placed in the incubator at 30° C., and O₂ was pumped into the biobag at 200-300 mL/min; the O₂ enables the aerobic metabolism and purging of the bioreactor (or biobag). After 48 h incubation, culture media was pumped out from the biobag, and cells were separated by centrifugation at 4000 rpm for 5 min.

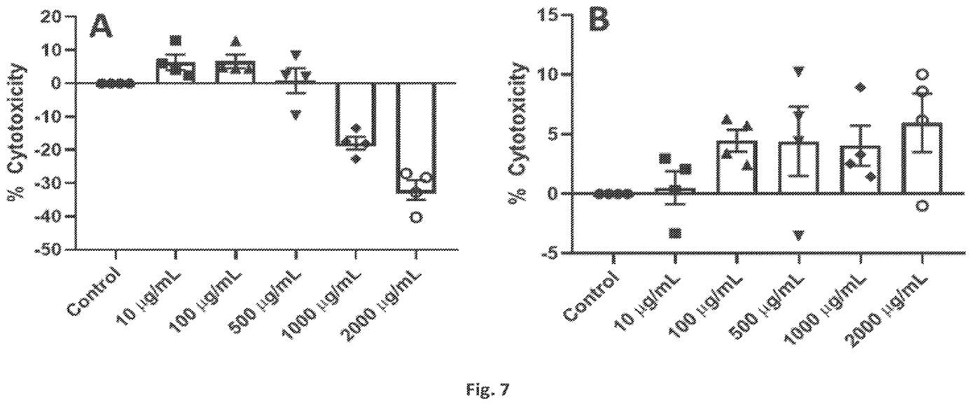

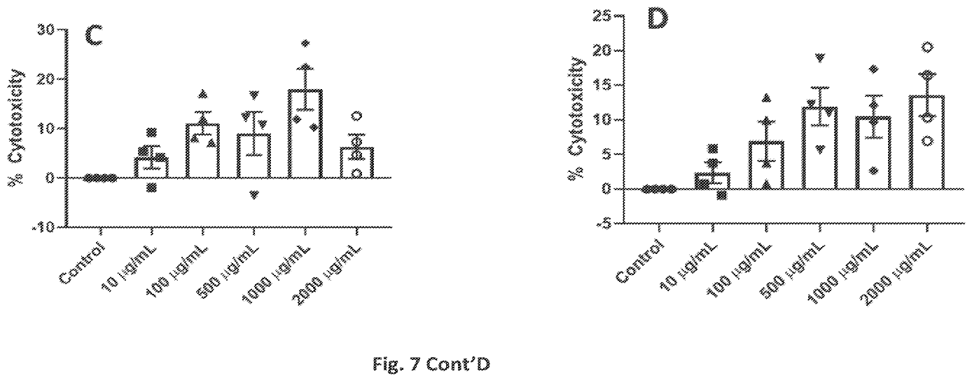

The toxicity of yeast protein obtained through OHD-fermentation was analyzed. Understanding chemical toxicity of OHD output feedstock to microbes and the toxicity of the products (yeast protein) to humans is critical for developing the μ-Bites system (10). The toxicity of OHD output feedstock and yeast protein obtained in the bioreactor component (16) was determined using human endothelial cells (ECs), as described by Guha and coworkers (https://pubs.acs.org/doi/full/10.1021/acs.jafc.0c04526). The data revealed that high concentrations of corn stover and PET OHD output feedstock may be toxic to endothelial cells (FIG. 7A), but yeast fermentation can alleviate the toxicity completely (FIG. 7B). Importantly, the yeast protein extracted through the OHD process has no toxicity (FIG. 7C) and behaves similarly to a protein obtained through the yeast fermented with glucose (FIG. 7D). This analysis confirms that yeast protein-generated through the fermentation is not toxic to the cells. Notably, fermentation alleviated the toxicity of OHD output feedstock. These results suggest that fermented OHD products could be used as a source for food production.

### Component 4: Separation Component (18)

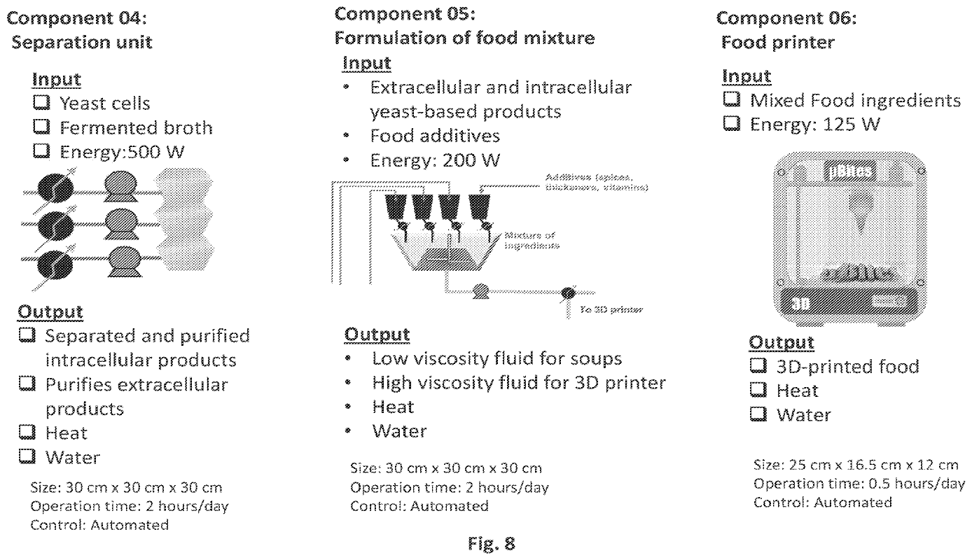

With reference to FIGS. 1 and 8, Component 4 (18) may comprise: an input line (67) for supplying an unpurified food product feedstock (66); a separation apparatus (18) for separating the unpurified food product feedstock (66) into one or more purified food product feedstocks (72, 70 and 68), wastewater (73), and a waste microorganism biomass; a product output line (69, 71 and 75) for supplying the purified food product feedstock (72, 70, and 68) from Component 4 (18) to Component 5 (20); and a water output line (73) for recycling wastewater from Component 4 (18) to the Reverse Osmosis unit (44) of Component 2 (14).

The input line (67) may be operably connected to the separation apparatus (18). The input line (67) may be operably connected to the output line (64) of Component 3 (16). The input line (67) may be the output line (64) of Component 3 (16).

In embodiments and as is shown in FIG. 8, the separation apparatus (18) may comprise a sonication separation apparatus. The separation apparatus (18) may comprise a centrifugation separation apparatus. The separation apparatus may comprise a membrane separation apparatus. The separation apparatus may comprise at least two types of separation apparatuses selected from the group consisting of: a sonication separation apparatus, a centrifugation separation apparatus, a membrane separation apparatus and any combination thereof.

The product output lines (69, 71, and 75) may be operably connected to the separation apparatus (18). The product output lines (69, 71, and 75) may also be operably connected to Component 5 (20). Each product output line (69, 71, and 75) may be operably connected to the separation apparatus (18). Each product output line (69, 71, and 75) may also be operably connected to Component 5 (20).

The waste water output line (73) may be operably connected to the separation apparatus (18). The waste water output line (73) may also be operably connected to the water input line (5) of Component 2 (14). The water output line (73) may be the water input line (5) of Component 2 (14), described above.

### Component 5: Formulation Component (20)

With reference to FIGS. 1 and 8, Component 5 (20) may comprise an input line for supplying a purified food product feedstock (72, 70, and 68), a mixing apparatus (76) for converting the purified food product feedstock (72, 70, and 68) into a usable feedstock, and an output line (78) for supplying the usable feedstock from Component 5 (20) to Component 6 (22).

The input line (69, 71, and 75) may be operably connected to the mixing apparatus (20). The input line (69, 71, and 75) may be operably connected to the product output line of Component 4 (18). The input line (69, 71, and 75) may be the product output line (69, 71, and 75) of Component 4 (18).

Component 5 (20) may comprise multiple input lines (69, 71 and 75). Each input line (69, 71, and 75) may be operably connected to the mixing apparatus (76). Each input line (69, 71, and 75) may also be operably connected to Component 4 (18). The multiple input lines (69, 71, and 75) may be the multiple product output lines (69, 71, and 75) of Component 4 (18).

Component 5 (20) may also comprise a supplemental input line (74) for supplying one or more additional ingredients. The supplemental input line (74) may be operably connected to the mixing apparatus (76).

The mixing apparatus (76) may comprise a paddle type (80) mixing apparatus. The mixing apparatus may comprise a screw type mixing apparatus. The mixing apparatus may comprise multiple types of mixing apparatuses.

The output line (78) may be operably connected to the mixing apparatus (76). The output line (78) may also be operably connected to Component 6 (22).

### Component 6: 3D Printing Component (22)

With reference to FIGS. 1 and 8, Component 6 (22) may comprise an input line (78) for supplying a usable feedstock, a 3D food printing apparatus for converting the usable feedstock into a printed food product (82), and a cooking apparatus (28) for converting the printed food product (82) into an edible food product (84).

The input line (78) may be operably connected to the 3D printing apparatus (22). The input line (78) may be operably connected to the output line of Component 5 (20). The input line (78) may be the output line (78) of Component 5 (20).

The 3D food printing apparatus (22) may comprise any 3D food printer or a cookie cutter. The 3D food printing apparatus (22) may be capable of converting the usable feedstock into various shapes and sizes of a printed food product (82).

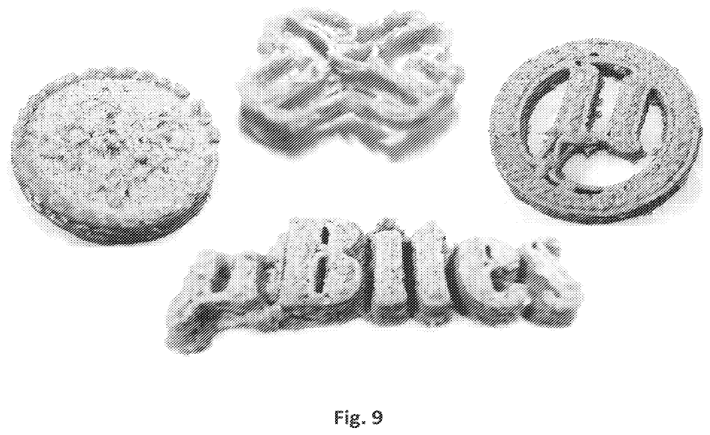

The printed food product (82) may take the form of a portable shape capable of being removed from the 3D printing apparatus and being inserted into and removed from a cooking apparatus (28). Embodiments of the printed food products include cookies such as those shown in a photograph of FIG. 9.

The cooking apparatus (28) may comprise any type of oven technology known in the art capable of heating the printed food product to a temperature deemed high enough to render the resulting edible food product safe for human consumption. Examples of temperatures and times held at those temperatures to convey food safety to a product are well known in the art and may be employed with the cooking apparatus as a guide. The cooking apparatus (28) may be a microwave oven or other portable oven-like device.

A commercial 3D food printer (22) may be successfully used with a single nozzle to print the μBites food product shown in FIG. 9. In this embodiment, the total yeast protein from the OHD culture was extracted by sonication, centrifugation, and membrane filtration steps. The extracted protein (2 g/mL) was mixed with Oatmeal, xylitol, salt, and water, and made the mixture (based on the μBites recipe). The mixture was loaded into the plastic cartilage with a plastic nozzle and printed into the μBites cookies on a cellulose mat, and then microwaved into final printed products.

### Component 7: Analytical Sensor Component (24)

Referring to FIGS. 1, 8 and 11, Component 7 (24) may include a machine learning (ML) that is based in a processor and is combined with biosensors. This component 7 is used to determine food-borne pathogens (such as bacteria and fungi) and hazardous substances. Biosensors may be optionally integrated with Raman to increase sensitivity of detection of pathogens or compounds. ML approach with mathematical and physics-based models are used to identify and interpret the molecular bands of Raman spectra robustly.

Once the spectra from a Raman spectrometer (24) are collected and preprocessed, ML algorithms are optimized in conjunction with dimension reduction techniques to create models with a high level of accuracy and specificity that can be saved and quickly to identify patterns and signatures from the Raman spectrum. Identified patterns and signatures in the Raman spectra are combined with biosensors' reading to predict the food quality and safety. A custom, in-house written Python code with data mining and data analysis tools such as Pandas, Scikit-learn, Keras, TensorFlow, and PyTorch may be used to analyze the entire Raman spectra and the reading from sensors at once and quickly. Deep Neural Networks (DNNs) are optionally adopted to improve accuracy further, develop a complex representation of spectra, and classify using the weight of known molecular information. DNNs will be implemented using Keras, which supports both Theano and TensorFlow libraries (widely used by ML communities).

A Raman spectrometer (24) may be connected to various components in the system (10) such that the Raman spectrometer (24) analyses and monitors a composition of the output feedstock, unpurified product feedstock, purified product feedstock, usable feedstock, re-cycled water and/or an edible food product while the system (10) is in use.

### Component 8: Control Interface Component (26)

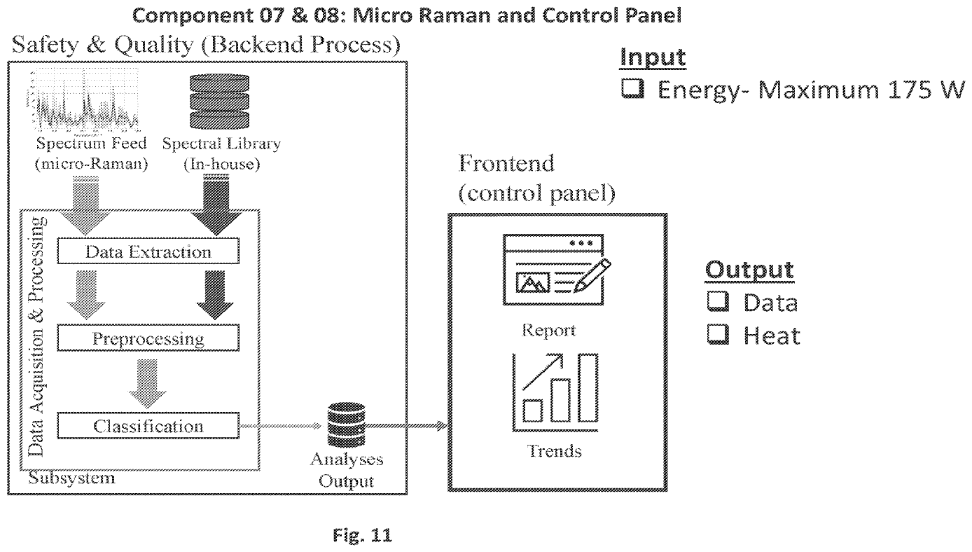

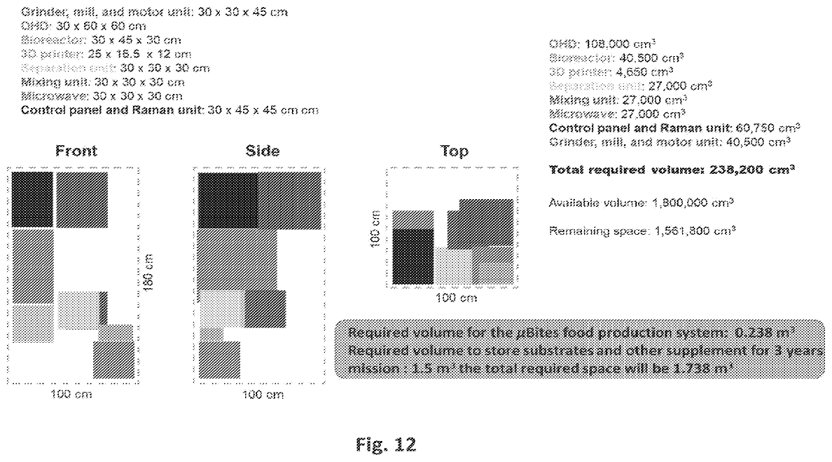

Referring to FIGS. 1 and 11, the control interface component (26) leverages a control unit or a control panel. The 3D food printer (22) is interfaced to an electronic computing and communication device through a microcontroller. This device may be wirelessly connected to the Internet and thereby constituting the notion of Internet-of-Things.

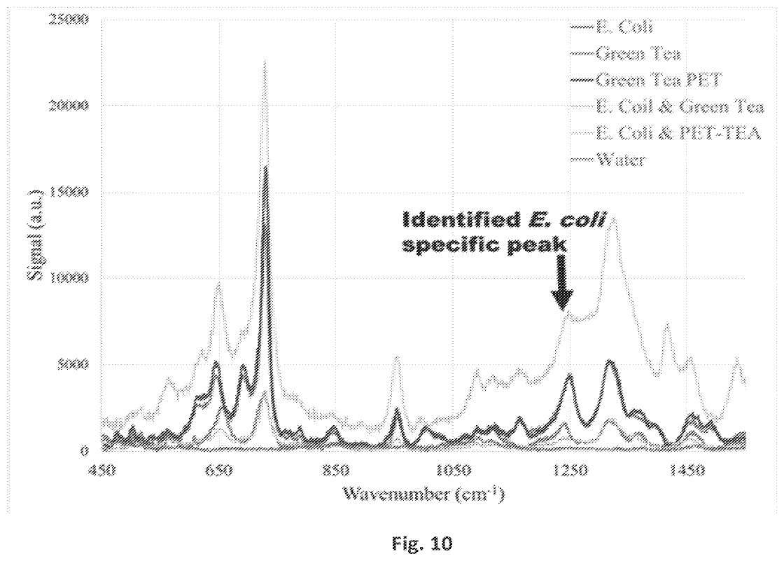

The food production system (10) is preferably operated via a wireless communication approach with an AI-guided controls system. Although this is the preferred approach, a hard-wired operation is also contemplated if the environment is better suited for a wired system. The safety and quality of each step in the μBites system (10) may be monitored via high-throughput sensors and Raman system (24) (results from Raman testing shown in FIG. 10). A machine learning approach with mathematical and physics-based models will be used to identify and interpret the molecular signatures and their source within the samples using Raman spectra. The non-invasive, in vivo analysis of the samples will be used to infer the safety and quality of the food. All the system components and a schematic of Components 7 (24) and 8 (26) are shown in FIG. 11.

In order to simulate operations, the wireless communications and control module, a mobile phone application has been developing to automate the system including menu selections and 3D printing of the selected food type. The 3D food printer may be connected to an electronic device with the Long Term Evolution (LTE) communications interface. The mobile phone with the aforementioned application may be connected to the 3D food printer via a private/secure LTE network. Thereby, the remote controlling of 3D food printing may be accomplished. The inbuilt wireless connectivity of the spacecraft can be utilized to enable remote controlling of 3D food painting process. The 3D food printer may be interfaced into a microcontroller or an electronic computing device. This controller can be wirelessly connected to the Internet and thereby constituting the notion of Internet-of-Things. Moreover, a mobile phone application may be developed to automate the system (10), including menu selections and 3D printing of the selected food type. By using this set-up, remote control of the 3D food printing process may be achieved. Thus, the inbuilt wireless connectivity of a spacecraft can be utilized to enable remote controlling of 3D food painting process.

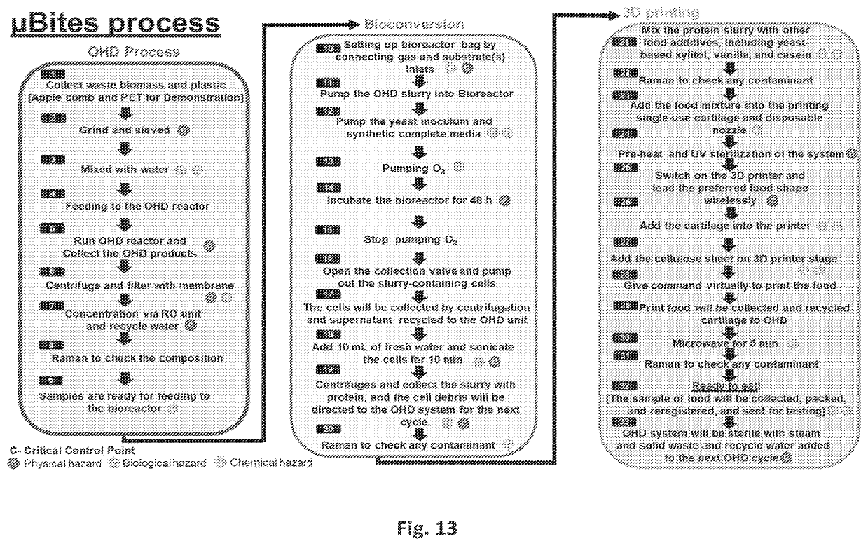

With reference to FIG. 13, this disclosure relates in another aspect to methods for producing food products by using the food production system (10) which may be controlled by a control panel. A mobile phone application or other computer application is used to automate the 3D food printing process so that the users can conveniently select food types, shapes, and nutrient contents through a menu with multiple options based on their preferences and nutrient needs.

Data related to the user preferences on food types, shapes and nutrient contents can be stored and used to train supervised machine learning models to facilitate artificial intelligent based predictive analytics on the system parameters of the entire process.

In case of a system malfunction, safety concern, or maintenance/repair, the control panel will shut down the food production system and each component will also be isolated using flow control valves automatically. The control panel will preferably warn the user about the potential risk and errors and step-by-step instructions to solve the problem.

In another aspect, this disclosure relates to methods for producing food products comprising yeast protein and/or other ingredients obtained by using the system (10). Such food products may include but are not limited to pasta, pizza, protein shakes and cookies to name a few. In particularly preferred embodiments, this disclosure provides cookies produced in the system (10) according to this disclosure.

### Ingredients for a Cookie

Commercially available food ingredients were purchased and mixed well and added to the 3D printing cartridge. The food cartridge was placed into the Foodbot S2 Multi Ingredient Food 3D Printer with a single nozzle (3D printer Online Store, Portland, USA). The printing model was developed by using the CURA; CURA is an open-source slicing application for 3D printers. The developed microcontroller fed the encoded “gcode” file into the printed. The model was printed on butter paper (approximately 20 min).

A yeast protein containing slurry was used to make a cookie mixture. Some examples of additional ingredients that could be used include salt, ground ginger, ground cinnamon, xylitol, water, yeast (from the micro-Bite), vanilla extract, and oatmeal powder. One particularly preferred recipe for the μBites cookies is as follows:

2 g of salt
2 g of ground ginger
2 g of ground cinnamon
10 g of xylitol
100 mL of water
Protein obtained from 100 g of micro-Bites yeast (Wet-basis)
½ teaspoon vanilla extract
50 g of oatmeal powder

The printed food item may be microwaved for 4 min using a microwave (1050 W/pizza setting). It is appreciated that other heating means may be employed such as an oven or toaster or heated liquid.

The μBites system additionally innovates food production by combining various engineered nutritive raw materials produced by yeast with the versatility of an optional food 3D printing process. Using the optional food 3D printing process, a painter's pallet of food styles is achieved (e.g., liquids to solids or protein to sugar richness), which meets human dietary needs and nourishes the human psyche. These significant μBites features of customization and sustainability under low resources greatly enhances the capabilities of human exploration, especially overlong journeys or severely isolating experiences as may be encountered during space travel.

A modular design, simple maintenance, and portability make the μBites system uniquely adaptable to any environment. With minimal required inputs and the majority of starting materials reused over consecutive food productions, the overhead energy requirements do not exceed 3 kwh. Besides customizability for the user, an AI algorithm monitors all aspects of the automated nature of the various unit operations, ensuring quality and safety. Efficient recirculation of left-over materials (water, yeast, and reactor bags) reduces the overall impact on resource demand by the μBites system which is especially useful in extreme environments and resource-scarce regions.

Thus, the disclosed technology offers various food options from currently underutilized carbon sources that can be deployed on Earth in urban, rural, or harsh environments where food security is a chronic problem. The disclosed technology may optionally be used in non-Earth environments such as space missions or planetary/satellite colonization or exploration missions.

The μBites food production technology also has a high potential to improve terrestrial food production while positively affecting the environment. In particular, the proposed solution should gain value in coming decades worldwide as it addresses two critical global challenges which are the scarcity of food and accumulating plastic waste.

The μBites technology mitigates food insecurity by promoting the efficient use of waste materials as a primary carbon source, ensuring an efficient water economy, and using other, less common inputs for producing food. Moreover, the modularity intrinsic to our proposed food production could provide the appropriate variation in nutrient composition to fit the specific need of a wide array of populations with cultural and culinary diversity. The simplicity and automation of the proposed process would also require minimal human involvement, thus, circumventing poor hygienic practices among poor and remote populations that could lead to infection. Therefore, our proposed approach could enable technologies with a reduced impact on the resources needed for food production, especially in extreme environments and resource-scarce regions. Military applications are also contemplated where μBites systems could be installed on naval ships, especially submarines. Remote locations such as the Arctic and Antarctic would provide a reliable food source when weather conditions prevent resupply runs by plane or boat. The μBites system provides the protein required for animal consumption with very low/zero greenhouse gas emissions and minimum water use relative to current protein production technologies.

### Sequences and Mutations

The amino acid sequences and nucleic acid sequences described herein may contain various mutations. Mutations may include insertions, substitutions, and deletions. Insertions are written as follows: (+)(amino acid/nucleic acid sequence position number)(inserted amino acid/nucleic acid base). For example, +287A would mean an insertion of an alanine residue after position 287 in the corresponding amino acid sequence. Substitutions are written as follows: (amino acid/nucleic acid base to be replaced) (amino acid/nucleic acid sequence position number)(substituted amino acid/nucleic acid base). For example, C1082A would mean a substitution of an adenine base instead of a cytosine base at position 1082 in the corresponding nucleic acid sequence. Deletions are written as follows: (amino acid/nucleic acid base to be deleted) (amino acid/nucleic acid sequence position number)(−). For example, C970—would mean a deletion of the cytosine base normally located at position 970 in the corresponding nucleic acid sequence.

The amino acid sequences and nucleic acid sequences described herein may contain mutations at various sequence positions. Sequence positions may be written a variety a ways for convenience. More specifically, sequence positions may be written from either the beginning of the sequence as a positive position number, or from the end of the sequence as a negative number. Sequence positions may be converted easily between a positive notation and a negative notation by comparing to the sequence length and either adding or subtracting the sequence length. For example, a promoter containing 10 nucleic acid bases with a mutation from cytosine to adenine at the second position from the start of the sequence may be written as C2A. Alternatively, this mutation may be written as C(−9)A, −9C/A, or in a similar fashion denoting the negative position number.

### Definitions and Alternative Embodiments

The following definitions and methods are provided to better define the present invention and to guide those of ordinary skill in the art in the practice of the present invention. Unless otherwise noted, terms are to be understood according to conventional usage by those of ordinary skill in the relevant art.

An “allele” refers to one of two or more alternative forms of a genomic sequence at a given locus on a chromosome.

The term “chimeric” is understood to refer to the product of the fusion of portions of two or more different polynucleotide molecules. “Chimeric promoter” is understood to refer to a promoter produced through the manipulation of known promoters or other polynucleotide molecules. Such chimeric promoters can combine enhancer domains that can confer or modulate gene expression from one or more promoters or regulatory elements, for example, by fusing a heterologous enhancer domain from a first promoter to a second promoter with its own partial or complete regulatory elements. Thus, the design, construction, and use of chimeric promoters according to the methods disclosed herein for modulating the expression of operably linked polynucleotide sequences are encompassed by the present disclosure.

Novel chimeric promoters can be designed or engineered by a number of methods. For example, a chimeric promoter may be produced by fusing an enhancer domain from a first promoter to a second promoter. The resultant chimeric promoter may have novel expression properties relative to the first or second promoters. Novel chimeric promoters can be constructed such that the enhancer domain from a first promoter is fused at the 5′ end, at the 3′ end, or at any position internal to the second promoter.

A “construct” is generally understood as any recombinant nucleic acid molecule such as a plasmid, cosmid, virus, autonomously replicating nucleic acid molecule, phage, or linear or circular single-stranded or double-stranded DNA or RNA nucleic acid molecule, derived from any source, capable of genomic integration or autonomous replication, comprising a nucleic acid molecule where one or more nucleic acid molecule has been operably linked.

A construct of the present disclosure can contain a promoter operably linked to a transcribable nucleic acid molecule operably linked to a 3′ transcription termination nucleic acid molecule. In addition, constructs can include but are not limited to additional regulatory nucleic acid molecules from, e.g., the 3′-untranslated region (3′ UTR). Constructs can include but are not limited to the 5′ untranslated regions (5′ UTR) of an mRNA nucleic acid molecule, which can play an important role in translation initiation and can also be a genetic component in an expression construct. These additional upstream and downstream regulatory nucleic acid molecules may be derived from a source that is native or heterologous with respect to the other elements present on the promoter construct.

“Expression vector”, “vector”, “expression construct”, “vector construct”, “plasmid”, or “recombinant DNA construct” is generally understood to refer to a nucleic acid that has been generated via human intervention, including by recombinant means or direct chemical synthesis, with a series of specified nucleic acid elements that permit transcription or translation of a particular nucleic acid in, for example, a host cell. The expression vector can be part of a plasmid, virus, or nucleic acid fragment. Typically, the expression vector can include a nucleic acid to be transcribed operably linked to a promoter.

The term “genotype” means the specific allelic makeup of an organism.

The terms “heterologous DNA sequence”, “exogenous DNA segment” or “heterologous nucleic acid,” as used herein, each refer to a sequence that originates from a source foreign to the particular host cell or, if from the same source, is modified from its original form. Thus, a heterologous gene in a host cell includes a gene that is endogenous to the particular host cell but has been modified through, for example, the use of DNA shuffling. The terms also include non-naturally occurring multiple copies of a naturally occurring DNA sequence. Thus, the terms refer to a DNA segment that is foreign or heterologous to the cell, or homologous to the cell but in a position within the host cell nucleic acid in which the element is not ordinarily found. Exogenous DNA segments are expressed to yield exogenous polypeptides. A “homologous” DNA sequence is a DNA sequence that is naturally associated with a host cell into which it is introduced.

“Highly stringent hybridization conditions” are defined as hybridization at 65° C. in a 6×SSC buffer (i.e., 0.9 M sodium chloride and 0.09 M sodium citrate). Given these conditions, a determination can be made as to whether a given set of sequences will hybridize by calculating the melting temperature (Tₘ) of a DNA duplex between the two sequences. If a particular duplex has a melting temperature lower than 65° C. in the salt conditions of a 6×SSC, then the two sequences will not hybridize. On the other hand, if the melting temperature is above 65° C. in the same salt conditions, then the sequences will hybridize. In general, the melting temperature for any hybridized DNA:DNA sequence can be determined using the following formula: Tₘ=81.5° C.+16.6(log₁₀[Na^{+]})+0.41(fraction G/C content)−0.63(% formamide)−(600/l). Furthermore, the Tₘ of a DNA:DNA hybrid is decreased by 1-1.5° C. for every 1% decrease in nucleotide identity [see Sambrook and Russel, 2006].

The term “introgressed,” when used in reference to a genetic locus, refers to a genetic locus that has been introduced into a new genetic background. Introgression of a genetic locus can thus be achieved through plant breeding methods and/or by molecular genetic methods. Such molecular genetic methods include, but are not limited to, various plant transformation techniques and/or methods that provide for homologous recombination, non-homologous recombination, site-specific recombination, and/or genomic modifications that provide for locus substitution or locus conversion.

The term “linked,” when used in the context of nucleic acid markers and/or genomic regions, means that the markers and/or genomic regions are located on the same linkage group or chromosome.

A “marker” means a detectable characteristic that can be used to discriminate between organisms. Examples of such characteristics include, but are not limited to, genetic markers, biochemical markers, metabolites, morphological characteristics, and agronomic characteristics.

A “marker gene” refers to any transcribable nucleic acid molecule whose expression can be screened for or scored in some way.

Certain genetic markers useful in the present disclosure include “dominant” or “codominant” markers. “Codominant” markers reveal the presence of two or more alleles (two per diploid individual). “Dominant” markers reveal the presence of only a single allele. The presence of the dominant marker phenotype (e.g., a band of DNA) is an indication that one allele is present in either the homozygous or heterozygous condition. The absence of the dominant marker phenotype (e.g., absence of a DNA band) is merely evidence that “some other” undefined allele is present. In the case of populations where individuals are predominantly homozygous and loci are predominantly dimorphic, dominant and codominant markers can be equally valuable. As populations become more heterozygous and multiallelic, codominant markers often become more informative of the genotype than dominant markers.

“Operably-linked” or “functionally linked” refers preferably to the association of nucleic acid sequences on a single nucleic acid fragment so that the function of one is affected by the other. For example, a regulatory DNA sequence is said to be “operably linked to” or “associated with” a DNA sequence that codes for an RNA or a polypeptide if the two sequences are situated such that the regulatory DNA sequence affects expression of the coding DNA sequence (i.e., that the coding sequence or functional RNA is under the transcriptional control of the promoter). Coding sequences can be operably-linked to regulatory sequences in sense or antisense orientation. The two nucleic acid molecules may be part of a single contiguous nucleic acid molecule and may be adjacent. For example, a promoter is operably linked to a gene of interest if the promoter regulates or mediates transcription of the gene of interest in a cell.

The term “phenotype” means the detectable characteristics of a cell or organism that can be influenced by gene expression.

The term “population” means a genetically heterogenous collection of organisms that share a common parental derivation.

A “promoter” is generally understood as a nucleic acid control sequence that directs transcription of a nucleic acid. An inducible promoter is generally understood as a promoter that mediates transcription of an operably linked gene in response to a particular stimulus. A promoter can include necessary nucleic acid sequences near the transcription start site, such as, in the case of a polymerase II type promoter, a TATA element. A promoter can optionally include distal enhancer or repressor elements, which can be located as much as several thousand base pairs from the start site of transcription.

A “quantitative trait locus (QTL)” is a chromosomal location that encodes for alleles that affect the expressivity of a phenotype.

A “transcribable nucleic acid molecule” as used herein refers to any nucleic acid molecule capable of being transcribed into a RNA molecule. Methods are known for introducing constructs into a cell in such a manner that the transcribable nucleic acid molecule is transcribed into a functional mRNA molecule that is translated and therefore expressed as a protein product. Constructs may also be constructed to be capable of expressing antisense RNA molecules, in order to inhibit translation of a specific RNA molecule of interest. For the practice of the present disclosure, conventional compositions and methods for preparing and using constructs and host cells are well known to one skilled in the art [Sambrook and Russel, 2006; Ausubel et al.; Sambrook and Russel, 2001; Elhai and Wolk].

The “transcription start site” or “initiation site” is the position surrounding a nucleotide that is part of the transcribed sequence, which is also defined as position+1. With respect to this site all other sequences of the gene and its controlling regions can be numbered. Downstream sequences (i.e., further protein encoding sequences in the 3′ direction) can be denominated positive, while upstream sequences (mostly of the controlling regions in the 5′ direction) can be denominated as negative.

The term “transformation” refers to the transfer of a nucleic acid fragment into the genome of a host cell, resulting in genetically stable inheritance. Host cells containing the transformed nucleic acid fragments are referred to as “transgenic” cells, and organisms comprising transgenic cells are referred to as “transgenic organisms”.

“Transformed,” “transgenic,” and “recombinant” refer to a host cell or organism such as a plant into which a heterologous nucleic acid molecule has been introduced. The nucleic acid molecule can be stably integrated into the genome as generally known in the art. Known methods of PCR include, but are not limited to, methods using paired primers, nested primers, single specific primers, degenerate primers, gene-specific primers, vector-specific primers, partially mismatched primers, and the like. The term “untransformed” refers to normal cells that have not been through the transformation process.

“Wild-type” refers to a virus or organism, or any of their components, found in nature without any known mutation.

In some embodiments, numbers expressing quantities of ingredients, properties such as molecular weight, reaction conditions, and so forth, used to describe and claim certain embodiments of the present disclosure are to be understood as being modified in some instances by the term “about.” In some embodiments, the term “about” is used to indicate that a value includes the standard deviation of the mean for the device or method being employed to determine the value. In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable. The numerical values presented in some embodiments of the present disclosure may contain certain errors necessarily resulting from the standard deviation found in their respective testing measurements. The recitation of ranges of values herein is merely intended to serve as a shorthand method of referring individually to each separate value falling within the range. Unless otherwise indicated herein, each individual value is incorporated into the specification as if it were individually recited herein.

Nucleotide and/or amino acid sequence identity percent (%) is understood as the percentage of nucleotide or amino acid residues that are identical with nucleotide or amino acid residues in a candidate sequence in comparison to a reference sequence when the two sequences are aligned. To determine percent identity, sequences are aligned and if necessary, gaps are introduced to achieve the maximum percent sequence identity. Sequence alignment procedures to determine percent identity are well known to those of skill in the art. Often publicly available computer software such as BLAST, BLAST2, ALIGN2 or Megalign (DNASTAR) software is used to align sequences. Those skilled in the art can determine appropriate parameters for measuring alignment, including any algorithms needed to achieve maximal alignment over the full-length of the sequences being compared. When sequences are aligned, the percent sequence identity of a given sequence A to, with, or against a given sequence B (which can alternatively be phrased as a given sequence A that has or comprises a certain percent sequence identity to, with, or against a given sequence B) can be calculated as: percent sequence identity=X/Y100, where X is the number of residues scored as identical matches by the sequence alignment program's or algorithm's alignment of A and B and Y is the total number of residues in B. If the length of sequence A is not equal to the length of sequence B, the percent sequence identity of A to B will not equal the percent sequence identity of B to A.

In some embodiments, the terms “a” and “an” and “the” and similar references used in the context of describing a particular embodiment (especially in the context of certain of the following claims) can be construed to cover both the singular and the plural, unless specifically noted otherwise. When used in conjunction with the word “comprising” or other open language in the claims, the words “a” and “an” denote “one or more,” unless specifically noted.

In some embodiments, the term “or” as used herein, including the claims, is used to mean “and/or” unless explicitly indicated to refer to alternatives only or the alternatives are mutually exclusive.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or embodiments of the present disclosure disclosed herein are not to be construed as limitations. Each group member can be referred to and claimed individually or in any combination with other members of the group or other elements found herein. One or more members of a group can be included in, or deleted from, a group for reasons of convenience or patentability. When any such inclusion or deletion occurs, the specification is herein deemed to contain the group as modified thus fulfilling the written description of all Markush groups used in the appended claims.

### Genetically Modified Yeast

In another aspect, this disclosure relates to a genetically modified yeast cell which may be referred in this disclosure as micro-bites yeast cell or μ-bites yeast cell and which has been genetically modified such that the micro-bites yeast cell can utilize the OHD substrate (feedstock) as a carbon source, preferably the OHD substrate comprising one or more of the following: PET, OHD-hydrolyzed biomass and/or EG.

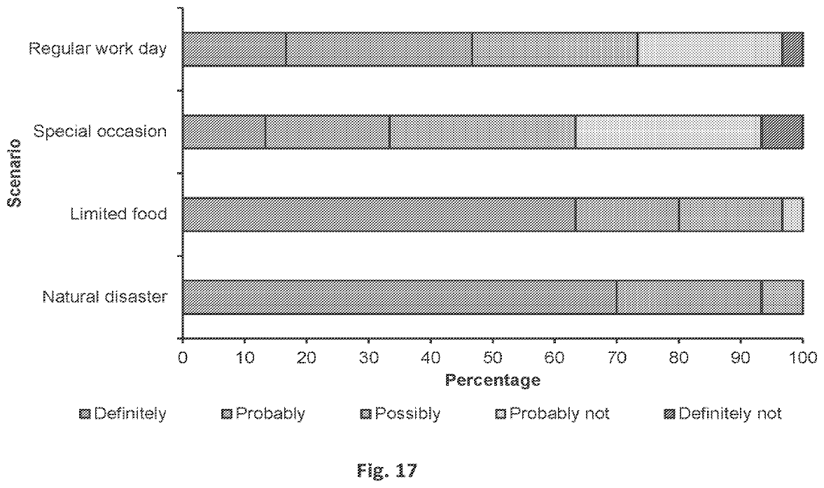

Examples of genetic modifications in the micro-bites yeast cell according to this disclosure include, but are not limited to, expressing one or more heterogenous enzymes in the micro-bites yeast cell, overexpressing one or more enzymes which are already expressed in the host yeast cell and/or disrupting expression of one or more enzymes. The enzymes which are to be expressed heterologously may be expressed from a plasmid for example as shown in FIGS. 17-19 or they may be expressed by being integrated into the host yeast genome. Suitable host yeast species include any yeast cells that are appropriate for human consumption. Suitable host yeast species may include, but are not limited to, Saccharomyces cerevisiae, Saccharomyces boulardii, Rhodosporidium toruloides, Rhodotorula toruloides, Yarrowia lipolytica or any other suitable yeast species genetically modified and/or gene edited to enzymatically hydrolyze the OHD feedstock and utilize the OHD feedstock as a carbon source for growth.

In some preferred embodiments, the micro-bites yeast cell may be genetically modified to express at least one or more PET-hydrolases. A preferred PET-hydrolase includes leaf-branch compost cutinase (LCC) or a functional variant thereof, having a hydrolase enzymatic activity for hydrolyzing PET. Preferably, the PET-hydrolase is a recombinant enzyme in which a yeast cell secretion signaling peptide is fused in frame with an opening reading frame (ORF) of LCC and having the amino acid sequence with SEQ ID NO: 17 or a functional variant thereof having at least 70%, 80%, 90%, or at least 95% overall amino acid sequence identity to the peptide with SEQ ID NO: 17. Preferably, the peptide with SEQ ID NO: 17 may be encoded by a nucleic acid sequence having SEQ ID NO: 1 or by a functional variant thereof having at least 70%, 80%, 90%, or at least 95% overall nucleotide sequence identity with SEQ ID NO: 1.

In some embodiments, the micro-bites yeast cell may be genetically modified to express at least one or more lactate dehydrogenase, preferably, L-lactate dehydrogenase A and more preferably, LDH-A having the amino acid sequence with SEQ ID NO: 18 or a functional variant thereof having at least 70%, 80%, 90%, or at least 95% overall amino acid sequence identity to the peptide with SEQ ID NO: 18. Preferably, the peptide with SEQ ID NO: 18 may be encoded by a nucleic acid sequence having SEQ ID NO: 2 or by a functional variant thereof having at least 70%, 80%, 90%, or at least 95% overall nucleotide sequence identity with SEQ ID NO: 2.

In some embodiments, the micro-bites yeast cell may be genetically modified to express at least one or more substrate transporters and/or permeases, preferably, the lactose permease and more preferably, lactose permease having amino acid sequence with SEQ ID NO: 19 or a functional variant thereof having at least 70%, 80%, 90%, or at least 95% overall amino acid sequence identity to the peptide with SEQ ID NO: 19. Preferably, the peptide with SEQ ID NO: 19 may be encoded by a nucleic acid sequence having SEQ ID NO: 3 or by a functional variant thereof having at least 70%, 80%, 90%, or at least 95% overall nucleotide sequence identity with SEQ ID NO: 3.

In some embodiments, the micro-bites yeast cell may be genetically modified to express at least one or more of beta-glucosidases, preferably the beta-glucosidase having amino acid sequence with SEQ ID NO: 20 or a functional variant thereof having at least 70%, 80%, 90%, or at least 95% overall amino acid sequence identity to the peptide with SEQ ID NO: 20. Preferably, the peptide with SEQ ID NO: 20 may be encoded by a nucleic acid sequence having SEQ ID NO: 4 or by a functional variant thereof having at least 70%, 80%, 90%, or at least 95% overall nucleotide sequence identity with SEQ ID NO: 4.

In some embodiments, the micro-bites yeast cell may be genetically modified to express at least one or more of xylose reductases which may convert xylose into xylitol, preferably the xylose reductase (XYL1) having the amino acid sequence with SEQ ID NO: 21 or a functional variant thereof having at least 70%, 80%, 90%, or at least 95% overall amino acid sequence identity to the peptide with SEQ ID NO: 21. Preferably, the peptide with SEQ ID NO: 21 may be encoded by a nucleic acid sequence having SEQ ID NO: 5 or by a functional variant thereof having at least 70%, 80%, 90%, or at least 95% overall nucleotide sequence identity with SEQ ID NO: 5.

In some embodiments, the micro-bites yeast cell may be genetically modified to express at least one or more of xylitol dehydrogenase, preferably the xylitol dehydrogenase (XYL2) having the amino acid sequence with SEQ ID NO: 22 or a functional variant thereof having at least 70%, 80%, 90%, or at least 95% overall amino acid sequence identity to the peptide with SEQ ID NO: 22. Preferably, the peptide with SEQ ID NO: 22 may be encoded by a nucleic acid sequence having SEQ ID NO: 6 or by a functional variant thereof having at least 70%, 80%, 90%, or at least 95% overall nucleotide sequence identity with SEQ ID NO: 6.

In some embodiments, the micro-bites yeast cell may be genetically modified to express at least one or more of xylulokinases, preferably the xylulokinase (XYL3) having the amino acid sequence with SEQ ID NO: 23 or a functional variant thereof having at least 70%, 80%, 90%, or at least 95% overall amino acid sequence identity to the peptide with SEQ ID NO: 23. Preferably, the peptide with SEQ ID NO: 23 may be encoded by a nucleic acid sequence having SEQ ID NO: 7 or by a functional variant thereof having at least 70%, 80%, 90%, or at least 95% overall nucleotide sequence identity with SEQ ID NO: 7.

In some embodiments, the micro-bites yeast cell may be genetically modified to overexpress from a heterogenous promoter at least one or more of enzymes for using ethylene glycol (EG) as a carbon source. The enzymes may include at least one enzyme for converting EG into glycoladehyde and/or at least one enzyme for converting glycolaldehyde into glycolate, embodiments of which are shown in FIGS. 18, 19, and 20. Preferably, the EG-processing enzymes may include YLLO56C having the amino acid sequence with SEQ ID NO: 24 or a functional variant thereof having at least 70%, 80%, 90%, or at least 95% overall amino acid sequence identity to the peptide with SEQ ID NO: 24, expressed from a heterogenous promoter, as shown in FIGS. 18, 19, and 20. Preferably, the peptide with SEQ ID NO: 24 may be encoded by a nucleic acid sequence having SEQ ID NO: 8 or by a functional variant thereof having at least 70%, 80%, 90%, or at least 95% overall nucleotide sequence identity with SEQ ID NO: 8.

Preferably, the EG-processing enzymes may further include at least one aldehyde dehydrogenase, preferably the aldehyde dehydrogenase (ALD5) having the amino acid sequence with SEQ ID NO: 25 or a functional variant thereof having at least 70%, 80%, 90%, or at least 95% overall amino acid sequence identity to the peptide with SEQ ID NO: 25, expressed from a heterogenous promoter, as shown in FIGS. 18, 19 and 20. Preferably, the peptide with SEQ ID NO: 25 may be encoded by a nucleic acid sequence having SEQ ID NO: 9 or by a functional variant thereof having at least 70%, 80%, 90%, or at least 95% overall nucleotide sequence identity with SEQ ID NO: 9.

In preferred embodiments, the micro-bites yeast cell may comprise one or more of the following recombinant nucleic acids:
SEQ ID NO: 1 or a functional variant therefore having at least 70%, 80%, 90%, or at least 95% overall nucleotide sequence identity with SEQ ID NO: 1;
SEQ ID NO: 2 or a functional variant therefore having at least 70%, 80%, 90%, or at least 95% overall nucleotide sequence identity with SEQ ID NO: 2;
SEQ ID NO: 3 or a functional variant therefore having at least 70%, 80%, 90%, or at least 95% overall nucleotide sequence identity with SEQ ID NO: 3;
SEQ ID NO: 4 or a functional variant therefore having at least 70%, 80%, 90%, or at least 95% overall nucleotide sequence identity with SEQ ID NO: 4;
SEQ ID NO: 5 or a functional variant therefore having at least 70%, 80%, 90%, or at least 95% overall nucleotide sequence identity with SEQ ID NO: 5;
SEQ ID NO: 6 or a functional variant therefore having at least 70%, 80%, 90%, or at least 95% overall nucleotide sequence identity with SEQ ID NO: 6;
SEQ ID NO: 7 or a functional variant therefore having at least 70%, 80%, 90%, or at least 95% overall nucleotide sequence identity with SEQ ID NO: 7;
SEQ ID NO: 8 or a functional variant therefore having at least 70%, 80%, 90%, or at least 95% overall nucleotide sequence identity with SEQ ID NO: 8;
SEQ ID NO: 9 or a functional variant therefore having at least 70%, 80%, 90%, or at least 95% overall nucleotide sequence identity with SEQ ID NO: 9; or
Any combination thereof.

In preferred embodiments, the micro-bites yeast cell may express one or more of the following recombinant enzymes:
PET-hydrolase, preferably the PET-hydrolase having the amino acid sequence with SEQ ID NO: 17 or a functional variant therefore having at least 70%, 80%, 90%, or at least 95% overall amino acid sequence identity with SEQ ID NO: 17 and more preferably, the PET-hydrolase being encoded by SEQ ID NO: 1 or by a functional variant thereof having at least 70%, 80%, 90%, or at least 95% overall nucleotide sequence identity with SEQ ID NO: 1;
L-lactate dehydrogenase A, preferably the L-LDH-A-dehydrogenase having the amino acid sequence with SEQ ID NO: 18 or a functional variant therefore having at least 70%, 80%, 90%, or at least 95% overall amino acid sequence identity with SEQ ID NO: 18, and more preferably the L-LDH-A dehydrogenase being encoded by a nucleotide sequence comprising SEQ ID NO: 2 or by a functional variant thereof having at least 70%, 80%, 90%, or at least 95% overall nucleotide sequence identity with SEQ ID NO: 2;
lactose permease, preferably the lactose permease having the amino acid sequence with SEQ ID NO: 19 or a functional variant thereof having at least 70%, 80%, 90%, or at least 95% overall amino acid sequence identity with SEQ ID NO: 19, and more preferably, the lactose permease being encoded by a nucleotide sequence comprising SEQ ID NO: 3 or by a functional variant thereof having at least 70%, 80%, 90%, or at least 95% overall nucleotide sequence identity with SEQ ID NO: 3;
beta glucosidase, preferably the beta glucosidase having the amino acid sequence with SEQ ID NO: 20 or a functional variant thereof having at least 70%, 80%, 90%, or at least 95% overall amino acid sequence identity with SEQ ID NO: 20, and more preferably, the beta glucosidase being encoded by a nucleotide sequence comprising SEQ ID NO: 4 or by a functional variant thereof having at least 70%, 80%, 90%, or at least 95% overall nucleotide sequence identity with SEQ ID NO: 4;
xylose reductase, preferably the xylose reductase having the amino acid sequence with SEQ ID NO: 21 or a functional variant thereof having at least 70%, 80%, 90%, or at least 95% overall amino acid sequence identity with SEQ ID NO: 21, and more preferably, the xylose reductase being encoded by a nucleotide sequence comprising SEQ ID NO: 5 or by a functional variant thereof having at least 70%, 80%, 90%, or at least 95% overall nucleotide sequence identity with SEQ ID NO: 5;
xylitol dehydrogenase, preferably the xylitol dehydrogenase having the amino acid sequence with SEQ ID NO: 22 or a functional variant thereof having at least 70%, 80%, 90%, or at least 95% overall amino acid sequence identity with SEQ ID NO: 22, and more preferably, the xylitol dehydrogenase being encoded by a nucleotide sequence comprising SEQ ID NO: 6 or by a functional variant thereof having at least 70%, 80%, 90%, or at least 95% overall nucleotide sequence identity with SEQ ID NO: 6;
xylulokinase, preferably the xylulokinase having the amino acid sequence with SEQ ID NO: 23 or a functional variant thereof having at least 70%, 80%, 90%, or at least 95% overall amino acid sequence identity with SEQ ID NO: 23, and more preferably, the xylulokinase being encoded by a nucleotide sequence comprising SEQ ID NO: 7 or by a functional variant thereof having at least 70%, 80%, 90%, or at least 95% overall nucleotide sequence identity with SEQ ID NO: 7;
the enzyme converting ethylene glycol into glycol aldehyde, preferably the enzyme having the amino acid sequence with SEQ ID NO: 24 or a functional variant thereof having at least 70%, 80%, 90%, or at least 95% overall amino acid sequence identity with SEQ ID NO: 24, and more preferably, the enzyme being encoded by a nucleotide sequence comprising SEQ ID NO: 8 or by a functional variant thereof having at least 70%, 80%, 90%, or at least 95% overall nucleotide sequence identity with SEQ ID NO: 8;
alcohol dehydrogenase, preferably the alcohol dehydrogenase having the amino acid sequence with SEQ ID NO: 25 or a functional variant thereof having at least 70%, 80%, 90%, or at least 95% overall amino acid sequence identity with SEQ ID NO: 25, and more preferably, the enzyme being encoded by a nucleotide sequence comprising SEQ ID NO: 9 or by a functional variant thereof having at least 70%, 80%, 90%, or at least 95% overall nucleotide sequence identity with SEQ ID NO: 9; or
any combination thereof.

In addition to these genetic modifications for consumption of the OHD feedstock, the micro-bites yeast cell according to this disclosure may comprise one or more additional mutations helping with increasing the total protein productions when the yeast cells are grown in a medium comprising the OHD feedstock.

In addition to converting the OHD feedstock into an unpurified food product feedstock comprising yeast protein, addition genetic modifications can be introduced such that the micro-bites yeast cell may be engineered in embodiments to produce intracellular (yeast protein, vitamins, flavors, aroma, and omega-3 and -6 fatty acids) and/or extracellular compounds (e.g., milk proteins and xylitol) from OHD processed materials (e.g., waste biomass or plastics). Oleaginous yeast strains were grown on OHD processed materials to obtain FDA-approved food components such as lipids and β-carotene.

### Methods for Producing Food Products

In yet another aspect, this disclosure relates to methods for producing food products using the system (10). The methods include those outlined in FIG. 13 and which may comprise producing the OHD output feedstock (41) in the OHD reactor (40), using a bioreactor (16) to produce unpurified food product feedstock and then purifying the food product feedstock and formulating a food product and cooking the food product. In some embodiments, the method may comprise:
i. grinding and/or extruding waste feedstock in the feedstock preparation component;
ii. mixing the waste feedstock with water;
iii. reacting the waste feedstock with oxygen in the presence of water at a temperature in the range 100° C. to about 374° C. under pressure in the range 1500 to 3500 psi and producing an OHD output feedstock comprising liquid organic compounds;
iv. supplying the OHD output feedstock obtained in step iii to a bioreactor and growing genetically modified yeast cells in the bioreactor with the OHD output feedstock used as a source of carbon and thereby producing unpurified food product feedstock;
v. subjecting the unpurified food product feedstock of step iv to one or more of sonication, centrifugation and/or filtration and obtaining purified food product feedstock separated from waste water and yeast cell debris;
vi. mixing a usable feedstock comprising the purified food product feedstock obtained in step v. and preferably also using a 3D food printer to shape the usable feedstock; and
vii. cooking or baking the usable feedstock in a cooking apparatus into an edible food product.

Preferably, the method further comprises using an analyzer, such as a Raman spectrometer to monitor for microbial contamination at each step of the process. In particular, a Raman spectrometer may be used to analyze compositions produced in steps iii. through vii.

Having described the present disclosure in detail, it will be apparent that all of the compositions and methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and methods and in the steps or in the sequence of steps of the methods described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims. Furthermore, it should be appreciated that all examples in the present disclosure are provided as non-limiting examples.

### EXAMPLES

The following non-limiting examples are provided to further illustrate the present invention. It should be appreciated by those of skill in the art that the techniques disclosed in the examples that follow represent approaches the inventors have found function well in the practice of the present disclosure, and this can be considered to constitute examples of modes for its practice. However, those of skill in the art should, in light of the present invention, appreciate that many changes can be made in the specific embodiments that are disclosed and still obtain a like or similar result without departing from the spirit and scope of the present invention.

### Example 1. Engineered Yeast can Utilize Oxidative Hydrothermal Dissolution (OHD) Substrates Derived from Biomass and Plastic

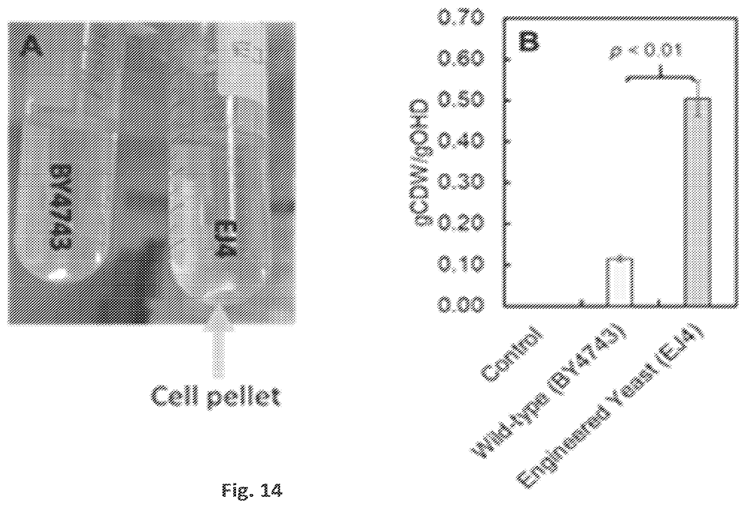

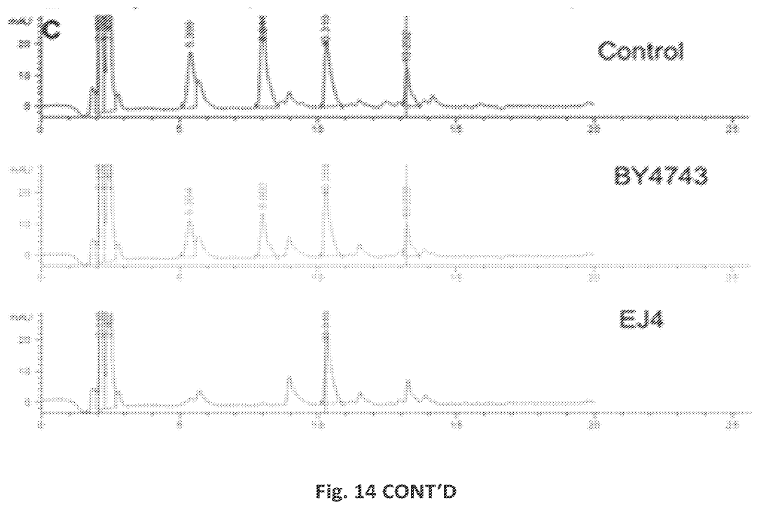

Engineered yeast S. cerevisiae is employed to bio-funnel the OHD-derived compounds. FIG. 14 shows the EJ4 (the engineered strain that can utilize cellobiose and xylose, E. J. Yun et al. Biology for Biofuels, 2018) can grow (FIG. 14A and FIG. 14B) and assimilate OHD-derived substrates (FIG. 14C) from Corn Stover (biomass) and polyethylene terephthalate (PET), the dry yeast cell yield was 0.50±0.02 from g of OHD total carbon. The data suggest the potential of using OHD substrate for yeast-based food production technology, and additional metabolic pathways to funnel remaining OHD-carbon to yeast and enable bio-funneling of 100% OHD carbon are being reviewed. Of note, bioreactor optimization can further improve yeast growth. The bio-funneling approach was used and optimized to utilize nearly 100% of OHD-corn stover+PET substrates via engineered yeast [S. cerevisiae heterologously overexpressing cdt-1, ghl-1, XYL1, XYL2, XYL3, and ldhA, and evolved in Green Tea+5% (w/w) PET].

### Example 2. Theoretical Protein Digestibility Comparison Study

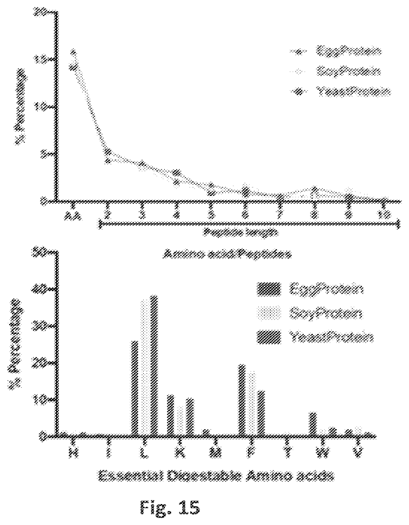

A comparison study between Yeast protein was performed with two major food proteins, egg (animal source) and soy (plant source), by in-silico gastrointestinal digestion. The results (FIG. 15) indicated that Yeast protein digestibility is very much comparable to egg and soy and essentially can produce a similar proportion of amino acids and small peptides. Furthermore, additional analysis on 9 essential amino acids: histidine (H), isoleucine (I), leucine (L), lysine (K), methionine (M), phenylalanine (F), threonine (T), tryptophan (W), and valine (V), it was revealed that the profile of 9 essential amino acids on the digested fractions for each protein sources was very much comparable except M, F, and W.

### Example 3. Yeast Extract Based Food

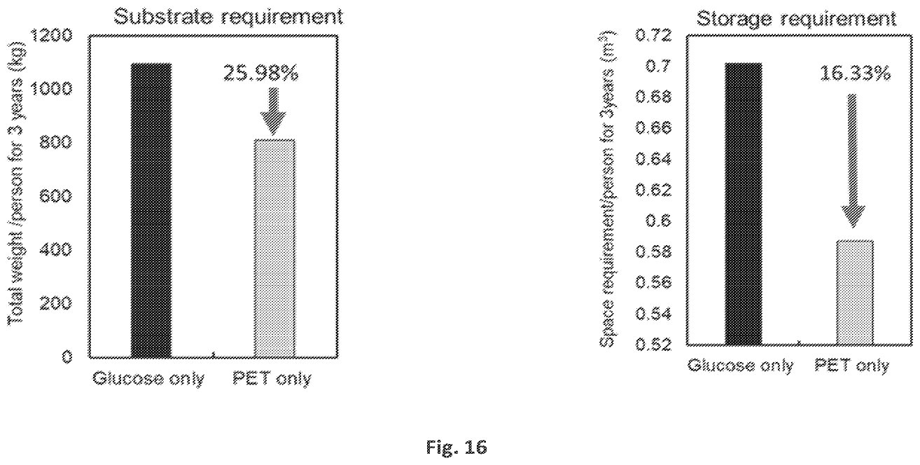

Recommended daily diet for 1 person/day is as follows. Protein: 0.8 grams per kilogram (g/kg) of body weight a day for adults, 70 kg human, 56 g/day. Fat: 40 g/day, Carbohydrate: 130 g/day. Composition of Yeast: Protein: 60%, Fat: 4%, Carbohydrate: 30%, and vitamins~40 mg. Based on the experimental data (FIG. 16), to meet one person's protein requirement per day via yeast, the calculated reactor volume is 2.77 L/d/person (OHD with 10% TOC). Hence, supplement daily protein for a three-year mission for four astronauts requires 13140 L of OHD. In addition to protein, 32% (42 g) of the carbohydrate requirement per day could be met and 14% (5.6 g) fat requirement with the current engineered strain EJ4 with OHD stream as substrate. Of note, oleaginous yeast will be used to obtain the required fat, including omega 3- and 6-fatty acids. The plastic requirement (e.g., PET) to make the protein for the entire mission was also calculated. The total required PET is 810.47 kg/person and less than 26% relevant to the glucose as substrate and requires less storage space (FIG. 16). Further net water usage for the production of 1 kg of protein is 1.857 L. The value is lower relative to major protein production systems. Collectively, the above example suggests the potential of using μBite systems for the sustainable production of food in a deep space mission.

### Example 4. Power Requirement

The food production system may be operated systematically to meet the power requirement, as shown in TABLE 1. The maximum power requirement will be 2475 W under the operation of OHD. The separation system with the units should operate all the time. The one food cycle requires 31.16 kWh to produce food for four astronauts.

TABLE 1
Power consumption of the μBites system.

| Component | Power requirement (W) | Operating time/d |
|---|---|---|
| Extrusion and grinder | 1000 | 1 |
| OHD system | 1200 | 12 |
| Bioreactor | 200 | 22 |
| CO₂ to formate reactor | 200 | 22 |
| Separation unit | 500 | 2 |
| Mixing Unit | 200 | 2 |
| Control Unit | 75 | 24 |
| micro-Raman | 100 | 24 |
| 3D printer | 324 | 0.5 |
| Microwave/oven | 1040 | 0.5 |

### Safety

A comprehensive safety plan model after Hazard Analysis and Critical Control Point (HACCP) for the μBites system (33 process steps) was developed to achieve a safe food production process as shown in FIG. 13. Safety protocol ensures the avoidance of physical, chemical, or biological hazards for the production and cleaning of the system. Since waste material in real mission scenarios (food and plastic) originated from manufacturer-verified food-grade materials, the waste does not contain any heavy metals or toxicants. The complete AI sensor system, including biosensor and micro-Raman are added to detect any food hazards. Notably, the OHD process can destroy any microbes in the feedstock. It was confirmed that the byproducts of the OHD process are free of microbes by aerobic plate test.

A comprehensive analysis was performed using Surface Enhanced Raman Spectroscopy/HPLC/GC-MS to find toxic chemicals and pathogens to ensure the OHD products are free of chemical toxicants (e.g., Pyrrolizidine alkaloid, Cyanogenic, glycosides, Furocoumarins, Solanines, Chaconine, Lectins, and Oxalic acid). Collectively, it was ensured that the OHD byproduct or output (a novel food production substrate) has the NASA-STD-3001 standard for raw materials for food production. Food-grade distilled water/soft water, O₂, and single-wrapped sterile food-grade cellulose sheet are used to meet the NASA-STD-300 standards. μBites carefully selects manufacture-certified food ingredients (e.g., oatmeal, cinnamon, ginger, xylitol . . . etc.) without containing any hazardous chemicals and microbes. μBites uses manufacture-certified and sterile food-grade single-used plastic consumables, including biobag, cartridge, nozzle, collection tubes, etc. for food production. μBites follows the standard aseptic food production (steam sterilization, UV light, and filters) techniques to avoid microbial contamination during the process and ensure food products are free of food pathogens (Total aerobic count<20,000 CFU/g, <100 CFU/g Enterobacteriaceae, 0 CFU/g Listeria monocytogenes, Salmonella 0 CFU/g, 0 CFU/g E. coli O157:H7).

Safety design is paramount for space travel as minute errors could lead to a compromised mission. As a result, various precautions and safety measures are considered at each step to eliminate malfunction and accidents, and injuries while running the μBites system. Each parameter, such as pressure, temperature, and water flow, will be monitored using various sensors. To provide greater safety and eliminate human error, the complete system is preferably automated. In case of a system malfunction, safety concern, or maintenance/repair, the automated system will shut down operation and automatically isolating each component using flow control valves. A combination of hardware (sensors, values, images, and gauges) and software (AI technology) is used to identify unsafe operations and safety risks. The control panel will warn the user about the potential risk and errors and step-by-step instructions to solve the problem. Safety precautions will evolve while designing the μBites system to deliver excellent safety. In the case of automation system failure, the system will be capable of manual operation by the crew.

### Example 5. Development of an Ethylene Glycol Utilizing Micro-Bites Yeast Strain

Ethylene glycol (EG) is a versatile two-carbon organic chemical primarily used to manufacture polyethylene terephthalate (PET). OHD products of PET contain the EG and enable the utilization of EG, which is essential in the μBites system. The yeast Yarrowia lipolytica enables the assimilation of EG, but no S. cerevisiae. Researchers use genetically engineered bacteria such as P. putida to convert EG into glycolic acid, glyoxylic acid, and polyhydroxyalketone. Franden, M. A.; Jayakody, L. N.; Li, W.-J.; Wagner, N. J.; Cleveland, N. S.; Michener, W. E.; Hauer, B.; Blank, L. M.; Wierckx, N.; Klebensberger, J., Engineering Pseudomonas putida KT2440 for efficient ethylene glycol utilization. Metabolic engineering 2018, 48, 197-207. Those molecules could be applied in various applications.³ In the present study, we developed the Saccharomyces cerevisiae BY4743 strain, capable of utilizing ethylene glycol as a sole carbon source and producing glycolic acid (FIGS. 18, 19, and 20). We can further engineer the strain to manufacture vital food ingredients using PET-derived EG.

### Materials and Methods

First, we constructed two different plasmids that carry the genes for converting ethylene glycol into glycolic acid via glycoladehyde. We developed two plasmids for overexpression of ethylene glycol metabolizing genes in S. cerevisiae BY4743. To overexpress the YLLO56C gene which is responsible for converting ethylene glycol into glycol aldehyde, we constructed pYD1-YLLO56C plasmid using pYD1 as the plasmid backbone. To overexpress ALD5 gene for conversion of glycolaldehyde into glycolic acid we constructed pVT100-ALD5 plasmid using pVT100-mito-GFP as the plasmid back bone. We amplified the gene insert YLLO56C and ALD5 insert from genomic DNA of S. cerevisiae BY4743 using specific primers. The YLLO56C was amplified using oLJLJ501 gatgacgataaggtaccagatgaaagtatttataactggtgcttctggc (SEQ ID NO: 11) forward primer and oLJLJ502 gtgctggatatctgcagtcagtttaagctatagttcgcacggatatctt (SEQ ID NO: 12) reverse primers. The plasmid backbone pYD1 also was linearized using primers oLJLJ499 gcagatatccagcacaatactactcagtaataacctatttcttagc (SEQ ID NO: 13) and oLJLJ500 taccttatcgtcatctacagctgctagtagtccga (SEQ ID NO: 14). To get the ALD5 gene, the genomic DNA was amplified with oLJLJ503 cggatccccgggtacatgctttctcgcacaagagct (SEQ ID NO: 15) and 504 gatcctctagacgagcttcaacgaattggcttgtcaatggc (SEQ ID NO: 16). To prepare the pVT100-mito-GFP plasmid for the experiment we digested it overnight at 37° C. with restriction enzymes Kpnl and Sac1.

The PCR products of the gene inserts and the plasmids were separated on a 1% agarose gel stained with SYBR Safe DNA gel stain (Invitrogen, Waltham, MA, USA) through electrophoresis. The gel was visualized using a SMARTDOC blue light illuminator (ACCURIS INSTRUMENTS, Edison, NJ, USA). DNA bands of the correct size were identified against a 1 kb DNA ladder, excised, and extracted using the GeneJET Gel Extraction kit (Thermo Fisher Scientific, Waltham, MA, USA). DNA concentration was measured using the TECAN iControl Infinite Plate Reader (TECAN trading, Mannedorf, Switzerland). The vectors and genes were assembled using the NEBuilder® HiFi DNA Assembly Master Mix (New England Biolabs, Ipswich, MA, USA) according to the manufacturer's instructions. The constructed plasmid was then transformed into NEB 5-alpha F′Iq E. coli competent cells following the manufacturer's instructions. Transformants were selected using LB agar plates containing 50 g/mL ampicillin as the antibiotic marker and were incubated at 37° C. overnight. After incubation, colonies carrying the correct plasmid construct were confirmed by colony PCR using the relevant primers oLJLJ015 (forward) and oLJLJ016 (reverse) and MyTaq Red master mix (Meridian Bioscience Inc., Newton, OH, USA). To confirm the sequence of the constructed plasmid, plasmids were extracted from the colonies confirmed by colony PCR using the GeneJET Plasmid Miniprep kit (Thermo Fisher Scientific, Waltham, MA, USA). Then the plasmids with the correct gene inserts were sequenced by Sanger sequencing by sending the samples to MACLAB (320 Harbor Way, South San Francisco, CA, USA). Glycerol stocks were prepared from the strains with the correct constructs and stored at −80° C. for future use.

Then the constructed, sequence verified plasmids were transformed into competent S. cerevisiae BY4743 competent cells. Yeast competent cells were prepared using the LiAc/SS carrier DNA/PEG method described by Gietz & Schiestl (2007).⁴ According to the method, we transformed the yeast with the respective plasmids. The correct transformants were selected in selective SC media. For the transformants S. cerevisiae BY4743-pVT100-ALD5 were selected on SC minimal agar plates without uracil while S. cerevisiae BY4743-pYD1-YLLO56C was selected on SC minimal agar plates without tryptophan.

After obtaining the correct transformants, we prepared the glycerol stocks and stored in −80° C. for future use. Furthermore, we decided to integrate ALD5 gene into S. cerevisiae BY4743 genome in order to enhance its efficiency. For this, we used EasyClone-MarkerFree vector toolkit for CRISPR-Cas9 and respective EasyClone-MarkerFree guiding RNA vector to direct Cas9 to cut at site X-2.⁵ To prepare rDNA we amplified our previously constructed pVT 100-ALD5 plasmid with primers to amplify the gene of interest with promoter and terminator and 50 bp homologues region. The primers for rDNA were oLJLJ567 cataccatattaagtaaattgcctccatttctttttcctcgggcagagaacgacctcgacgcatgca (SEQ ID NO: 26) and oLJLJ568 ttcagcatagatgggtaacgggatccctctgtgagggccgattatgcaggatgccggtagaggtgtgg (SEQ ID NO: 27). We utilized the Cas9 expression vector [pCfB2312 (TEF1p-Cas9-CYC1t_kanMX)] from the kit and transformed it into competent S. cerevisiae BY4743. The correct transformants were selected on yeast extract peptone dextrose agar plates with KanMX selection. After obtaining the correct transformant we made competent cells with the transformant and rDNA as well as the gRNA [pCfB3020 (gRNA X-2)] were transformed into the competent cells using the same LiAc/SS carrier DNA/PEG method. Transformants were selected on KanMX and NatMX containing YPD agar plates. Then the genome integrated strains were cured by transferring them to YPD agar without selection by confirming the correct genome integration by colony PCR using chromosome X-2 loci specific primers. After obtaining this genome integrated strain, we transformed our previously constructed pYD1-YLLO56C plasmid into the ALD5 genome integrated strain using the same method. After this transformation, we obtained S. cerevisiae BY4743::ALD5-pYD1-YLLO56C strain that assumed to have the ability to convert EG into glycolic acid.

Then we conducted a shake flask experiment to confirm the phenotype of the strain. For this, we inoculated our final constructed yeast strain, S. cerevisiae BY4743::ALD5-pYD1-YLLO56C, S. cerevisiae BY4743 wild type, S. cerevisiae BY4743-pYD1-YLLO56C, S. cerevisiae BY4743-pYD1-YLLO56C, S. cerevisiae BY4743-pVTI00-ALD5, S. cerevisiae BY4743-pVT100-mito-GFP, and S. cerevisiae BY4743-pYD1 in 250 mL baffled flasks containing Synthetic Complete (SC) minimal medium with 25 mM ethylene glycol as a sole source of carbon and 25 mM ethylene glycol supplemented with glucose 20 g/L as the carbon sources and 2 g/L of galactose (induce to YLL056C). Yeast cells were inoculated with initial OD₆₀₀ of 0.1 and allowed the flasks to grow at 30° C. In 24-hour, time intervals we withdrew samples from each flask for HPLC analysis and OD₆₀₀ was recorded.

HPLC analyses were conducted for the samples collected to determine the ethylene glycol consumption and glycolic acid accumulation using the organic acid column. The mobile phase was 0.005 N sulfuric acid in a flow rate of 0.5 mL/min. After analyzing the samples, we used ethylene glycol as well as glycolic acid standards curves to determine the amount of ethylene glycol consumption and accumulation of glycolic acid by each strain. The results were plotted to observe the trends.

### Results

We successfully developed the S. cerevisiae BY4743 yeast strain (BY4743::ALD5-pYD1-YLLO56C) to overexpress the pathways relevant to EG utilization by integrating an extra copy of native ALD5 under ADH1 constitutive promotor to the genome. We overexpressed the YLLO56C under an inducible GAL1 promotor using a plasmid containing auxotroph marker (TRP1). The strain enables the growth of ethylene glycol and the production of glycolic acid (FIG. 18). Further engineering is vital to enhanced EG utilization by integrating YLLO56C into the genome and overexpressing the downstream pathway genes. The strain can be used to obtain the yeast protein and flavor molecules for the μBites, and we are further engineering the strain to enable the production of other food additives such as caseins (i.e., Cow-less milk).⁶

### REFERENCES

1. Kosiorowska, K. E.; Moreno, A. D.; Iglesias, R.; Leluk, K.; Mirończuk, A. M., Production of PETase by engineered Yarrowia lipolytica for efficient poly (ethylene terephthalate) biodegradation. Science of the Total Environment 2022, 846, 157358.
2. Franden, M. A.; Jayakody, L. N.; Li, W.-J.; Wagner, N. J.; Cleveland, N. S.; Michener, W. E.; Hauer, B.; Blank, L. M.; Wierckx, N.; Klebensberger, J., Engineering Pseudomonasputida KT2440 for efficient ethylene glycol utilization. Metabolic engineering 2018, 48, 197-207.
3. Dissanayake, L.; Jayakody, L. N., Engineering microbes to bio-upcycle Polyethylene Terephthalate. Frontiers in bioengineering and biotechnology 2021, 9.
4. Gietz, R. D.; Schiestl, R. H., High-efficiency yeast transformation using the LiAc/SS carrier DNA/PEG method. Nature protocols 2007, 2 (1), 31-34.
5. Jessop-Fabre, M. M.; Jakočiūnas, T.; Stovicek, V.; Dai, Z.; Jensen, M. K.; Keasling, J. D.; Borodina, I., EasyClone-MarkerFree: Avector toolkit for marker-less integration of genes into Saccharomyces cerevisiae via CRISPR-Cas9. Biotechnology journal 2016, 11 (8), 1110-1117.
6. Tome, D., Yeast extracts: Nutritional and flavoring food ingredients. ACS Food Science & Technology 2021, 1 (4), 487-494.

### Example 6. Sensory Studies of a Micro-Bites Cookie

Studies were conducted with consented participants to evaluate micro-bites cookies produced with the system (10), examples of which are shown in FIG. 9.

Demographic information of sensory study participants is summarized in TABLE 2 below.

TABLE 2

| | Count (n = 30) | Percentage |
|---|---|---|
| Age | | |
| 18-25 | 6 | 20 |
| 26-35 | 11 | 36.7 |
| 36-45 | 6 | 20 |
| 46-55 | 2 | 6.7 |
| 56-65 | 2 | 6.7 |
| 66-75 | 3 | 10 |
| 76 or older | 0 | 0 |
| Prefer not to answer | 0 | 0 |
| Gender | | |
| Male | 9 | 30 |
| Female | 21 | 70 |
| Intersex | 0 | 0 |
| Prefer not to answer | 0 | 0 |
| Ethnicity | | |
| Hispanic or Latino or Spanish Origin | 1 | 3.3 |
| Not Hispanic or Latino or Spanish Origin | 27 | 90 |
| Prefer not to answer | 2 | 6.7 |
| Race | | |
| American Indian or Alaska Native | 0 | 0 |
| Asian | 5 | 16.7 |
| Black or African American | 0 | 0 |
| Native Hawaiian or Other Pacific Islander | 0 | 0 |
| White | 23 | 76.7 |
| Two or more races | 2 | 6.7 |
| Prefer not to answer | 0 | 0 |

The studies included the following assessment of micro-bites cookies acceptability as shown in TABLE 3 below.

TABLE 3
Average, standard deviation and variance
of product acceptability scores

| | Average score on 9-pt | Standard | |
|---|---|---|---|
| Attribute | hedonic scale | Deviation | Variance |
| Overall Liking | 6.50 | 1.45 | 2.12 |
| Liking of the shape | 5.47 | 1.84 | 3.38 |
| Liking of the color | 5.20 | 1.74 | 3.03 |
| Liking of the | 5.37 | 1.80 | 3.23 |
| visual texture | | | |
| Liking of the aroma | 7.33 | 1.85 | 3.42 |

Overall results of the studies are reported in FIG. 17, showing that 80% of study participants would definitely or likely consider consuming the micro-bites cookies under the limited food or natural disaster conditions.

### SEQUENCE LISTING

ORGANISM: artificial sequence

We claim:

1. A system for sustainable food production from waste feedstock, the system comprising:
a) a feedstock preparation component comprising a grinding and/or an extrusion apparatus;
b) an oxidative hydrothermal dissolution (OHD) apparatus configured for decomposing plastic materials and/or biomass into an output OHD feedstock;
c) a bioreactor configured for growing a microorganism, including bacterial and/or yeast cells;
d) one or more of bacterial and/or yeast cells encoding enzymes for utilizing the OHD output feedstock as a carbon source while growing and producing yeast protein and/or food additives;
e) a separation component configured for harvesting the yeast protein and/or the food additives and separating the yeast protein and/or food additives from fermented broth and yeast cell debris;
f) a formulation component for formulating and preparing a food product comprising the yeast protein and/or the food additives;
g) an analytical sensor component configured for analyzing chemical compositions and for detecting bacterial contamination; and
h) a control interface component for operating component a) through g).

2. The system of claim 1, wherein the system is further characterized by one or more of the following features:
the feedstock preparation component is connectable to the oxidative hydrothermal dissolution apparatus;
the bioreactor is a plastic bag and/or comprises one or more inlets for and one or more outlets;
the separation component comprises one or more of the following: a centrifuge, a sonicator and/or filtration membrane;
the formulation component comprises a mixing apparatus; and/or
the system further comprises one or more of the following: a 3D food printer, cooking oven or a microwave.

3. The system of claim 1, wherein the waste feedstock comprises waste plastic and/or biomass such as apple, green tea, coffee, corn stover.

4. The system of claim 1, wherein the OHD apparatus comprises one or more of the following: a reactor for reacting waste feedstock with oxygen in the presence of water, an oxygen pump, a chiller, water reclamation unit, reverse osmosis unit and/or an OHD substrate storage tank.

5. The system of claim 1, wherein in the bacterial and/or yeast cell is supplied as a dry material in a capsule.

6. The system of claim 1, wherein the yeast cell is Saccharomyces cerevisiae, Saccharomyces boulardii, Rhodosporidium toruloides, Rhodotorula toruloides or Yarrowia lipolytica genetically modified to grow on the OHD output feedstock as a carbon source and expressing one or more of following recombinant enzymes:
YLLO56C enzyme converting ethylene glycol into glycolaldehyde and having the amino acid sequence with SEQ ID NO: 24 or a functional variant thereof;
aldehyde dehydrogenase having the amino acid sequence with SEQ ID NO: 25 or a functional variant thereof; and/or PET-hydrolase having the amino acid sequence with SEQ ID NO: 17 or a functional variant thereof.

7. The system of claim 1, wherein the yeast cell produces at least yeast protein as an unpurified food product feedstock.

8. The system of claim 1, wherein the system further comprises one or more of the following: a 3D food printing apparatus and/or a microwave oven.

9. A sustainable food product produced by using the system of claim 1.

10. A method for sustainable food production, using the system of claim 1, the method comprising:
i. grinding and/or extruding waste feedstock in the feedstock preparation component;
ii. mixing with water the waste feedstock, wherein the waste feedstock comprises plastic and biomass;
iii. reacting the waste feedstock with oxygen in the presence of water at a temperature in the range 100° C. to about 374° C. under pressure in the range 1500 to 3500 psi and producing an OHD output feedstock comprising liquid organic compounds;
iv. supplying the OHD output feedstock obtained in step iii to a bioreactor and growing microbial cells in the bioreactor with the OHD output feedstock used as a source of carbon and thereby producing unpurified food product feedstock;
v. subjecting the unpurified food product feedstock of step iv to one or more of sonication, centrifugation and/or filtration and obtaining purified food product feedstock separated from waste water and yeast cell debris;
vi. mixing and/or 3D-printing a usable feedstock product comprising the purified food product feedstock obtained in step v. and other food additives; and
vii. cooking or baking the usable feedstock product from step vi. into an edible food product.

11. The method of claim 10, wherein step ii is performed simultaneously with step i.

12. The method of claim 10, wherein the OHD output feedstock comprises ethylene glycol.

13. The method of claim 10, wherein the yeast cell is Saccharomyces cerevisiae, Saccharomyces boulardii, Rhodosporidium toruloides, Rhodotorula toruloides or Yarrowia lipolytica genetically modified to grow on the OHD output feedstock as a carbon source.

14. The method of claim 10, wherein the yeast cells are genetically modified to utilize ethylene glycol as a carbon source and the yeast cells express one or more of following recombinant enzymes: YLLO56C enzyme converting ethylene glycol into glycolaldehyde and having the amino acid sequence with SEQ ID NO: 24 or a functional variant thereof; aldehyde dehydrogenase having the amino acid sequence with SEQ ID NO: 25 or a functional variant thereof; and/or PET-hydrolase having the amino acid sequence with SEQ ID NO: 17 or a functional variant thereof.

15. The method of claim 10, wherein the unpurified food product feedstock produced in step iv comprises one or more of the following: yeast protein, xylitol, milk protein, amino acids, a vitamin, lactic acid, flavor, aroma, lipid, β-carotene, omega-3 and/or -6 fatty acids.

16. The method of claim 10, wherein the purified food product feedstock comprises one or more of the following: yeast protein, xylitol, milk protein, amino acids, a vitamin, lactic acid, flavor, aroma, lipid, β-carotene, omega-3 and/or -6 fatty acids.

17. The method of claim 10, wherein the method further includes using a 3D food printing apparatus to form the usable feedstock into a printed food product before the step of cooking or baking.

18. The method of claim 10, wherein the method includes using a Raman spectrometer to analyze for microbial contamination any of the following: the OHD output feedstock comprising liquid organic compounds; the unpurified food product feedstock; the purified food product feedstock separated from waste water and yeast cell debris, the usable feedstock product comprising the purified food product feedstock obtained in step v. and/or the edible food product.

19. A genetically modified yeast cell expressing one or more of enzymes utilizing an OHD output feedstock as a carbon source for growth.

20. The genetically modified yeast cell of claim 19, wherein the yeast cell is genetically modified to express one or more of enzymes for hydrolyzing poly(ethylene terephthalate) (PET) and/or ethylene glycol.

21. The genetically modified yeast cell of claim 19, expressing one or more of the following recombinant enzymes: YLLO56C enzyme converting ethylene glycol into glycolaldehyde and having the amino acid sequence with SEQ ID NO: 24 or a functional variant thereof; aldehyde dehydrogenase having the amino acid sequence with SEQ ID NO: 25 or a functional variant thereof; and/or PET-hydrolase having the amino acid sequence with SEQ ID NO: 17 or a functional variant thereof.


SEQUENCE LISTING (27 sequences)

SEQ ID NO: 1 - DNA, 2068 bp, synthetic construct
  misc_feature 1..2068: note = Synthetic: LCC; contains ORF of LCC degradation enzyme which is codon-optimized to S. cerevisiae, and S. cerevisiae GAL1-GAL10 promotor, CYC1 terminator, and secretion signal
  source 1..2068: mol_type = other DNA
tttcaaaaattcttactttttttttggatggacgcaaagaagtttaataatcatattacatggcattaccaccatatacatatccatatacatatccatatctaatcttacttatatgttgtggaaatgtaaagagccccattatcttagcctaaaaaaaccttctctttggaactttcagtaatacgcttaactgctcattgctatattgaagtacggattagaagccgccgagcgggtgacagccctccgaaggaagactctcctccgtgcgtcctcgtcttcaccggtcgcgttcctgaaacgcagatgtgcctcgcgccgcactgctccgaacaataaagattctacaatactagcttttatggttatgaagaggaaaaattggcagtaacctggccccacaaaccttcaaatgaacgaatcaaattaacaaccataggatgataatgcgattagttttttagccttatttctggggtaattaatcagcgaagcgatgatttttgatctattaacagatatataaatgcaaaaactgcataaccactttaactaatactttcaacattttcggtttgtattacttcttattcaaatgtaataaaagtatcaacaaaaaattgttaatatacctctatactttaacgtcaaggagaaaaaaccccggatccgtaatacgactcactatagggcccgggatgaggcaggtttggttctcttggattgtgggattgttcctatgttttttcaacgtgtcttctgctgctccagtcaacactacaacagaagatgaaacggcacaaattccggctgaagctgtcatcggttacttagatttagaaggggatttcgatgttgctgttttgccattttccaacagcacaaataacgggttattgtttataaatactactattgccagcattgctgctaaagaagaaggggtatctttggataaaagagaggctgaagctatggatggtgttttgtggagagtcaggacagccgccttgatggctgctttactggcccttgctgcctgggcgcttgtatgggcctcacccagcgtagaggcgcaatctaacccctaccaacgtggacccaaccccacgagatccgcacttaccgcggatggacccttctctgtcgcaacatacaccgttagcaggctgagtgtctccgggtttggcggaggagtaatctactatccaacgggcacgtctctaacttttggcggcattgcaatgtcacctggttacacagcagacgctagttcacttgcgtggctagggaggcgtcttgcgagccacggtttcgtagtgctagtcatcaatactaattcaagattcgacggtcctgactcaagggcttctcagctatctgcggccttgaattacctgcgtacttcctcaccaagcgcagtacgtgcgcgtcttgatgcaaatcgtcttgcagtagctggtcattccatgggcggcgggggcacgctgaggatcgcggaacaaaatcccagtcttaaagcggctgtccccttaacaccatggcacactgacaagacatttaacaccagtgtgcccgtactgatcgtaggtgcagaagcggatactgtcgctccggtgtcacaacacgcgatccccttttatcagaacctgccgagcacaacacccaaagtctacgttgaactatgtaatgcatcacatatagcgccaaatagcaataacgctgcgatcagtgtatatacaatttcttggatgaaactatgggtcgacaacgacacacgttaccgtcaattcctttgcaatgtgaacgaccccgctctgtgtgatttcaggaccaacaaccgtcactgtcaatgaggtaccgcggctagctaagatccgctctaaccgaaaaggaaggagttagacaacctgaagtctaggtccctatttatttttttatagttatgttagtattaagaacgttatttatatttcaaatttttcttttttttctgtacagacgcgtgtacgcatgtaacattatactgaaaaccttgcttgagaaggttttgggacgctcgaag

SEQ ID NO: 2 - DNA, 1864 bp, synthetic construct
  misc_feature 1..1864: note = Synthetic: ldhA; Contain S. cerevisiae PGK promotor and CYC1 terminator, and ORF of ldhA from Rhizopus oryzae
  source 1..1864: mol_type = other DNA
gggtaggggaggcgcttttcccaaggcagtctggagcatgcgctttagcagccccgctgggcacttggcgctacacaagtggcctctggcctcgcacacattccacatccaccggtaggcgccaaccggctccgttctttggtggccccttcgcgccaccttctactcctcccctagtcaggaagttcccccccgccccgcagctcgcgtcgtgcaggacgtgacaaatggaagtagcacgtctcactagtctcgtgcagatggacagcaccgctgagcaatggaagcgggtaggcctttggggcagcggccaatagcagctttgctccttcgctttctgggctcagaggctgggaaggggtgggtccgggggcgggctcaggggcgggctcaggggcggggcgggcgcccgaaggtcctccggaggcccggcattctgcacgcttcaaaagcgcacgtctgccgcgctgttctcctcttcctcatctccgggcctttcgttactttatttttctttacaatataattctcatggtattacactcaaaggtcgccatcgttggagctggtgcagtaggagcctccactgcttatgcacttatgtttaaaaacatttgtacagaaatcattattgttgatgttaatcctgacatcgttcaagctcaagtccttgaccttgcagatgctgccagtataagtcacacgcccatccgagcaggtagcgcagaggaggcagggcaggcagatattgttgtcatcacggccggtgcgaaacaaagggaaggtgagcctcggacaaagctcattgaacgaaacttcagagtgttgcaaagtatcattggtggcatgcaacccattcgaccagacgcagtcatcttggtggtagcaaatccagtcgatatcttgacacacattgcaaagaccctctctggactgcctccaaaccaggtcattggctccggtacctaccttgacacgacccgtcttcgcgtccatcttggcgatgtctttgatgtcaatcctcaatcggtccatgcttttgtcttgggtgaacatggggattcccagatgatcgcttgggaggctgcttcgattggtggccagccgttgacaagtttcccggaattcgcaaagctggataaaacagcaatttcaaaagcgatatcaggtaaagcgatggagatcattcgtttgaaaggagccacgttttatggaattggtgcctgtgcagcggatttagtgcacactatcatgttgaataggaaatcagtacatccagtttctgtttatgttgaaaagtatggagccactttttctatgcctgctaaacttggatggagaggtgttgaacagatctatgaagtaccactgacggaagaagaagaagcgttgcttgtaaaatctgtagaggcattgaaatcagttgaatattcatctacaaaagttccagaaaaaaaggttcatgctacttccttttctaaaagtagctgttgataatttacaaataataaatcatgttttgcactgctagtgtatacataaagaaaaagttaatagtcagttgttatactcggtgtagctaattttttgaatgatacttttaattacaatattattcatgtaattagttatgtcacgcttacattcacgccctccccccacatccgctctaaccgaaaaggaaggagttagacaacctgaagtctaggtccctatttatttttttatagttatgttagtattaagaacgttatttatatttcaaatttttcttttttttctgtacagacgcgtgtacgcatgtaacattatactgaaaaccttgcttgagaaggttttgggacgctcgaaggctttaatttgc

SEQ ID NO: 3 - DNA, 3941 bp, synthetic construct
  misc_feature 1..3941: note = Synthetic: CDT-1; Contain S. cerevisiae PGK promotor and CYC1 terminator, ORF of cdt-1 from Neurospora crassa
  source 1..3941: mol_type = other DNA
gggtaggggaggcgcttttcccaaggcagtctggagcatgcgctttagcagccccgctgggcacttggcgctacacaagtggcctctggcctcgcacacattccacatccaccggtaggcgccaaccggctccgttctttggtggccccttcgcgccaccttctactcctcccctagtcaggaagttcccccccgccccgcagctcgcgtcgtgcaggacgtgacaaatggaagtagcacgtctcactagtctcgtgcagatggacagcaccgctgagcaatggaagcgggtaggcctttggggcagcggccaatagcagctttgctccttcgctttctgggctcagaggctgggaaggggtgggtccgggggcgggctcaggggcgggctcaggggcggggcgggcgcccgaaggtcctccggaggcccggcattctgcacgcttcaaaagcgcacgtctgccgcgctgttctcctcttcctcatctccgggcctttcgggacaactcgacgcgacacggcaacacacgagcaacgaactcggaaagtctcccatgaacgaactcctttcaccgtcgttcctcggtagaacagactgcccatcgtcccgccatcccggccaacaagtccattcgagcatggggtccgaatccactctatcgaaccttctacgccgacggatcatgcgcatttcccaccgccgacgttgatcttccatccaaccttgggaaggcagatgggatgggcaagatgtatacttaccttacctccgcagtgacgatctgtcgaaaccatctccgtgaaataacatccaaattaaggaacattcggaggatttctgatctatagaggtagcaatgctcaatggcgcgccttgctcctcgcatccgctgtggagacctcggagggaacgagtccgacccaggacggggacagctccaacggccgccaacggggccaagcatcagctacacagtgaaaaaaggggccagctacacacaacccaagtcttggccatacctcctcgagaggcatctcgttgccgcttgttgctgaccgcaacggtgcatggtcgtactgtgcaaggagcatggccatctcgtcaagtctggtgttctcgcgggacacctgagtgctaacttcagcgaggtagtatcatagagacaggaacgggttctagatttcggatccctccacaatcttatgtgctgtcatggtcttaccatggctccatggctcacgtggcagcgaggcgcgcttccgtacccagccgtctgggggtgacccggggtgatctggggtgaccttctggggaacctggagatgagggggcaaccttcgcgccaacccgagtccgaccatctcactccatcctcaaaaacatgataaaggatgataccgccgccgtggcaacacccttcccctcttgctcctcagccagtcccgtcttctctccatcgtgccgagtaagaattgccatggtcgtccactgttgacctgtcctcaactccctcatcgactgccagacgacacaggaagagggcctagcacgtccagatcaacacccataccatcaccgacatcctcaaagacatccaacatgtcgtctcacggctcccatgacggggccagcaccgagaagcatcttgctactcatgacattgcgcccacccacgacgccatcaagatagtgcccaagggccatggccagacagccacaaagcccggtgcccaagagaaggaggtccgcaacgccgccctatttgcggccatcaaggagtccaatatcaagccctggagcaaggagtccatccacctctatttcgccatcttcgtcgccttttgttgtgcatgcgccaacggttacgatggttcactcatgaccggaatcatcgctatggacaagttccagaaccaattccacactggtgacactggtcctaaagtctctgtcatcttttctctctataccgtgtaagtgattagggatttagcaaatcactcctttttggtttggggcttttctaacacctcgagtcttccagtggtgccatggttggagctcccttcgctgctatcctctctgatcgttttggccgtaagaagggcatgttcatcggtggtatctttatcattgtcggctccattattgttgctagctcctccaagctcgctcagtttgtcgttggccgcttcgttcttggcctcggtatcgccatcatgaccgttgctgccccggcctactccatcgaaatcgcccctcctcactggcgcggccgctgcactggcttctacaactgcggttggttcggaggttcgattcctgccgcctgcatcacctatggctgctacttcattaagagcaactggtcatggcgtatccccttgatccttcaggctttcacgtgccttatcgtcatgtcctccgtcttcttcctcccagaatcccctcgcttcctatttgccaacggccgcgacgctgaggctgttgcctttcttgtcaagtatcacggcaacggcgatcccaattccaagctggtgttgctcgagactgaggagatgagggacggtatcaggaccgacggtgtcgacaaggtctggtgggattaccgcccgctcttcatgacccacagcggccgctggcgcatggcccaggtgctcatgatctccatctttggccagttctccggcaacggtctcggttacttcaataccgtcatcttcaagaacattggtgtcaccagcacctcccaacagctcgcctacaacatcctcaactccgtcatctccgctatcggtgccttgaccgccgtctccatgactgatcgtatgccccgccgcgcggtgctcattatcggtaccttcatgtgcgccgctgctcttgccaccaactcgggtctttcggctactctcgacaagcagactcaaagaggcacgcaaatcaacctgaaccagggtatgaacgagcaggatgccaaggacaacgcctacctccacgtcgacagcaactacgccaagggtgccctggccgcttacttcctcttcaacgtcatcttctccttcacctacactcccctccagggtgttattcccaccgaggctctcgagaccaccatccgtggcaagggtcttgccctttccggcttcattgtcaacgccatgggcttcatcaaccagttcgctggccccatcgctctccacaacattggctacaagtacatctttgtctttgtcggctgggatcttatcgagaccgtcgcttggtacttctttgggtatgttttgggtcttcttctctgtcgacatcgcgtaaacagcacacagatcgctaactcgttccactacagtgtcgaatcccaaggccgtaccctcgagcagctcgaatgggtctacgaccagcccaaccccgtcaaggcctccctaaaagtcgaaaaggtcgtcgtccaggccgacggccatgtgtccgaagctatcgttgcttagacaggcgacaaggaagcgtccgaccaccacagcgagtttccttgcaggtctttcaaaaagcctcaagtgcgcccgtccctatatgatataggaggacggtgaggcatgtacaatatattataatgagcgtcatgttgtgatggctgcgggtggatttagcaagcaagcaagcataatgtattaatgaaatgtaatgtctttattatattttcatgtaattagttatgtcacgcttacattcacgccctccccccacatccgctctaaccgaaaaggaaggagttagacaacctgaagtctaggtccctatttatttttttatagttatgttagtattaagaacgttatttatatttcaaatttttcttttttttctgtacagacgcgtgtacgcatgtaacattatactgaaaaccttgcttgagaaggttttgggacgctcgaaggctttaatttgc

SEQ ID NO: 4 - DNA, 3099 bp, synthetic construct
  misc_feature 1..3099: note = Synthetic: gh-1-1; Contain S. cerevisiae PGK promotor and CYC1, and ORF of gh1-1 from N. crassa
  source 1..3099: mol_type = other DNA
gggtaggggaggcgcttttcccaaggcagtctggagcatgcgctttagcagccccgctgggcacttggcgctacacaagtggcctctggcctcgcacacattccacatccaccggtaggcgccaaccggctccgttctttggtggccccttcgcgccaccttctactcctcccctagtcaggaagttcccccccgccccgcagctcgcgtcgtgcaggacgtgacaaatggaagtagcacgtctcactagtctcgtgcagatggacagcaccgctgagcaatggaagcgggtaggcctttggggcagcggccaatagcagctttgctccttcgctttctgggctcagaggctgggaaggggtgggtccgggggcgggctcaggggcgggctcaggggcggggcgggcgcccgaaggtcctccggaggcccggcattctgcacgcttcaaaagcgcacgtctgccgcgctgttctcctcttcctcatctccgggcctttcgcccaagacaagcttcgggtttggttctctgctgattaccatgacatgggctgctgtgtgctgtgttcctatgtgtgcgggcaagattcgaaaagcgtggggatggaagcacacaaagaagcgttgggaaccacacacacacccaagcacaaacgaacaggtagaactacatactgtatggatcatggtgtaggtacaaattacacttactaacgatgttgtactgaccttgcctgatctcttctgggtaccattgatctcctctcaggctatgcctagcttttctctcggtgtcgacggtccgaaacacgggagaaatggggggcatcaagtatcccctttgggaggtcgttttcatgggccatggctataagataaccatcgcgccctcacttgaggctgcgttcttccttcgtgggctccctttctttcccagttcttcttcagtccctttcctcgtctatcccagtctgacagatagccggttgcatagcagctagggttgagtagcttacagtcagtttggcggagtcattctcagatatctcccctgacccatctctggaaaacctcacattgtccaacgagataagcatttatcatgtctcttcctaaggatttcctctggggcttcgctactgcggcgtaagtgcaaattctcagctgagattccggacttattatcagcaacaccttatgttcagagctcaacaactgatacggatatctctgcattagctatcagattgagggtgctatccacgccgacggccgtggcccctctatctgggatactttctgcaacattcccggtaaaatcgccgacggcagctctggtgccgtcgcctgcgactcttacaaccgcaccaaggaggacattgacctcctcaagtctctcggcgccaccgcctaccgcttctccatctcctggtctcgcatcatccccgttggtggtcgcaacgaccccatcaaccagaagggcatcgaccactatgtcaagtttgtcgatgacctgctcgaggctggtattaccccctttatcaccctcttccactgggatcttcccgatggtctcgacaagcgctacggcggtcttctgaaccgtgaagagttccccctcgactttgagcactacgcccgcactatgttcaaggccattcccaagtgcaagcactggatcaccttcaacgagccctggtgcagctccatcctcggctacaactcgggctactttgcccctggccacacctccgaccgtaccaagtcacccgttggtgacagcgctcgcgagccctggatcgtcggccataacctgctcatcgctcacgggcgtgccgtcaaggtgtaccgagaagacttcaagcccacgcagggcggcgagatcggtatcaccttgaacggcgacgccactcttccctgggatccagaggaccccttggacgtcgaggcgtgcgaccgcaagattgagttcgccatcagctggttcgcagaccccatctactttggaaagtaccccgactcgatgcgcaaacagctcggtgaccggctgcccgagtttacgcccgaggaggtggcgcttgtcaagggttccaacgacttctacggcatgaaccactacacagccaactacatcaagcacaagaagggcgtccctcccgaggacgacttcctcggcaacctcgagacgctcttctacaacaagaagggtaactgcatcgggcccgagacccagtcgttctggctccggccgcacgcccagggcttccgcgacctgctcaactggctcagcaagcgctacggataccccaagatctacgtgaccgagaacgggaccagtctcaagggcgagaacgccatgccgctcaagcaaattgtcgaggacgacttccgcgtcaagtacttcaacgactacgtcaacgccatggccaaggcgcatagcgaggacggcgtcaacgtcaagggatatcttgcctggagcttgatggacaactttgagtgggccgagggctatgagacgcggttcggcgttacctatgtcgactatgagaacgaccagaagaggtaccccaagaagagcgccaagagcttgaagccgctctttgactctttgatcaagaaggactaacggggcaagaagaaagcatgggtggattatctgttatgaaatttgtgatgaattgggcaagcgtcagcaagggaatgggaatgatttgcaagggtttagtgttcaggggtcctctgtttttttcgaccccctccttgagtgcgcattcgcgtattgcgttgtctggtacatagaagccgtgtaatcgagcagctgcatgtcgaatcgtgatgcttggtgttgtaccttcatgtaattagttatgtcacgcttacattcacgccctccccccacatccgctctaaccgaaaaggaaggagttagacaacctgaagtctaggtccctatttatttttttatagttatgttagtattaagaacgttatttatatttcaaatttttcttttttttctgtacagacgcgtgtacgcatgtaacattatactgaaaaccttgcttgagaaggttttgggacgctcgaaggctttaatttgc

SEQ ID NO: 5 - DNA, 1870 bp, synthetic construct
  misc_feature 1..1870: note = Synthetic: XYL1; Contain S. cerevisiae GAP promotor and TDH3 terminator, and ORF of XYL1 from Pichia stipitis
  source 1..1870: mol_type = other DNA
tcattatcaatactcgccatttcaaagaatacgtaaataattaatagtagtgattttcctaactttatttagtcaaaaaattagccttttaattctgctgtaacccgtacatgcccaaaatagggggcgggttacacagaatatataacatcgtaggtgtctgggtgaacagtttattcctggcatccactaaatataatggagcccgctttttaagctggcatccagaaaaaaaaagaatcccagcaccaaaatattgttttcttcaccaaccatcagttcataggtccattctcttagcgcaactacagagaacaggggcacaaacaggcaaaaaacgggcacaacctcaatggagtgatgcaacctgcctggagtaaatgatgacacaaggcaattgacccacgcatgtatctatctcattttcttacaccttctattaccttctgctctctctgatttggaaaaagctgaaaaaaaaggttgaaaccagttccctgaaattattcccctacttgactaataagtatataaagacggtaggtattgattgtaattctgtaaatctatttcttaaacttcttaaattctacttttatagttagtcttttttttagttttaaaacaccagaacttagtttcgatacaactatactacaatgccttctattaagttgaactctggttacgacatgccagccgtcggtttcggctgttggaaagtcgacgtcgacacctgttctgaacagatctaccgtgctatcaagaccggttacagattgttcgacggtgccgaagattacgccaacgaaaagttagttggtgccggtgtcaagaaggccattgacgaaggtatcgtcaagcgtgaagacttgttccttacctccaagttgtggaacaactaccaccacccagacaacgtcgaaaaggccttgaacagaaccctttctgacttgcaagttgactacgttgacttgttcttgatccacttcccagtcaccttcaagttcgttccattagaagaaaagtacccaccaggattctactgtggtaagggtgacaacttcgactacgaagatgttccaattttagagacctggaaggctcttgaaaagttggtcaaggccggtaagatcagatctatcggtgtttctaacttcccaggtgctttgctcttggacttgttgagaggtgctaccatcaagccatctgtcttgcaagttgaacaccacccatacttgcaacaaccaagattgatcgaattcgctcaatcccgtggtattgctgtcaccgcttactcttcgttcggtcctcaatctttcgttgaattgaaccaaggtagagctttgaacacttctccattgttcgagaacgaaactatcaaggctatcgctgctaagcacggtaagtctccagctcaagtcttgttgagatggtcttcccaaagaggcattgccatcattccaaagtccaacactgtcccaagattgttggaaaacaaggacgtcaacagcttcgacttggacgaacaagatttcgctgacattgccaagttggacatcaacttgagattcaacgacccatgggactgggacaagattcctatcttcgtctaagaaggttgctttatagagaggaaataaaacctaatatacattgattgtacatttgtgaatttactttaaatcttgcatttaaataaattttctttttatagctttatgacttagtttcaatttatatactattttaatgacattttcgattcattgattgaaagctttgtgttttttcttgatgcgctattgcattgttcttgtctttttcgccacatgtaatatctgtagtagatacctgatacattgtggat

SEQ ID NO: 6 - DNA, 2530 bp, synthetic construct
  misc_feature 1..2530: note = Synthetic: XYL2; Contain S. cerevisiae PGK1 promotor and PGK1 terminator, and ORF of XYL2 from Pichia stipitis
  source 1..2530: mol_type = other DNA
gttgttctcgagggaagtaccttcaaagaatggggtcttatcttgttttgcaagtaccactgagcaggataataatagaaatgataatatactatagtagagataacgtcgatgacttcccatactgtaattgcttttagttgtgtatttttagtgtgcaagtttctgtaaatcgattaatttttttttctttcctctttttattaaccttaatttttattttagattcctgacttcaactcaagacgcacagatattataacatctgcataataggcatttgcaagaattactcgtgagtaaggaaagagtgaggaactatcgcatacctgcatttaaagatgccgatttgggcgcgaatcctttattttggcttcaccctcatactattatcagggccagaaaaaggaagtgtttccctccttcttgaattgatgttaccctcataaagcacgtggcctcttatcgagaaagaaattaccgtcgctcgtgatttgtttgcaaaaagaacaaaactgaaaaaacccagacacgctcgacttcctgtcttcctattgattgcagcttccaatttcgtcacacaacaaggtcctagcgacggctcacaggttttgtaacaagcaatcgaaggttctggaatggcgggaaagggtttagtaccacatgctatgatgcccactgtgatctccagagcaaagttcgttcgatcgtactgttactctctctctttcaaacagaattgtccgaatcgtgtgacaacaacagcctgttctcacacactcttttcttctaaccaagggggtggtttagtttagtagaacctcgtgaaacttacatttacatatatataaacttgcataaattggtcaatgcaagaaatacatatttggtcttttctaattcgtagtttttcaagttcttagatgctttctttttctcttttttacagatcatcaaggaagtaattatctactttttacaacaaatataaaacaagcggccgcaacaaccctcactttagtttgtttcaatcacccctaatactcttcacacaattaaaatgactgctaacccttccttggtgttgaacaagatcgacgacatttcgttcgaaacttacgatgccccagaaatctctgaacctaccgatgtcctcgtccaggtcaagaaaaccggtatctgtggttccgacatccacttctacgcccatggtagaatcggtaacttcgttttgaccaagccaatggtcttgggtcacgaatccgccggtactgttgtccaggttggtaagggtgtcacctctcttaaggttggtgacaacgtcgctatcgaaccaggtattccatccagattctccgacgaatacaagagcggtcactacaacttgtgtcctcacatggccttcgccgctactcctaactccaaggaaggcgaaccaaacccaccaggtaccttatgtaagtacttcaagtcgccagaagacttcttggtcaagttgccagaccacgtcagcttggaactcggtgctcttgttgagccattgtctgttggtgtccacgcctctaagttgggttccgttgctttcggcgactacgttgccgtctttggtgctggtcctgttggtcttttggctgctgctgtcgccaagaccttcggtgctaagggtgtcatcgtcgttgacattttcgacaacaagttgaagatggccaaggacattggtgctgctactcacaccttcaactccaagaccggtggttctgaagaattgatcaaggctttcggtggtaacgtgccaaacgtcgttttggaatgtactggtgctgaaccttgtatcaagttgggtgttgacgccattgccccaggtggtcgtttcgttcaagtcggtaacgctgctggtccagtcagcttcccaatcaccgttttcgccatgaaggaattgactttgttcggttctttcagatacggattcaacgactacaagactgctgttggaatctttgacactaactaccaaaacggtagagaaaatgctccaattgactttgaacaattgatcacccacagatacaagttcaaggacgctattgaagcctacgacttggtcagagccggtaagggtgctgtcaagtgtctcattgacggccctgagtaagtcaaccgcttggctggcccaaagtgaaccagaaacgaaaatgattatcaaatagctttatagacctttatccaaatttatgtaaactaatagtaaggaattgccaggtgttgctttcttatccgaaaagaaataaattgaattgaattgaaatcgatagatcaatttttttcttttctctttccccatcctttacgctaaaataatagtttattttattttttgaatattttttatttatatacgtatatatagactattatttatcttttaatgattattaagatttttattaaaaaaaaattcgctcctcttttaatgcctttatgcagtttttttttcccattcgatatttctatgttcgggttcagcgtattt

SEQ ID NO: 7 - DNA, 3046 bp, synthetic construct
  misc_feature 1..3046: note = Synthetic: XYL3; Contain S. cerevisiae GAP promotor and TDH3 terminator, and ORF of XYL3 from Pichia stipitis
  source 1..3046: mol_type = other DNA
tcattatcaatactcgccatttcaaagaatacgtaaataattaatagtagtgattttcctaactttatttagtcaaaaaattagccttttaattctgctgtaacccgtacatgcccaaaatagggggcgggttacacagaatatataacatcgtaggtgtctgggtgaacagtttattcctggcatccactaaatataatggagcccgctttttaagctggcatccagaaaaaaaaagaatcccagcaccaaaatattgttttcttcaccaaccatcagttcataggtccattctcttagcgcaactacagagaacaggggcacaaacaggcaaaaaacgggcacaacctcaatggagtgatgcaacctgcctggagtaaatgatgacacaaggcaattgacccacgcatgtatctatctcattttcttacaccttctattaccttctgctctctctgatttggaaaaagctgaaaaaaaaggttgaaaccagttccctgaaattattcccctacttgactaataagtatataaagacggtaggtattgattgtaattctgtaaatctatttcttaaacttcttaaattctacttttatagttagtcttttttttagttttaaaacaccagaacttagtttcgaatagatccctggaggatacccacagacattactgctactaattcataccatacttgacgtatatctgcgcatacatatctaccccaactttcatataaaattcctagatttattgcatcttctaatagagtcatttttcagatttttcaatttccatagaaagcatacattttcatacagcttctatttgttaatcgacctgataattttactagccatatttctttttttgatttttcacttaatcgacatataaatactcacgtagttgacactcacaatgaccactaccccatttgatgctccagataagctcttcctcgggttcgatctttcgactcagcagttgaagatcatcgtcaccgatgaaaacctcgctgctctcaaaacctacaatgtcgagttcgatagcatcaacagctctgtccagaagggtgtcattgctatcaacgacgaaatcagcaagggtgccattatttcccccgtttacatgtggttggatgcccttgaccatgtttttgaagacatgaagaaggacggattccccttcaacaaggttgttggtatttccggttcttgtcaacagcacggttcggtatactggtctagaacggccgagaaggtcttgtccgaattggacgctgaatcttcgttatcgagccagatgagatctgctttcaccttcaagcacgctccaaactggcaggatcactctaccggtaaagagcttgaagagttcgaaagagtgattggtgctgatgccttggctgatatctctggttccagagcccattacagattcacagggctccagattagaaagttgtctaccagattcaagcccgaaaagtacaacagaactgctcgtatctctttagtttcgtcatttgttgccagtgtgttgcttggtagaatcacctccattgaagaggccgatgcttgtggaatgaacttgtacgatatcgaaaagcgcgagttcaacgaagagctcttggccatcgctgctggtgtccaccctgagttggatggtgtagaacaagacggtgaaatttacagagctggtatcaatgagttgaagagaaagttgggtcctgtcaaacctataacatacgaaagcgaaggtgacattgcctcttactttgtcaccagatacggcttcaaccccgactgtaaaatctactcgttcaccggagacaatttggccacgattatctcgttgcctttggctccaaatgatgctttgatctcattgggtacttctactacagttttaattatcaccaagaactacgctccttcttctcaataccatttgtttaaacatccaaccatgcctgaccactacatgggcatgatctgctactgtaacggttccttggccagagaaaaggttagagacgaagtcaacgaaaagttcaatgtagaagacaagaagtcgtgggacaagttcaatgaaatcttggacaaatccacagacttcaacaacaagttgggtatttacttcccacttggcgaaattgtccctaatgccgctgctcagatcaagagatcggtgttgaacagcaagaacgaaattgtagacgttgagttgggcgacaagaactggcaacctgaagatgatgtttcttcaattgtagaatcacagactttgtcttgtagattgagaactggtccaatgttgagcaagagtggagattcttctgcttccagctctgcctcacctcaaccagaaggtgatggtacagatttgcacaaggtctaccaagacttggttaaaaagtttggtgacttgtacactgatggaaagaagcaaacctttgagtctttgaccgccagacctaaccgttgttactacgtcggtggtgcttccaacaacggcagcattatccgcaagatgggttccatcttggctcccgtcaacggaaactacaaggttgacattcctaacgcctgtgcattgggtggtgcttacaaggccagttggagttacgagtgtgaagccaagaaggaatggatcggatacgatcagtatatcaacagattgtttgaagtaagtgacgagatgaatctgttcgaagtcaaggataaatggctcgaatatgccaacggggttggaatgttggccaagatggaaagtgaattgaaacactaaaatccataatagcttgtatagaggtatagaaaaagagaacgttatagagtgtgaatttactttaaatcttgcatttaaataaattttctttttatagctttatgacttagtttcaatttatatactattttaatgacattttcgattcattgattgaaagctttgtgttttttcttgatgcgctattgcattgttcttgtctttttcgccacatgtaatatctgtagtagatacctgatacattgtggat

SEQ ID NO: 8 - DNA, 5562 bp, Saccharomyces cerevisiae
  misc_feature 1..5562
  misc_feature 1..5562: note = YLLO56C Sequence: 5-3 ; Contains ORF for S. cerevisiae YLLO56C,
  source 1..5562: mol_type = genomic DNA
gcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctttgagtgagctgataccgctcgccgcagccgaacgaccgagcgcagcgagtcagtgagcgaggaagcggaagagcgcccaatacgcaaaccgcctctccccgcgcgttggccgattcattaatgcagctggcacgacaggtttcccgactggaaagcgggcagtgagcgcaacgcaattaatgtgagttagctcactcattaggcaccccaggctttacactttatgcttccggctcgtatgttgtgtggaattgtgagcggataacaatttcacacaggaaacagctatgaccatgattacgccaagctcgaaattaaccctcactaaagggaacaaaagctgctagtacggattagaagccgccgagcgggtgacagccctccgaaggaagactctcctccgtgcgtcctcgtcttcaccggtcgcgttcctgaaacgcagatgtgcctcgcgccgcactgctccgaacaataaagattctacaatactagcttttatggttatgaagaggaaaaattggcagtaacctggccccacaaaccttcaaatgaacgaatcaaattaacaaccataggatgataatgcgattagttttttagccttatttctggggtaattaatcagcgaagcgatgatttttgatctattaacagatatataaatgcaaaaactgcataaccactttaactaatactttcaacattttcggtttgtattacttcttattcaaatgtaataaaagtatcaacaaaaaattgttaatatacctctatactttaacgtcaaggagaaaaaaccccggatcggactactagcagctgtaatacgactcactatagggaatattaagctaattccctacttcatatgaaagtatttataactggtgcttctggcttcattggttctgccgtattatctgaactaatatcctcgggtcatgaagttgttggcttggcaaggtcagacgaggctgctgcaaagattaagtcgattgatcctgctgcaaaaatccttcgcggtgatctcaaggatctggaaattttgaaaaaaggtgccactgaatctgatggcgttattcatttaggatttgtgcatgattttaaaaattttgaacagtgctgcgaaattgaccgtcaggccactgtagctatgctagagtcacttaaaggttctaacaagcctttcttatatacgaatggtacactttctttgcgaccaaacaaagttgctaacgaacaggatggtattgatgaagattccaaaattttgcgtgctgtcactgaacaggttgccttgagttacaaagacaaaggtgtttcagcaagaattgtcagactcccattctcggttcatggcaagggggacaaggcttttgtaccaatattaatgaatattgccaaagctgccggaaaatctggctatgtcggacaaggcacaaacgcttgggcggctgtacatcgtttggatacggctcctctgttcagacttgttttagagaaaggaaaaacaggacaagtgtatcattgcgttggtgaacaaggtataccattcaaagatattgcgcgtgtgattggagaaattttgaatgttcccgtggcctctatccctgttgatgacgcggaaagtcattttggcttcctcacttgttttgtcactagagatggcccagtttcaagcgaaggtaccagaaaagagctgggatggcagccacaacaaatcggtcttcttgaagatatccgtgcgaactatagcttaaactgaactactcagtaataacctatttcttagcatttttgacgaaatttgctattttgttagagtcttttacaccatttgtctccacacctccgcttacatcaacaccaataacgccatttaatctaagcgcatcaccaacattttctggcgtcagtccaccagctaacataaaatgtaagctctcggggctctcttgccttccaacccagtcagaaatcgagttccaatccaaaagttcacctgtcccacctgcttctgaatcaaacaagggaataaacgaatgaggtttctgtgaagctgcactgagtagtatgttgcagtcttttggaaatacgagtcttttaataactggcaaaccgaggaactcttggtattcttgccacgactcatctccgtgcagttggacgatatcaatgccgtaatcattgaccagagccaaaacatcctccttaggttgattacgaaacacgccaaccaagtatttcggagtgcctgaactatttttatatgcttttacaagacttgaaattttccttgcaataaccgggtcaattgttctctttctattgggcacacatataatacccagcaagtcagcatcggaatctagagcacattctgcggcctctgtgctctgcaagccgcaaactttcaccaatggaccagaactacctgtgaaattaataacagacatactccaagctgcctttgtgtgcttaatcacgtatactcacgtgctcaatagtcaccaatgccctccctcttggccctctccttttcttttttcgaccgaatttcttgaagacgaaagggcctcgtgatacgcctatttttataggttaatgtcatgataataatggtttcttaggacggatcgcttgcctgtaacttacacgcgcctcgtatcttttaatgatggaataatttgggaatttactctgtgtttatttatttttatgttttgtatttggattttagaaagtaaataaagaaggtagaagagttacggaatgaagaaaaaaaaataaacaaaggtttaaaaaatttcaacaaaaagcgtactttacatatatatttattagacaagaaaagcagattaaatagatatacattcgattaacgataagtaaaatgtaaaatcacaggattttcgtgtgtggtcttctacacagacaagatgaaacaattcggcattaatacctgagagcaggaagagcaagataaaaggtagtatttgttggcgatccccctagagtcttttacatcttcggaaaacaaaaactattttttctttaatttctttttttactttctatttttaatttatatatttatattaaaaaatttaaattataattatttttatagcacgtgatgaaaaggacccaggtggcacttttcggggaaatgtgcgcggaacccctatttgtttatttttctaaatacattcaaatatgtatccgctcatgagacaataaccctgataaatgcttcaataatattgaaaaaggaagagtatgagtattcaacatttccgtgtcgcccttattcccttttttgcggcattttgccttcctgtttttgctcacccagaaacgctggtgaaagtaaaagatgctgaagatcagttgggtgcacgagtgggttacatcgaactggatctcaacagcggtaagatccttgagagttttcgccccgaagaacgttttccaatgatgagcacttttaaagttctgctatgtggcgcggtattatcccgtgttgacgccgggcaagagcaactcggtcgccgcatacactattctcagaatgacttggttgagtactcaccagtcacagaaaagcatcttacggatggcatgacagtaagagaattatgcagtgctgccataaccatgagtgataacactgcggccaacttacttctgacaacgatcggaggaccgaaggagctaaccgcttttttgcacaacatgggggatcatgtaactcgccttgatcgttgggaaccggagctgaatgaagccataccaaacgacgagcgtgacaccacgatgcctgtagcaatggcaacaacgttgcgcaaactattaactggcgaactacttactctagcttcccggcaacaattaatagactggatggaggcggataaagttgcaggaccacttctgcgctcggcccttccggctggctggtttattgctgataaatctggagccggtgagcgtgggtctcgcggtatcattgcagcactggggccagatggtaagccctcccgtatcgtagttatctacacgacggggagtcaggcaactatggatgaacgaaatagacagatcgctgagataggtgcctcactgattaagcattggtaactgtcagaccaagtttactcatatatactttagattgatttaaaacttcatttttaatttaaaaggatctaggtgaagatcctttttgataatctcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgttcttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctttgagtgagctgataccgctcgccgcagccgaacgaccgagcgcagcgagtcagtgagcgaggaagcggaagagcgcctgatgcggtattttctccttacgcatctgtgcggtatttcacaccgcatatggtgcactctcagtacaatctgctctgatgccgcatagttaagccagtatacactccgctatcgc

SEQ ID NO: 9 - DNA, 8630 bp, Saccharomyces cerevisiae
  misc_feature 1..8630: note = pVT100-ALD5 sequence: 5-3 ; Contains ORF for S. cerevisiae ALD5 in pVT100 expression cassette
  source 1..8630: mol_type = genomic DNA
caacttcttttctttttttttcttttctctctcccccgttgttgtctcaccatatccgcaatgacaaaaaaatgatggaagacactaaaggaaaaaattaacgacaaagacagcaccaacagatgtcgttgttccagagctgatgaggggtatctcgaagcacacgaaactttttccttccttcattcacgcacactactctctaatgagcaacggtatacggccttccttccagttacttgaatttgaaataaaaaaaagtttgctgtcttgctatcaagtataaatagacctgcaattattaatcttttgtttcctcgtcattgttctcgttccctttcttccttgtttctttttctgcacaatatttcaagctataccaagcatacaatcaactccaagcttatggcctccactcgtgtcctcgcctctcgcctggcctcccggatggctgcttccgccaaggttgcccgccctgctgtccgcgttgctcaggtcagcaagcgcaccatccagactggctcccccctccagaccctcaagcgcacccagatgacctccatcgtcaacgccaccacccgccaggctttccagaagcgcgcctactcttccggatccccgggtacatgctttctcgcacaagagctgcagctccgaattccagaatattcactagaagcttgttacgtctttattctcaagcaccattacgcgttccaattactcttccaaatggtttcacctacgaacagccaacagggttattcatcaatggtgaatttgttgcctcgaagcaaaagaaaacgtttgacgtgatcaatccatctaacgaagaaaagataacaactgtatacaaggctatggaagatgatgttgatgaagccgttgcagcggctaaaaaagcttttgaaacgaagtggtctattgtagagccggaggttcgcgctaaagctttattcaatctcgctgacttggttgagaaacaccaagaaacactggctgccattgagtcaatggataatggtaagtcattgttttgtgcgcgcggtgacgtcgctttagtatctaaatacttgcgttcttgcggtggttgggcagataaaatctacggtaacgttattgacacaggtaaaaaccattttacctactcaattaaggaaccattaggcgtttgcggccaaataatcccttggaacttccctttattgatgtggtcatggaaaattgggcctgctctggctacaggtaacaccgtcgtattgaaacccgctgaaacaacacctttatctgcccttttcgcttcccagttgtgtcaggaagcaggcatacccgctggtgtagtcaatatccttccgggttccggtagagttgttggagaaagattgagtgcacacccagacgtgaagaagattgcttttacaggctctactgccaccggccgccatattatgaaggtcgctgccgatactgtcaagaaagtcactttggagctgggaggtaaatcaccaaatattgtgtttgctgacgctgatctagataaagccgtcaagaacattgccttcggtattttttacaactctggtgaagtttgctgcgctggttccagaatatacattcaagatacagtatacgaggaggtgttgcaaaaactaaaggattacaccgagtcactaaaggtcggtgacccatttgatgaggaagttttccaaggtgctcaaacatctgacaaacagctgcataaaattttagactatgtcgatgtagcaaaatcagagggggctcgtcttgtgactggaggggccagacatggcagtaaaggttattttgtcaagccaacagtgtttgctgatgtcaaagaagatatgagaattgttaaggaggaagtgtttggtcccattgtaactgtatccaagttttctactgttgatgaagtgattgctatggcaaatgattctcaatatgggttagccgcaggtattcacactaacgatattaacaaggctgttgatgtgtccaaaagagtgaaagctggtactgtttggataaatacctataacaacttccaccaaaatgttcctttcggtggcttcggccagtcaggtattggccgtgaaatgggtgaggctgctttaagtaactacactcaaacaaaatctgtcagaattgccattgacaagccaattcgttgaagctcgtctagaggatccagctttggacttcttcgccagaggtttggtcaagtctccaatcaaggttgtcggcttgtctaccttgccagaaatttacgaaaagatggaaaagggtcaaatcgttggtagatacgttgttgacacttctaaataagcgaatttcttatgatttatgatttttattattaaataagttataaaaaaaataagtgtatacaaattttaaagtgactcttaggttttaaaacgaaaattcttattcttgagtaactctttcctgtaggtcaggttgctttctcaggtatagcatgaggtcgctcttattgaccacacctctaccggcatgcgatatgatccaatatcaaaggaaatgatagcattgaaggatgagactaatccaattgaggagtggcagcatatagaacagctaaagggtagtgctgaaggaagcatacgataccccgcatggaatgggataatatcacaggaggtactagactacctttcatcctacataaatagacgcatataagtacgcatttaagcataaacacgcactatgccgttcttctcatgtatatatatatacaggcaacacgcagatataggtgcgacgtgaacagtgagctgtatgtgcgcagctcgcgttgcattttcggaagcgctcgttttcggaaacgctttgaagttcctattccgaagttcctattctctagctagaaagtataggaacttcagagcgcttttgaaaaccaaaagcgctctgaagacgcactttcaaaaaaccaaaaacgcaccggactgtaacgagctactaaaatattgcgaataccgcttccacaaacattgctcaaaagtatctctttgctatatatctctgtgctatatccctatataacctacccatccacctttcgctccttgaacttgcatctaaactcgacctctacattttttatgtttatctctagtattactctttagacaaaaaaattgtagtaagaactattcatagagtgaatcgaaaacaatacgaaaatgtaaacatttcctatacgtagtatatagagacaaaatagaagaaaccgttcataattttctgaccaatgaagaatcatcaacgctatcactttctgttcacaaagtatgcgcaatccacatcggtatagaatataatcggggatgcctttatcttgaaaaaatgcacccgcagcttcgctagtaatcagtaaacgcgggaagtggagtcaggctttttttatggaagagaaaatagacaccaaagtagccttcttctaaccttaacggacctacagtgcaaaaagttatcaagagactgcattatagagcgcacaaaggagaaaaaaagtaatctaagatgctttgttagaaaaatagcgctctcgggatgcatttttgtagaacaaaaaagaagtatagattctttgttggtaaaatagcgctctcgcgttgcatttctgttctgtaaaaatgcagctcagattctttgtttgaaaaattagcgctctcgcgttgcatttttgttttacaaaaatgaagcacagattcttcgttggtaaaatagcgctttcgcgttgcatttctgttctgtaaaaatgcagctcagattctttgtttgaaaaattagcgctctcgcgttgcatttttgttctacaaaatgaagcacagatgcttcgttaacaaagatatgctattgaagtgcaagatggaaacgcagaaaatgaaccggggatgcgacgtgcaagattacctatgcaatagatgcaatagtttctccaggaaccgaaatacatacattgtcttccgtaaagcgctagactatatattattatacaggttcaaatatactatctgtttcagggaaaactcccaggttcggatgttcaaaattcaatgatgggtaacaagtacgatcgtaaatctgtaaaacagtttgtcggatattaggctgtatctcctcaaagcgtattcgaatatcattgagaagctgcattttttttttttttttttttttttttttttatatatatttcaaggatataccattgtaatgtctgcccctaagaagatcgtcgttttgccaggtgaccacgttggtcaagaaatcacagccgaagccattaaggttcttaaagctatttctgatgttcgttccaatgtcaagttcgatttcgaaaatcatttaattggtggtgctgctatcgcagatctggctttttctttccaattttttttttttcgtcattataaaaatcattacgaccgagattcccgggtaataactgatataattaaattgaagctctaatttgtgagtttagtatacatgcatttacttataatacagttttttagttttgctggccgcatcttctcaaatatgcttcccagcctgcttttctgtaacgttcaccctctaccttagcatcccttccctttgcaaatagtcctcttccaacaataataatgtcagatcctgtagagaccacatcatccacggttctatactgttgacccaatgcgtctcccttgtcatctaaacccacaccgggtgtcataatcaaccaatcgtaaccttcatctcttccacccatgtctctttgagcaataaagccgataacaaaatctttgtcgctcttcgcaatgtcaacagtacccttagtatattctccagtagatagggagcccttgcatgacaattctgctaacatcaaaaggcctctaggttcctttgttacttcttctgccgcctgcttcaaaccgctaacaatacctgggcccaccacaccgtgtgcattcgtaatgtctgcccattctgctattctgtatacacccgcagagtactgcaatttgactgtattaccaatgtcagcaaattttctgtcttcgaagagtaaaaaattgtacttggcggataatgcctttagcggcttaactgtgccctccatggaaaaatcagtcaagatatccacatgtgtttttagtaaacaaattttgggacctaatgcttcaactaactccagtaattccttggtggtacgaacatccaatgaagcacacaagtttgtttgcttttcgtgcatgatattaaatagcttggcagcaacaggactaggatgagtagcagcacgttccttatatgtagctttcgacatgatttatcttcgtttccggtttttgttctgtgcagttgggttaagaatactgggcaatttcatgtttcttcaacactacatatgcgtatatataccaatctaagtctgtgctccttccttcgttcttccttctgttcggagattaccgaatcaaaaaaatttcaaggaaaccgaaatcaaaaaaaagaataaaaaaaaaatgatgaattgaaaagccagatctggatctgtttctggctatatgctggagtcagcactggaagcgggtctgatcatctccgatgaagcctccgttatcccaggctccttgggtttgttgccatctgcgtccttggcctctttgccagacaagaacaccgcatttggtttgtacgaaccatgccatggttccgctccagatttgccaaagaataaggtcaaccctatcgccactatcttgtctgctgcaatgatgttgaaattgtcattgaacttgcctgaagaaggtaaagccattgaagatgcagttaaaaaggttttggatgcaggtatcagaactggtgatttaggtggttccaacagtaccaccgaagtcggtgatgctgtcgccgaagaagttaagaaaatccttgcttaaaaagattctctttttttatgatatttgtacagcgtcacatcggataataatgatggcagccattgtagaagtgccttttgcatttctagtctctttctcggtctagctagttttactacatcgcgaagatagaatcttagatcacactgcctttgctgagctggatcaatagagtaacaaaagagtggtaaggaccccggttgataatcagaaaagccccaaaaacaggaagattgtataagcaaatatttaaattgtaagcgttaatattttgttaaaattcgcgttaaatttttgttaaatcagctcattttttaaccaataggccgaaatcggcaaaatcccttataaatcaaaagaatagaccgagatagggttgagtgttgttccagtttggaacaagagtccactattaaagaacgtggactccaacgtcaaagggcgaaaaaccgtctatcagggcgatggcccactacgtgaaccatcaccctaatcaagttttttggggtcgaggtgccgtaaagcactaaatcggaaccctaaagggagcccccgatttagagcttgacggggaaagccggcgaacgtggcgagaaaggaagggaagaaagcgaaaggagcgggcgctagggcgctggcaagtgtagcggtcacgctgcgcgtaaccaccacacccgccgcgcttaatgcgccgctacagggcgcgtcctcgttaaaggacaaggacctgagcggaagtgtatcgtacagtagacggagtatactagtatagtctatagtccgtggaattcttgaagacgaaagggcctcgtgatacgcctatttttataggttaatgtcatgataataatggtttcttagacgtcaggtggcacttttcggggaaatgtgcgcggaacccctatttgtttatttttctaaatacattcaaatatgtatccgctcatgagacaataaccctgataaatgcttcaataatattgaaaaaggaagagtatgagtattcaacatttccgtgtcgcccttattcccttttttgcggcattttgccttcctgtttttgctcacccagaaacgctggtgaaagtaaaagatgctgaagatcagttgggtgcacgagtgggttacatcgaactggatctcaacagcggtaagatccttgagagttttcgccccgaagaacgttttccaatgatgagcacttttaaagttctgctatgtggcgcggtattatcccgtattgacgtcgggcaagagcaactcggtcgccgcatacactattctcagaatgacttggttgagtactcaccagtcacagaaaagcatcttacggatggcatgacagtaagagaattatgcagtgctgccataaccatgagtgataacactgcggccaacttacttctgacaacgatcggaggaccgaaggagctaaccgcttttttgcacaacatgggggatcatgtaactcgccttgatcgttgggaaccggagctgaatgaagccataccaaacgacgagcgtgacaccacgatgcctgtagcaatggcaacaacgttgcgcaaactattaactggcgaactacttactctagcttcccggcaacaattaatagactggatggaggcggataaagttgcaggaccacttctgcgctcggcccttccggctggctggtttattgctgataaatctggagccggtgagcgtgggtctcgcggtatcattgcagcactggggccagatggtaagccctcccgtatcgtagttatctacacgacggggagtcaggcaactatggatgaacgaaatagacagatcgctgagataggtgcctcactgattaagcattggtaactgtcagaccaagtttactcatatatactttagattgatttaaaacttcatttttaatttaaaaggatctaggtgaagatcctttttgataatctcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcccgacctcgacgcatg

SEQ ID NO: 10 - DNA, 2649 bp, Saccharomyces cerevisiae
  misc_feature 1..2649: note = Genome integrated sequence of ALD5 at X-2 locus: 5-3 ; Contains ORF for S. cerevisiae ALD5 integrated at X-2 locus: 5-3
  source 1..2649: mol_type = genomic DNA
cataccatattaagtaaattgcctccatttctttttcctcgggcagagaacgacctcgacgcatgcaacttcttttctttttttttcttttctctctcccccgttgttgtctcaccatatccgcaatgacaaaaaaatgatggaagacactaaaggaaaaaattaacgacaaagacagcaccaacagatgtcgttgttccagagctgatgaggggtatctcgaagcacacgaaactttttccttccttcattcacgcacactactctctaatgagcaacggtatacggccttccttccagttacttgaatttgaaataaaaaaaagtttgctgtcttgctatcaagtataaatagacctgcaattattaatcttttgtttcctcgtcattgttctcgttccctttcttccttgtttctttttctgcacaatatttcaagctataccaagcatacaatcaactccaagcttatggcctccactcgtgtcctcgcctctcgcctggcctcccggatggctgcttccgccaaggttgcccgccctgctgtccgcgttgctcaggtcagcaagcgcaccatccagactggctcccccctccagaccctcaagcgcacccagatgacctccatcgtcaacgccaccacccgccaggctttccagaagcgcgcctactcttccggatccccgggtacatgctttctcgcacaagagctgcagctccgaattccagaatattcactagaagcttgttacgtctttattctcaagcaccattacgcgttccaattactcttccaaatggtttcacctacgaacagccaacagggttattcatcaatggtgaatttgttgcctcgaagcaaaagaaaacgtttgacgtgatcaatccatctaacgaagaaaagataacaactgtatacaaggctatggaagatgatgttgatgaagccgttgcagcggctaaaaaagcttttgaaacgaagtggtctattgtagagccggaggttcgcgctaaagctttattcaatctcgctgacttggttgagaaacaccaagaaacactggctgccattgagtcaatggataatggtaagtcattgttttgtgcgcgcggtgacgtcgctttagtatctaaatacttgcgttcttgcggtggttgggcagataaaatctacggtaacgttattgacacaggtaaaaaccattttacctactcaattaaggaaccattaggcgtttgcggccaaataatcccttggaacttccctttattgatgtggtcatggaaaattgggcctgctctggctacaggtaacaccgtcgtattgaaacccgctgaaacaacacctttatctgcccttttcgcttcccagttgtgtcaggaagcaggcatacccgctggtgtagtcaatatccttccgggttccggtagagttgttggagaaagattgagtgcacacccagacgtgaagaagattgcttttacaggctctactgccaccggccgccatattatgaaggtcgctgccgatactgtcaagaaagtcactttggagctgggaggtaaatcaccaaatattgtgtttgctgacgctgatctagataaagccgtcaagaacattgccttcggtattttttacaactctggtgaagtttgctgcgctggttccagaatatacattcaagatacagtatacgaggaggtgttgcaaaaactaaaggattacaccgagtcactaaaggtcggtgacccatttgatgaggaagttttccaaggtgctcaaacatctgacaaacagctgcataaaattttagactatgtcgatgtagcaaaatcagagggggctcgtcttgtgactggaggggccagacatggcagtaaaggttattttgtcaagccaacagtgtttgctgatgtcaaagaagatatgagaattgttaaggaggaagtgtttggtcccattgtaactgtatccaagttttctactgttgatgaagtgattgctatggcaaatgattctcaatatgggttagccgcaggtattcacactaacgatattaacaaggctgttgatgtgtccaaaagagtgaaagctggtactgtttggataaatacctataacaacttccaccaaaatgttcctttcggtggcttcggccagtcaggtattggccgtgaaatgggtgaggctgctttaagtaactacactcaaacaaaatctgtcagaattgccattgacaagccaattcgttgaagctcgtctagaggatccagctttggacttcttcgccagaggtttggtcaagtctccaatcaaggttgtcggcttgtctaccttgccagaaatttacgaaaagatggaaaagggtcaaatcgttggtagatacgttgttgacacttctaaataagcgaatttcttatgatttatgatttttattattaaataagttataaaaaaaataagtgtatacaaattttaaagtgactcttaggttttaaaacgaaaattcttattcttgagtaactctttcctgtaggtcaggttgctttctcaggtatagcatgaggtcgctcttattgaccacacctctaccggcatcctgcataatcggccctcacagagggatcccgttacccatctatgctgaa

SEQ ID NO: 11 - DNA, 49 bp, synthetic construct
  misc_feature 1..49: note = Synthetic: oLJLJ501; forward primer for cloning S. cerevisiae BY4743 YLLO56C gene
  source 1..49: mol_type = other DNA
gatgacgataaggtaccagatgaaagtatttataactggtgcttctggc

SEQ ID NO: 12 - DNA, 49 bp, synthetic construct
  misc_feature 1..49: note = Synthetic: oLJLJ502; reverse primer for cloning S. cerevisiae BY4743 YLLO56C gene
  source 1..49: mol_type = other DNA
gtgctggatatctgcagtcagtttaagctatagttcgcacggatatctt

SEQ ID NO: 13 - DNA, 46 bp, synthetic construct
  misc_feature 1..46: note = Synthetic: oLJLJ499; forward primer for linearizing the plasmid backbone pYD1
  source 1..46: mol_type = other DNA
gcagatatccagcacaatactactcagtaataacctatttcttagc

SEQ ID NO: 14 - DNA, 35 bp, synthetic construct
  misc_feature 1..35: note = Synthetic: oLJLJ500; reverse primer for linearizing the plasmid backbone pYD1
  source 1..35: mol_type = other DNA
taccttatcgtcatctacagctgctagtagtccga

SEQ ID NO: 15 - DNA, 36 bp, synthetic construct
  misc_feature 1..36: note = Synthetic: oLJLJ503; forward primer for cloning for cloning S. cerevisiae BY4743 ALD5 gene
  source 1..36: mol_type = other DNA
cggatccccgggtacatgctttctcgcacaagagct

SEQ ID NO: 16 - DNA, 41 bp, synthetic construct
  misc_feature 1..41: note = Synthetic: oLJLJ504; reverse primer for cloning for cloning S. cerevisiae BY4743 ALD5 gene
  source 1..41: mol_type = other DNA
gatcctctagacgagcttcaacgaattggcttgtcaatggc

SEQ ID NO: 17 - protein, 320 aa, synthetic construct
  REGION 1..320: note = Synthetic: LCC; a recombinant protein having a leaf-branch compost cutinase attached in frame with a yeast secretion signal peptide
MNFPRASRLMQAAVLGGLMAVSAAATAMDGVLWRVRTAALMAALLALAAWALVWASPSVEAQSNPYQRGPNPTRSALTADGPFSVATYTVSRLSVSGFGGGVIYYPTGTSLTFGGIAMSPGYTADASSLAWLGRRLASHGFVVLVINTNSRFDGPDSRASQLSAALNYLRTSSPSAVRARLDANRLAVAGHSMGGGGTLRIAEQNPSLKAAVPLTPWHTDKTFNTSVPVLIVGAEADTVAPVSQHAIPFYQNLPSTTPKVYVELCNASHIAPNSNNAAISVYTISWMKLWVDNDTRYRQFLCNVNDPALCDFRTNNRHCQ

SEQ ID NO: 18 - protein, 320 aa, Rhizopus oryzae
  REGION 1..320: note = misc_feature - ldhA L-lactate dehydrogenase A
MVLHSKVAIVGAGAVGASTAYALMFKNICTEIIIVDVNPDIVQAQVLDLADAASISHTPIRAGSAEEAGQADIVVITAGAKQREGEPRTKLIERNFRVLQSIIGGMQPIRPDAVILVVANPVDILTHIAKTLSGLPPNQVIGSGTYLDTTRLRVHLGDVFDVNPQSVHAFVLGEHGDSQMIAWEAASIGGQPLTSFPEFAKLDKTAISKAISGKAMEIIRLKGATFYGIGACAADLVHTIMLNRKSVHPVSVYVEKYGATFSMPAKLGWRGVEQIYEVPLTEEEEALLVKSVEALKSVEYSSTKVPEKKVHATSFSKSSC

SEQ ID NO: 19 - protein, 476 aa, Neurospora crassa
  REGION 1..476: note = misc_feature - CDT-1
MVGAPFAAILSDRFGRKKGMFIGGIFIIVGSIIVASSSKLAQFVVGRFVLGLGIAIMTVAAPAYSIEIAPPHWRGRCTGFYNCGWFGGSIPAACITYGCYFIKSNWSWRIPLILQAFTCLIVMSSVFFLPESPRFLFANGRDAEAVAFLVKYHGNGDPNSKLVLLETEEMRDGIRTDGVDKVWWDYRPLFMTHSGRWRMAQVLMISIFGQFSGNGLGYFNTVIFKNIGVTSTSQQLAYNILNSVISAIGALTAVSMTDRMPRRAVLIIGTFMCAAALATNSGLSATLDKQTQRGTQINLNQGMNEQDAKDNAYLHVDSNYAKGALAAYFLFNVIFSFTYTPLQGVIPTEALETTIRGKGLALSGFIVNAMGFINQFAGPIALHNIGYKYIFVFVGWDLIETVAWYFFGYVLGLLLCRHRVNSTQIANSFHYSVESQGRTLEQLEWVYDQPNPVKASLKVEKVVVQADGHVSEAIVA

SEQ ID NO: 20 - protein, 326 aa, Neurospora crassa
  REGION 1..326: note = misc_feature - gh-1-1
MFKAIPKCKHWITFNEPWCSSILGYNSGYFAPGHTSDRTKSPVGDSAREPWIVGHNLLIAHGRAVKVYREDFKPTQGGEIGITLNGDATLPWDPEDPLDVEACDRKIEFAISWFADPIYFGKYPDSMRKQLGDRLPEFTPEEVALVKGSNDFYGMNHYTANYIKHKKGVPPEDDFLGNLETLFYNKKGNCIGPETQSFWLRPHAQGFRDLLNWLSKRYGYPKIYVTENGTSLKGENAMPLKQIVEDDFRVKYFNDYVNAMAKAHSEDGVNVKGYLAWSLMDNFEWAEGYETRFGVTYVDYENDQKRYPKKSAKSLKPLFDSLIKKD

SEQ ID NO: 21 - protein, 318 aa, Pichia stipitis
  REGION 1..318: note = misc_feature - XYL1
MPSIKLNSGYDMPAVGFGCWKVDVDTCSEQIYRAIKTGYRLFDGAEDYANEKLVGAGVKKAIDEGIVKREDLFLTSKLWNNYHHPDNVEKALNRTLSDLQVDYVDLFLIHFPVTFKFVPLEEKYPPGFYCGKGDNFDYEDVPILETWKALEKLVKAGKIRSIGVSNFPGALLLDLLRGATIKPSVLQVEHHPYLQQPRLIEFAQSRGIAVTAYSSFGPQSFVELNQGRALNTSPLFENETIKAIAAKHGKSPAQVLLRWSSQRGIAIIPKSNTVPRLLENKDVNSFDLDEQDFADIAKLDINLRFNDPWDWDKIPIFV

SEQ ID NO: 22 - protein, 363 aa, Pichia stipitis
  REGION 1..363: note = misc_feature - XYL2
MTANPSLVLNKIDDISFETYDAPEISEPTDVLVQVKKTGICGSDIHFYAHGRIGNFVLTKPMVLGHESAGTVVQVGKGVTSLKVGDNVAIEPGIPSRFSDEYKSGHYNLCPHMAFAATPNSKEGEPNPPGTLCKYFKSPEDFLVKLPDHVSLELGALVEPLSVGVHASKLGSVAFGDYVAVFGAGPVGLLAAAVAKTFGAKGVIVVDIFDNKLKMAKDIGAATHTFNSKTGGSEELIKAFGGNVPNVVLECTGAEPCIKLGVDAIAPGGRFVQVGNAAGPVSFPITVFAMKELTLFGSFRYGFNDYKTAVGIFDTNYQNGRENAPIDFEQLITHRYKFKDAIEAYDLVRAGKGAVKCLIDGPE

SEQ ID NO: 23 - protein, 623 aa, Pichia stipitis
  REGION 1..623: note = misc_feature - XYL3
MTTTPFDAPDKLFLGFDLSTQQLKIIVTDENLAALKTYNVEFDSINSSVQKGVIAINDEISKGAIISPVYMWLDALDHVFEDMKKDGFPFNKVVGISGSCQQHGSVYWSRTAEKVLSELDAESSLSSQMRSAFTFKHAPNWQDHSTGKELEEFERVIGADALADISGSRAHYRFTGLQIRKLSTRFKPEKYNRTARISLVSSFVASVLLGRITSIEEADACGMNLYDIEKREFNEELLAIAAGVHPELDGVEQDGEIYRAGINELKRKLGPVKPITYESEGDIASYFVTRYGFNPDCKIYSFTGDNLATIISLPLAPNDALISLGTSTTVLIITKNYAPSSQYHLFKHPTMPDHYMGMICYCNGSLAREKVRDEVNEKFNVEDKKSWDKFNEILDKSTDFNNKLGIYFPLGEIVPNAAAQIKRSVLNSKNEIVDVELGDKNWQPEDDVSSIVESQTLSCRLRTGPMLSKSGDSSASSSASPQPEGDGTDLHKVYQDLVKKFGDLYTDGKKQTFESLTARPNRCYYVGGASNNGSIIRKMGSILAPVNGNYKVDIPNACALGGAYKASWSYECEAKKEWIGYDQYINRLFEVSDEMNLFEVKDKWLEYANGVGMLAKMESELKH

SEQ ID NO: 24 - protein, 304 aa, Saccharomyces cerevisiae
  REGION 1..304: note = misc_feature - YLLO56C, Contains ORF for S. cerevisiae YLLO56C
MTIRYQMKVFITGASGFIGSAVLSELISSGHEVVGLARSDEAAAKIKSIDPAAKILRGDLKDLEILKKGATESDGVIHLGFVHDFKNFEQCCEIDRQATVAMLESLKGSNKPFLYTNGTLSLRPNKVANEQDGIDEDSKILRAVTEQVALSYKDKGVSARIVRLPFSVHGKGDKAFVPILMNIAKAAGKSGYVGQGTNAWAAVHRLDTAPLFRLVLEKGKTGQVYHCVGEQGIPFKDIARVIGEILNVPVASIPVDDAESHFGFLTCFVTRDGPVSSEGTRKELGWQPQQIGLLEDIRANYSLN

SEQ ID NO: 25 - protein, 520 aa, Saccharomyces cerevisiae
  REGION 1..520: note = misc_feature - ALD5
MLSRTRAAAPNSRIFTRSLLRLYSQAPLRVPITLPNGFTYEQPTGLFINGEFVASKQKKTFDVINPSNEEKITTVYKAMEDDVDEAVAAAKKAFETKWSIVEPEVRAKALFNLADLVEKHQETLAAIESMDNGKSLFCARGDVALVSKYLRSCGGWADKIYGNVIDTGKNHFTYSIKEPLGVCGQIIPWNFPLLMWSWKIGPALATGNTVVLKPAETTPLSALFASQLCQEAGIPAGVVNILPGSGRVVGERLSAHPDVKKIAFTGSTATGRHIMKVAADTVKKVTLELGGKSPNIVFADADLDKAVKNIAFGIFYNSGEVCCAGSRIYIQDTVYEEVLQKLKDYTESLKVGDPFDEEVFQGAQTSDKQLHKILDYVDVAKSEGARLVTGGARHGSKGYFVKPTVFADVKEDMRIVKEEVFGPIVTVSKFSTVDEVIAMANDSQYGLAAGIHTNDINKAVDVSKRVKAGTVWINTYNNFHQNVPFGGFGQSGIGREMGEAALSNYTQTKSVRIAIDKPIR

SEQ ID NO: 26 - DNA, 67 bp, synthetic construct
  misc_feature 1..67: note = Synthetic: forward primer for amplifying ALD5 gene with promoter and terminator and 50 bp homologous region from pVT100-ALD5 plasmid
  source 1..67: mol_type = other DNA
cataccatattaagtaaattgcctccatttctttttcctcgggcagagaacgacctcgacgcatgca

SEQ ID NO: 27 - DNA, 68 bp, synthetic construct
  misc_feature 1..68: note = Synthetic: reverse primer for amplifying ALD5 gene with promoter and terminator and 50 bp homologous region from pVT100-ALD5 plasmid
  source 1..68: mol_type = other DNA
ttcagcatagatgggtaacgggatccctctgtgagggccgattatgcaggatgccggtagaggtgtgg